(19) United States
(12) Patent Application Publication
(10) Pub. No.: US 2026/0269639 A1
(43) Pub. Date: Sep. 10, 2026

(54) DOCKING STATION FOR HUMANOID ROBOT

(71) Applicant: Figure AI Inc., San Jose, CA (US)

(72) Inventors: Basel Zohny, San Jose, CA (US); Adeel Zaheer, San Jose, CA (US); Huize Li, San Jose, CA (US); Ryan Benyshek, San Jose, CA (US); May Yang, San Jose, CA (US)

(21) Appl. No.: 19/557,999

(22) Filed: Mar. 5, 2026

Related U.S. Application Data
(60) Provisional application No. 63/875,558, filed on Sep. 4, 2025.
(60) Provisional application No. 63/874,723, filed on Sep. 3, 2025.
(60) Provisional application No. 63/875,074, filed on Sep. 3, 2025.
(60) Provisional application No. 63/850,760, filed on Jul. 25, 2025.
(60) Provisional application No. 63/839,479, filed on Jul. 7, 2025.
(60) Provisional application No. 63/839,474, filed on Jul. 7, 2025.
(60) Provisional application No. 63/767,281, filed on Mar. 5, 2025.

(51) Int. Cl. H02J 7/70; B25J 19/00; H02J 7/84; H02J 7/90; H02J 50/12

(52) U.S. Cl. CPC H02J 7/70; B25J 19/005; H02J 7/84; H02J 7/975; H02J 50/12

(57) ABSTRACT

A docking station for a humanoid robot comprises a wireless charging mat assembly with a base housing, a platform cover coupled to the base housing's upper surface, the platform cover comprising a wireless charging surface and a ramped portion extending forward and downward from the wireless charging surface, a wireless power transmitter within the base housing comprising at least one transmitter coil assembly beneath the wireless charging surface configured to generate an electromagnetic field for wireless power transfer to a humanoid robot, and at least one thermistor within the base housing. A charging controller is communicatively coupled to the transmitter coil assembly and thermistor, configured to receive temperature data, determine when a predetermined temperature threshold is exceeded, and adjust the electromagnetic field accordingly.

### CROSS REFERENCE TO RELATED APPLICATIONS

This application claims the benefit and priority to U.S. Provisional Application Nos. 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is expressly incorporated by reference herein in its entirety.

### TECHNICAL FIELD

The present disclosure relates to foreign object detection for a docking station, that is designed for use in recharging a humanoid robot.

### BACKGROUND

The current workplace landscape is marked by an unparalleled labor shortage, evident in over 10 million unsafe or undesirable jobs within the United States. To counter this ever-expanding labor shortage, it has become imperative to design and integrate advanced robots capable of handling unappealing and even hazardous workplace tasks. With the goal of performing these tasks in an optimal and efficient manner, advanced robots are typically general-purpose humanoid robots tailored for human-centric environments. To work in human-centric environments, the general-purpose humanoid robot must include a battery to enable said robot to move from location to location without being coupled to an external power source. To this extent, the general-purpose humanoid robots must be able to recharge its internal battery. Accordingly, a need exists for an improved charging system that offers safe and enhanced power delivery, superior thermal management, and faster charging.

### SUMMARY

According to an aspect of the present disclosure, a docking station for a humanoid robot is provided. The docking station comprises a wireless charging mat assembly. The wireless charging mat assembly comprises a base housing. The wireless charging mat assembly further comprises a platform cover coupled to an upper surface of the base housing. The platform cover comprises a wireless charging surface and a ramped portion extending forward and downward from the wireless charging surface. The wireless charging mat assembly further comprises a wireless power transmitter positioned within the base housing. The wireless power transmitter comprises at least one transmitter coil assembly positioned beneath the wireless charging surface and configured to generate an electromagnetic field to provide wireless power transfer to a humanoid robot. The wireless charging mat assembly further comprises at least one thermistor positioned within the base housing. The docking station further comprises a charging controller communicatively coupled to the at least one transmitter coil assembly and the at least one thermistor. The charging controller is configured to, while causing the at least one transmitter coil assembly to generate an electromagnetic field, receive, from the at least one thermistor, temperature data. The charging controller is further configured to, based on the received temperature data, determine that a predetermined temperature threshold has been exceeded. The charging controller is further configured to, based on determining that the predetermined temperature threshold has been exceeded, adjust the electromagnetic field generated by the at least one transmitter coil assembly.

According to another aspect of the present disclosure, a docking station for a humanoid robot is provided. The docking station comprises a wireless charging mat assembly. The wireless charging mat assembly comprises a base. The wireless charging mat assembly further comprises a wireless power transmitter positioned within the base. The wireless power transmitter comprises at least one transmitter coil assembly configured to generate an electromagnetic field to provide wireless power transfer to the humanoid robot. The wireless charging mat assembly further comprises at least one thermistor positioned within the base. The docking station further comprises a charging controller communicatively coupled to the at least one transmitter coil assembly and the at least one thermistor. The charging controller is configured to, while causing the at least one transmitter coil assembly to generate the electromagnetic field, receive, from the at least one thermistor, temperature data. The charging controller is further configured to, based on the received temperature data, determine that a predetermined temperature threshold has been exceeded. The charging controller is further configured to, based on determining that the predetermined temperature threshold has been exceeded, adjust the electromagnetic field generated by the at least one transmitter coil assembly.

According to another aspect of the present disclosure, a docking station for a humanoid robot is provided. The docking station comprises a wireless charging mat assembly comprising a wireless charging surface configured to receive feet of a humanoid robot for wireless power transfer. The docking station further comprises at least one camera positioned on the docking station and oriented to capture image data of a sole of a first foot of the humanoid robot while the first foot is lifted above the wireless charging surface. The docking station further comprises a cleaning system comprising at least one fan assembly configured to direct airflow across the wireless charging surface. The docking station further comprises a controller communicatively coupled to the at least one camera and the cleaning system. The controller is configured to receive an indication that the humanoid robot is approaching the docking station. The controller is further configured to capture, via the at least one camera, first image data of the sole of the first foot of the humanoid robot while the first foot is lifted above the wireless charging surface. The controller is further configured to analyze the first image data and thereby detect a foreign object on the sole of the first foot. The controller is further configured to, based on detecting the foreign object on the sole of the first foot, activate the cleaning system to direct airflow toward the sole of the first foot to remove the foreign object. The controller is further configured to, after activating the cleaning system to direct airflow toward the sole of the first foot to remove the foreign object, capture, via the at least one camera, second image data of the sole of the first foot of the humanoid robot while the first foot is lifted above the wireless charging surface. The controller is further configured to analyze the second image data and thereby determine that the sole of the first foot is free of foreign objects. The controller is further configured to, based on determining that the sole of the first foot is free of foreign objects, transmit a signal to the humanoid robot indicating that the sole of the first foot is free of foreign objects.

According to another aspect of the present disclosure, a method carried out by a humanoid robot is provided. The method comprises determining that the humanoid robot is approaching a docking station comprising a wireless charging surface. The method further comprises, based on determining that the humanoid robot is approaching the docking station and before positioning a first foot of the humanoid robot on the wireless charging surface, lifting the first foot of the humanoid robot for inspection via one or more cameras. The method further comprises receiving first image data of a sole of the first foot that was captured while the first foot was lifted. The method further comprises analyzing the first image data and thereby detecting a foreign object on the sole of the first foot. The method further comprises, based on detecting the foreign object on the sole of the first foot, causing a cleaning action to remove the foreign object from the sole of the first foot. The method further comprises, after causing the cleaning action to remove the foreign object from the sole of the first foot, receiving second image data of the sole of the first foot that was captured while the first foot was lifted. The method further comprises analyzing the second image data and thereby determining that the sole of the first foot is free of foreign objects. The method further comprises, based on determining that the sole of the first foot is free of foreign objects, positioning the first foot on the wireless charging surface of the docking station.

According to other aspects of the present disclosure, the method may include one or more of the following features. Receiving the first image data and the second image data may comprise receiving, via one or more cameras of the humanoid robot, the first image data and the second image data. The method may further comprise, based on determining that the humanoid robot is approaching the docking station and before lifting the first foot of the humanoid robot for inspection, removing a foot cover from the first foot of the humanoid robot. Causing the cleaning action to remove the foreign object from the sole of the first foot may comprise wiping the sole of the first foot across a cleaning surface. Causing the cleaning action to remove the foreign object from the sole of the first foot may comprise transmitting a command to the docking station to activate a cleaning system of the docking station to direct airflow toward the sole of the first foot to remove the foreign object.

In various embodiments, the docking station incorporates specific hardware and thermal management configurations to support and safely charge a humanoid robot. The station may include first and second transmitter coil assemblies arranged side-by-side to correspond to the robot's left and right feet, as well as multiple ramped portions extending laterally and downward from the charging surface. To physical secure the robot, a support stand equipped with a vertical support and a cradle can be used to hold the robot upright during wireless power transfer. Thermal regulation and debris management are handled by fan assemblies configured to generate airflow across the charging base or a textured, grooved charging surface, and through internal channels of a rearward-positioned thermal transfer device. These fans can be triggered by thermal imaging sensors that identify foreign objects by detecting the heat signatures of metallic items warmed by induced eddy currents. Furthermore, temperature is safely monitored using negative temperature coefficient (NTC) thermistors or unshielded wire thermistors that are specifically designed to avoid inductive heating from the electromagnetic field.

According to further aspects of the disclosure, the system includes related operational methods for pre-charging inspection and cleaning. To ensure safe docking, the humanoid robot may use its own onboard cameras to capture image data of its soles and can be programmed to remove a foot cover before lifting its foot for inspection. If a foreign object is detected on the sole, the cleaning action may involve the robot physically wiping its foot across a cleaning surface, or transmitting a remote command to the docking station to activate the station's integrated fan system to blow the debris away. For docking stations equipped with their own camera systems, image data is captured before the robot places its foot on the mat. This can be achieved using a dual-camera setup located on opposing sides of the charging assembly with overlapping fields of view to provide thorough foreign object detection.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a perspective view of a humanoid robot engaged with a docking station forming a wireless charging system, wherein: (i) the docking station includes a charging mat with a transmitter device, a support stand with a support cradle, and a station electronics assembly, and (ii) the robot includes a receiver device and a battery pack;

FIG. 2 is a diagram illustrating an environment and a network in which one or more humanoid robots of FIG. 1 may operate, connect, command and/or be commanded by, control and/or be controlled by, and/or interact;

FIG. 3 is a block diagram illustrating components of the humanoid robot of FIG. 1;

FIG. 4A is a perspective view of a humanoid robot of FIGS. 1-3;

FIG. 4B is a diagram illustrating actuators contained within the humanoid robot of FIGS. 1-3 and the corresponding rotational axes of said actuators;

FIG. 5A is a diagram of the wireless charging system of FIG. 1, showing the generation of an electromagnetic field between the transmitter device of the docking station and the receiver device of the robot;

FIG. 5B is a system-level diagram of the wireless charging system of FIG. 1;

FIG. 6A is a top view of an example array of foreign object detection coils arranged in conjunction with the charging coil of the docking station of FIG. 1;

FIG. 6B is a top view of the transmitter coil assembly of FIG. 31;

FIG. 7 is a flow diagram of an example process for detecting and responding to the presence of foreign objects on the charging mat of the docking station of FIG. 1.

FIG. 8 is a front perspective view of the docking station of FIG. 1 and showing the docking station includes: (i) the charging mat with the transmitter device, (ii) the support stand with a flared base, a vertical support member, and the support cradle, (iii) the station electronics assembly with a sensor assembly for thermal monitoring and foreign object detection and a communication interface, (iv) an active cooling system, and (v) a cleaning system;

FIG. 9 is an exploded view of the docking station of FIG. 8, and showing components of the charging mat, the support stand, the station electronics assembly, the active cooling system, and the cleaning system;

FIG. 10 is an exploded view of the charging mat, the station electronics assembly, and the active cooling system included in the docking station of FIG. 8;

FIG. 11 is an exploded view of a portion of the support stand included in the docking station of FIG. 8;

FIG. 12 is a front elevational view of a lower extent of the docking station of FIG. 8 showing an exemplary airflow into an extent of the cooling and cleaning systems contained in the support stand and out of an extent of the cleaning system contained in the charging mat;

FIG. 13 is a front perspective view of the lower extent of the docking station of FIG. 8 showing the exemplary airflow into the extent of the cooling and cleaning systems contained in the support stand and out of the extent of the active cooling system contained in the charging mat;

FIG. 14 is a rear perspective view of the lower extent of the docking station of FIG. 8 showing the exemplary airflow into the extent of the cooling and cleaning systems contained in the support stand and out of an extent of the active cooling system contained in the charging mat;

FIG. 15 is a zoomed in view of the lower extent of the docking station of FIG. 14, wherein portions of the charging mat and support stand have been removed to further show the exemplary airflow through the active cooling system and the cleaning system;

FIG. 16 is a perspective cross-sectional view of the docking station taken along line 16-16 of FIG. 14 and further showing the exemplary airflow through the active cooling system;

FIG. 17 is a top view of the lower extent of the docking station of FIG. 8, showing two partly overlapping fields of view of two foreign object detection sensors;

FIG. 18 is a front elevational view of a lower extent of the docking station of FIG. 8 showing a second embodiment of a cleaning system for the charging mat, wherein the cleaning system includes dedicated fan assemblies coupled to an exterior of the charging mat;

FIG. 19 is a front perspective view of the lower extent of the docking station of FIG. 18 showing an exemplary airflow exhausted out of the fan assemblies of the cleaning system;

FIG. 20 is a rear perspective view of the lower extent of the docking station of FIG. 18 showing the exemplary airflow drawn in by the fan assemblies of the cleaning system and a separate exemplary airflow out of an extent of the active cooling system contained in the charging mat;

FIG. 21 is a cross-sectional view of the docking station taken along line 21-21 of FIG. 20 and further showing the exemplary airflows through the active cooling system and the cleaning system;

FIG. 22 is a front elevational view of a lower extent of the docking station of FIG. 8 showing a third embodiment of a cleaning system for the charging mat, wherein the cleaning system includes dedicated fan assemblies integrated into the support stand of the docking station;

FIG. 23 is a front perspective view of the lower extent of the docking station of FIG. 22 showing an exemplary airflow into an extent of the active cooling system and a separate exemplary airflow exhausted out of the fan assemblies of the cleaning system;

FIG. 24 is a rear perspective view of the lower extent of the docking station of FIG. 22 showing the exemplary airflow drawn in by the fan assemblies of the cleaning system and an exemplary airflow out of an extent of the active cooling system contained in the charging mat;

FIG. 25 is a front elevational view of a lower extent of the docking station of FIG. 8 showing a fourth embodiment of a cleaning system for the charging mat, wherein the cleaning system includes dedicated fan assemblies integrated into the charging mat of the docking station;

FIG. 26 is a front perspective view of the lower extent of the docking station of FIG. 25 showing an exemplary airflow exhausted out of the fan assemblies of the cleaning system;

FIG. 27 is a rear perspective view of the lower extent of the docking station of FIG. 25 showing the exemplary airflow drawn in by the fan assemblies of the cleaning system and an exemplary airflow out of an extent of the active cooling system contained in the charging mat;

FIG. 28 is a cross-sectional view of the docking station taken along line 28-28 of FIG. 25 and further showing the exemplary airflow in and out of the cleaning system;

FIG. 29 is a cross-sectional view of the docking station taken along line 29-29 of FIG. 25 showing the fan assemblies of the cleaning system are fan arrays arranged in the charging mat of the docking station;

FIG. 30 is a cross-sectional view similar to FIG. 29 showing another embodiment of the fan arrays for the cleaning system;

FIG. 31 is a perspective view of a charging coil included in the charging mat of the docking station of FIG. 8;

FIG. 32 is a top view of the charging coil of FIG. 31;

FIG. 33 is a top view of a first embodiment of a foreign object detection system featuring a grid-like sensor coil array in conjunction with the charging coil of FIG. 31;

FIG. 34 is a top view of a second embodiment of a foreign object detection system featuring an elongated coil array in conjunction with the charging coil of FIG. 31;

FIG. 35 is a top view of a third embodiment of a foreign object detection system featuring a multi-layer coil array in conjunction with the charging coil of FIG. 31;

FIG. 36 is a top view of a fourth embodiment of a foreign object detection system featuring a two-layer balanced coil array in conjunction with the charging coil of FIG. 31;

FIG. 37 is a top view of a fifth embodiment of a foreign object detection system featuring a multi-layer hexagonal coil array in conjunction with the charging coil of FIG. 31;

FIG. 38 is a top view of a sixth embodiment of a foreign object detection system featuring a horizontally-oriented coil array in conjunction with the charging coil of FIG. 31;

FIG. 39 is a top view of a seventh embodiment of a foreign object detection system featuring a symmetric self-inductance-based coil array in conjunction with the charging coil of FIG. 31;

FIG. 40 is a block diagram of a system for detecting foreign objects on the base of the docking station of FIG. 1;

FIG. 41 is a side view of the humanoid robot of FIGS. 1-3 and the docking station shown in FIG. 8, and wherein the humanoid robot is in a forward approaching state;

FIG. 42 is a side view of the humanoid robot of FIGS. 1-3 and the docking station shown in FIG. 8, and wherein the humanoid robot has removed foot covers from its feet and is in a rearward approaching state;

FIG. 43 is a side view of the humanoid robot of FIGS. 1-3 and the docking station shown in FIG. 8, and wherein the humanoid robot remains in the rearward approaching state but has lifted one of its feet to expose the sole to the sensor assembly of the docking station to (i) detect foreign objects and/or debris on the sole of the lifted foot and/or (ii) clean the sole of the lifted foot;

FIG. 44 is a top view of the humanoid robot and docking station of FIG. 43 showing the fields of view of two foreign object detection sensors relative to the foot of the robot;

FIG. 45 is a top view of the humanoid robot and docking station of FIG. 43 showing the cleaning system activated to dislodge and/or remove debris from the foot of the robot; and

FIG. 46 is a side view of the humanoid robot of FIGS. 1-3 and the docking station of FIG. 8, and wherein the humanoid robot 1 is in a fully docked state and has lifted one of its feet to expose the sole to the cleaning system to be able to dislodge and/or remove debris from the sole of the lifted foot.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to "one embodiment," "an embodiment," "an illustrative embodiment," etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of "at least one A, B, and C" can mean (A); (B); (C); (A and B); (A and C); (B and C); or (A, B, and C). Similarly, items listed in the form of "at least one of A, B, or C" can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of autonomously handling undesirable and hazardous tasks, or (ii) advanced robots capable of generating data that can be utilized to develop cutting-edge artificial intelligence models (e.g., LLMs, VLMs, VLAs, and/or BAMs) to enable these robots to operate autonomously in human-centric environments.

One aspect of advanced robotic autonomy is to provide the advanced robot with the capability to replenish its own internal power reserves. As the robot operates, the onboard electrical and electromechanical systems consume power. As such, the robot should be provided with sufficient reserves of power to prevent motor, sensor, or processor malfunctions that could lead to a fall that could potentially damage the robot and/or people and objects in the robot’s environment. Furthermore, the robot should be able to be recharged and return to work without requiring a human presence or distracting a human from other higher-level tasks that the robot may be freeing them to perform.

The disclosed docking station with wireless charging capabilities solves or improves upon the shortcomings of conventional (e.g., manual plug-in) charging systems. As such, the docking station is designed to be locatable by the robot, provide recharging power to the robot, and passively support the weight of the robot (e.g., allowing some or all of the robot’s power-consuming electrical and electromechanical systems to at least partly shut down during recharging, thereby reducing recharging time and preventing falls). The disclosed docking station provides a support cradle configured to engage the robot proximal the robot’s waist, and wireless (e.g., inductive) charging pads in a base upon which the robot places its feet (e.g., which include inductive receiver coils). In general, the disclosed docking station allows the robot to walk up to the docking station, turn around, and walk backwards onto the base such that the support cradle at least partly surrounds the robot’s waist. The robot can then relax its knee actuators in a slightly “squatted” configuration to rest its torso upon the support cradle at the waist, while the robot’s feet rest upon the base to receive recharging power.

The disclosed docking station is configured for a humanoid robot having a wireless charging assembly configured receive power by induction. The docking station includes a charging mat that includes two transmitter coil assemblies configured to generate an electromagnetic field to provide power to the humanoid robot, wherein the humanoid robot includes two receiver coil assemblies that substantially align with the transmitter coil assemblies of the charging mat when the humanoid robot is standing on the charging mat. The docking station also includes a communication interface configured to participate in a communication link to exchange information between the humanoid robot and the docking station, and wherein the system is configured to communicate information for the robot to adjust a position of each of the left and right foot thereby improving an alignment of each of the receiver coil assemblies with its corresponding transmitter coil assembly.

The disclosure docking station is also configured for foreign objection detection. Foreign objects (e.g., living animals) and/or debris (e.g., large and small physical objects) on the wireless charging surface of the charging mat may impede wireless charging or create a hazard during wireless charging. The docking station may have foreign object detection capabilities to address this risk. These may include a sensor assembly to monitor the wireless charging surface. In some embodiments, the sensors may be temperature-based sensors configured to detect thermal signatures of metallic foreign objects being heated by induced eddy currents and/or to detect heat signatures of living things. In some embodiments, the sensors may be vision-based sensors configured to detect foreign objects or debris on the wireless charging surface. The docking station may further include a field-based foreign object detection system comprising an auxiliary sensor coil array positioned over each transmitter coil assembly configured to detect localized disturbances in the magnetic field caused by the presence of conductive foreign objects.

Various embodiments of the docking station are designed to: (i) support the weight of the robot, (ii) stabilize the robot in a substantially upright (e.g., standing) configuration while some or all of the robot’s onboard systems and actuators are in low or no-power mode, (iii) provide wireless power to the robot for operation and/or recharging its onboard power reserves, (iv) be portable, (v) detect foreign objects that might impede wireless charging or create a hazard during wireless charging. This configuration helps enhance the productivity, autonomy, and flexibility of humanoid robotic operations. For the above reasons, the design and arrangement of the disclosed docking station and complementary features of the robot provide the disclosed robot with substantial benefits over conventional robots and charging systems.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

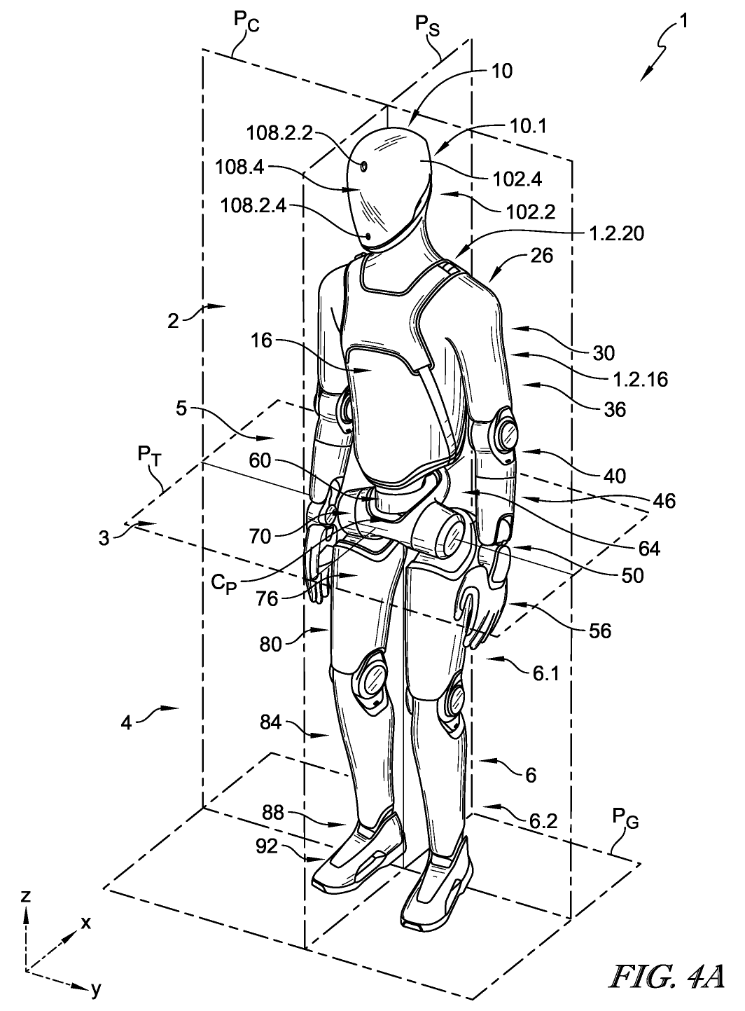

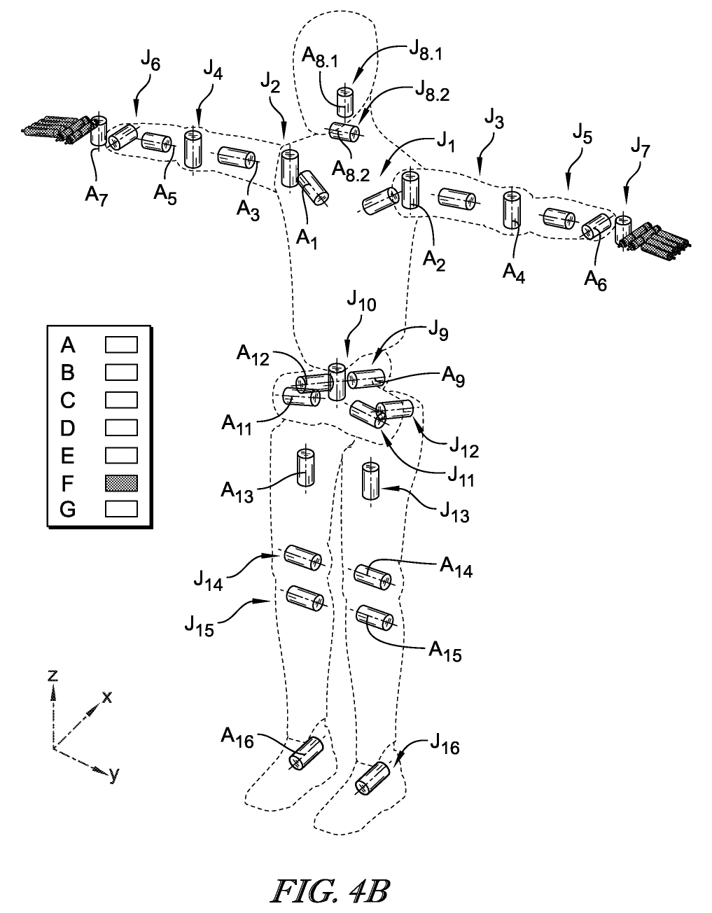

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 4A.

Extended State: a state of the robot with the arms extended outward laterally at the shoulder (as illustrated in FIG. 4B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 4A) is a vertical plane positioned at a midway point between the left and right legs and the left and right arms and contains a rotational axis A₁₀ of a torso twist actuator (J10) (e.g., as illustrated in FIG. 4B) located in the spine 60 of the robot 1 and divides the left and right sides of the robot 1 (e.g., as illustrated in FIG. 4A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 4A and 4B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 4A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 4A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 4B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth),engineered textiles, and non-fabric-like materials (e.g., plastics or polymers), and/or a combination of the above.

### C. ROBOTS AND ENVIRONMENT

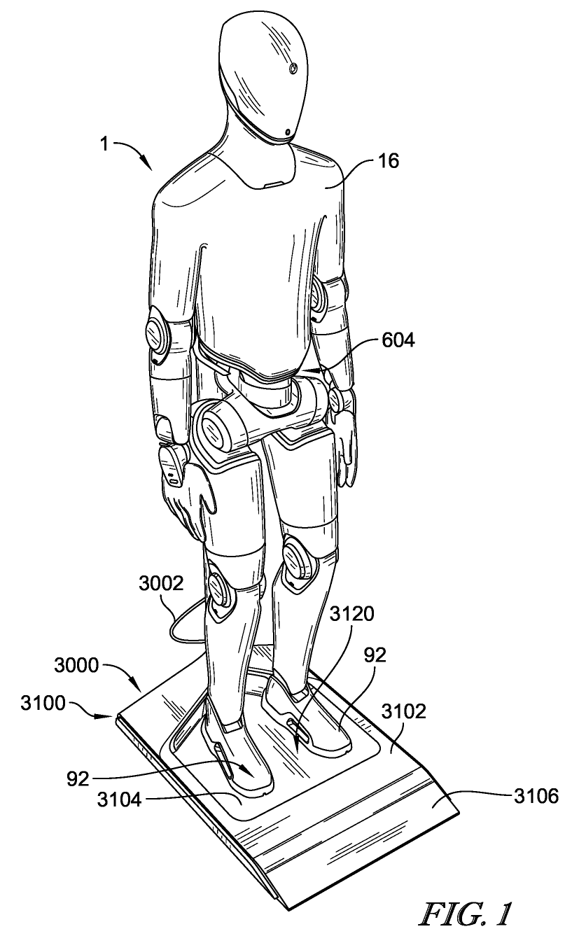

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated - e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

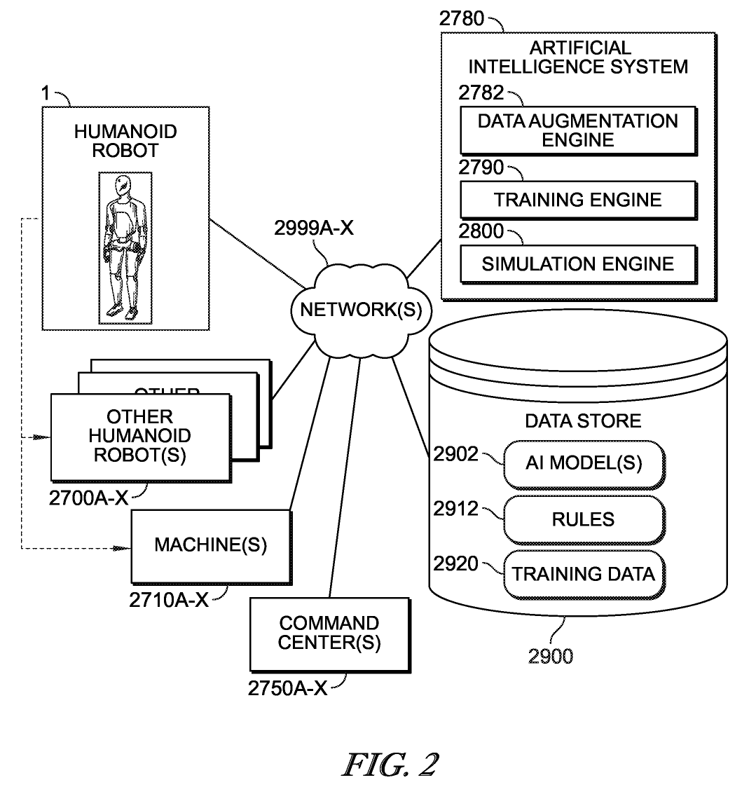

Although FIG. 2 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 in the illustrative embodiment shown in FIG. 4A may include the following systems, assemblies, components, and parts, which can be broadly categorized into three regions. As shown in FIG. 4A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 4A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### ii. Kinematics

As illustrated in, e.g., FIGS. 4A and 4B, an upper portion of the torso 16 is designed to receive and secure two arm actuators (J1) 190, wherein each arm assembly 5 extends from its respective arm actuator (J1) 190 and comprises a series of actuators that are arranged to provide extensive mobility and dexterity. Each arm actuator (J1) 190 is engineered to provide the principal rotational movement for the entire respective arm assembly 5. Each arm actuator (J1) 190 may utilize a motor, a gear reduction system, and sensors or encoders that are similar to other actuators in the robot 1, but potentially with a larger motor and a different gear ratio that is specifically optimized for high-torque shoulder movements.

The rotational axis A₁ of the arm actuator (J1) 190 is oriented at a rearward angle (α) with respect to a vertical or coronal plane P_{C}. This angle α is intentionally selected such that the rotational axis A₁ is neither orthogonal nor parallel to the other arm axes (A₂-A₇) and α is chosen from a range of between 1 and 45 degrees, with a preferred range between 10 and 20 degrees. This specific rearward angle strategically positions a primary kinematic singularity of the arm 5 in the illustrative embodiment of robot 1 at a location that is away from an intended primary operational workspace of the robot 1. This configuration is beneficial because it places that singularity of the robot's arm in a location that is outside of normal use for the tasks that the robot 1 is designed to perform. For example, when the robot 1 holds an object with a narrow grip, it is significantly less likely to encounter this performance-degrading singularity.

Generally, an upper portion of the arm assembly 5 includes three actuators (shoulder actuator J2, upper arm twist actuator J3, elbow actuator J4), while a lower portion of said arm assembly 5 includes three actuators (lower arm twist actuator J5, wrist flex actuator J6, wrist pivot actuator J7). The rotational axes A₂, A₄ of shoulder actuator J2 and elbow actuator J4, respectively, are arranged such that they are orthogonal to: (i) the rotational axis of A₃ of upper arm twist actuator J3. In addition, the rotational axis A₃ is collinear with the rotational axis A₅ of lower arm twist actuator J5 when the arm is fully extended. The rotational axis A₄ of elbow actuator J4 is oriented orthogonal to the collinear rotational axes A₃ and A₅. Additionally, the axis A₄ is offset rearward along the X-axis from a common cord that is defined by the alignment of A₃ and A₅. This rearward placement of the elbow axis A₄ increases its range of motion. The three actuators (J5, J6, J7) situated in the lower portion of the arm are arranged with their respective axes (A₅, A₆, and A₇) mutually orthogonal to one another, which provides three degrees of freedom and enables complex orientation of the lower arm and the hand 56. This arrangement allows for control of roll via lower arm twist actuator (J5) 468, pitch via wrist flex actuator (J6) 484, and yaw via wrist pivot actuator (J7) 520, thereby governing the final position of the hand 56. In the wrist 50, the rotational axis A₅ of lower arm twist actuator J5 is positioned orthogonal to the rotational axis A₇ of the wrist pivot actuator J7. The elbow axis A₄ and the wrist pivot axis A₇ are parallel to one another in the extended state but are not aligned within the same ZY-plane.

The central portion of the robot 1 includes the torso lean actuator J9, the torso twist actuator J10, the hip flex actuators J11, and hip roll actuators J12. The torso lean actuator (J9) 680 is positioned in the pelvis 64 and is coupled to the spine 60, while a torso twist actuator (J10) 620 is located in the waist of the robot 1 and is coupled to the spine 60. These two actuators, J9 and J10, are positioned to provide two degrees of freedom for the torso (i.e., torso twist (yaw) and torso lean (roll)) and are centered along the sagittal plane P_{S}, enabling capabilities such as allowing the robot 1 to twist its body to pick up an item that is positioned at 90 degrees to its side and to lean over an obstacle to complete another task. Their respective axes are arranged such that axis A₉ (torso lean) is angled downward such that an angle (β) is formed with respect to the transverse plane (P_{T}) at an angle of between 1 and 30 degrees, preferably 8-16 degrees, while axis A₁₀ (torso twist) is parallel with the coronal plane P_{C} and perpendicular to the transverse plane (P_{T}).

The disclosed robot 1 lacks a dedicated torso pitch actuator that would allow the robot 1 to bend forward (i.e., in a ZX-plane from the neutral state) at the robot's belly. The elimination of this actuator can increase the internal volume of the torso 16 by over 300% (e.g., from approximately 7 liters to approximately 20 liters). This expanded volume allows for the inclusion of a relatively larger battery pack and relatively larger volume for compute. This lack of a torso pitch actuator would be a significant sacrifice, but for the ability to generally move this functionality into the robot's hips, specifically hip flex actuators (J11) 720. By rotating both hip flex actuators (J11) 720 in concert, the robot 1 can effectively bend its entire upper body forward from the hips. While the functionality of hip flex actuators (J11) 720 does not fully replace the inclusion of a specific torso pitch actuator because it alters the location from where the robot 1 can bend forward, the designer of the disclosed robot 1 made this trade-off in order to gain the above-described benefits. It should be understood, however, that said robot 1 could be modified to include a torso pitch actuator to add this additional functionality if needed.

As illustrated in FIGS. 4A and 4B, the hip flex actuators (J11) 720 are coupled to the left and right sides of the pelvis 64. Each rotational axis A₁₁ of hip flex actuators (J11) 720 is positioned at a respective downward angle such that an angle (γ) is formed with respect to the transverse plane (P_{T}) of between 1 and 30 degrees, preferably 8-16 degrees, a configuration to provide a pitch-like motion (e.g., extension and flexion, front kick or a torso 16 forward lean motion). Each axis A₁₁ is also offset from axes A₁₀ and A₉ along the Z-axis, which helps position the leg directly beneath a frontal extent of the torso 16. In an unconventional arrangement, the hip flex actuators (J11) 720 are directly coupled to the pelvis 64 and are positioned closer to the torso lean actuator (J9) than are any other leg actuators. This high placement (e.g., relative to the leg assemblies 6) within the kinematic chain increases the torque requirements for the hip flex actuators (J11) 720 actuators, which are sized accordingly with approximately twice the torque capacity of the hip roll actuators (J12) 768 and leg twist actuators (J13) 782.

The hip roll actuators (J12) 768 can each independently provide roll-like movement (e.g., abduction and adduction, hip pivot, sideways kick) about rotational axis A₁₂ for the portions of the respective leg assemblies 6 that are moved about the hip roll actuators (J12) 768. In the illustrative embodiment of robot 1, the hip roll actuators (J12) 768 are each coupled to a respective hip flex actuator (J11) 720, rather than being coupled directly to the pelvis 64. This arrangement allows the hip roll axis A₁₂ to be angled rearward and downward relative such that an angle (δ) is formed with respect to the transverse plane (P_{T}) of between 1 and 45 degrees, preferably 10-20 degrees. Hip roll axis A₁₂ is neither parallel nor orthogonal to any other of the actuators J13, J14, J15, J16, each described in further detail below. This specific configuration provides a greater range of motion for actions such as performing deep squats and rising from the ground, which further compensates for the absence of a dedicated spine pitch actuator.

A left and right leg twist actuator (J13) 782 is positioned near actuator (J12) 768 within the hip housing and is coupled to the lower thigh 80. Its rotational axis, A₁₃, is parallel with the torso twist axis A₁₀. Each leg twist actuator (J13) 782 can each independently provide a yaw movement about rotational axis A₁₃ for lower portions of the respective leg assembly 6 that are moved about the leg twist actuator (J13) 782. Each leg twist actuator (J13) 782 is not directly coupled to the pelvis 64, and each is positioned below all of the other hip and spine actuators (J9-J12). This is different than conventional robots and is potentially less desirable due to the fact that it increases the weight in the lower leg, which increases the torque requirements of the other actuators contained in the hip. However, in this configuration, as described above, the hip flex actuator (J11) 720 has been configured with a greater torque to address this issue. This particular design may also require any hip housing to be split into two separate components, which may add a degree of manufacturing complexity and cost.

Each leg assembly 6 of the robot 1 includes a knee actuator (J14) 820 with a rotational axis A₁₄ which is housed in the lower thigh 80. Unlike conventional designs that often utilize linear actuators or linkages for knee joints, knee actuator (J14) 820 is a rotary actuator that is directly coupled to housings of the lower thigh 80 and the shin 84 and provides a pitch movement about rotational axis A₁₄.

Each leg assembly 6 of the robot 1 includes a foot assembly which includes a foot flex actuator (J15) 860 with a rotational axis A₁₅, which is housed in the shin 84 and utilizes a rotary actuator and an associated linkage to provide a pitch movement (e.g., flexion and extension) for the foot 92 which is not about the rotational axis A₁₅. Each foot 92 further includes a foot roll actuator (J16) 900 with a rotational axis A₁₆, which is housed within the talus 88 and provides a roll movement for respective portions of the foot 92 that are moved about the foot roll actuator (J16) 900. Placing the roll actuator (J16) 900 in the foot is an uncommon design solution that tends to increase the torque requirements on other leg actuators (J11, J12, J14). However, the housing of actuator (J16) 900 is advantageously designed to couple directly to the output of actuator (J15) 860, a configuration that reduces the total number of parts and minimizes potential failure modes.

The humanoid robot 1 may further include head and neck actuators to complete its human-like form. For example, a head twist actuator (J8.1) 120 with a rotational axis A_{8.1} and a head nod actuator (J8.2) 140 with a rotational axis A_{8.2} may be included to provide two degrees of freedom (e.g., yaw and pitch, respectively) to orient sensors, cameras, or displays that are housed within the head 10.1. Although the head 10.1 and neck are not intended to manipulate objects, the head 10.1 completes the human-like form and may contain components such as cameras, displays, or other user interfaces. The head twist actuator (J8.1) 120 and the head nod actuator (J8.2) 140 may be used to direct the field of view of one or more cameras or sensors that are contained within the head 10.1 and may cooperate with each other, but they are not generally linked to other actuators.

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

### i. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. The humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

### ii. Data Storage

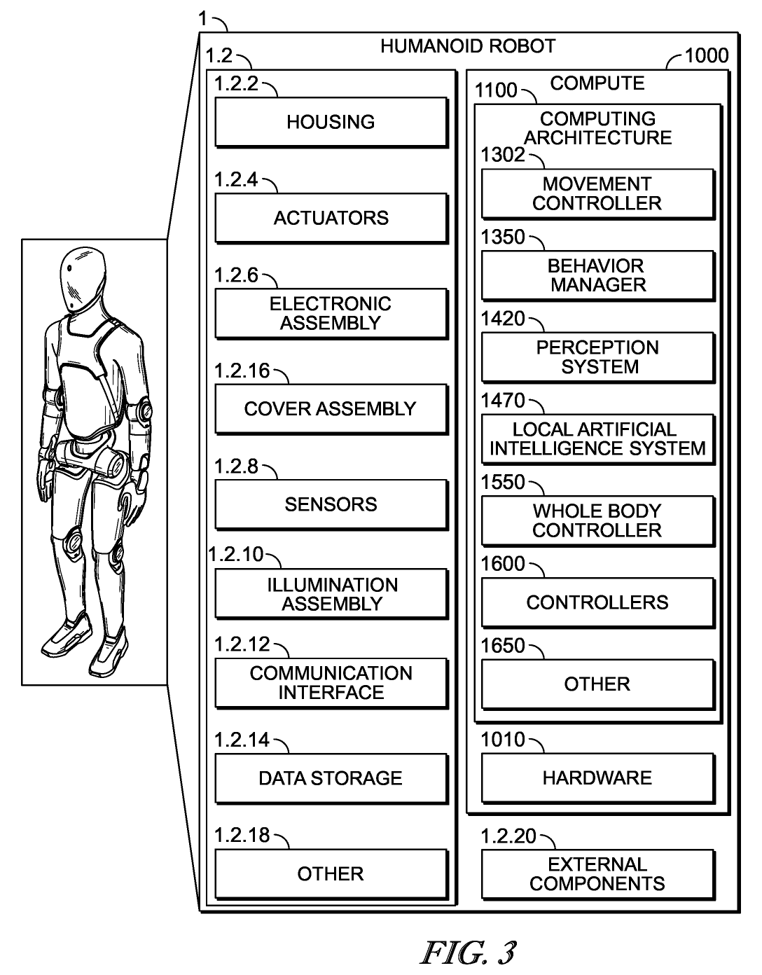

Referring back to FIG. 3, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel^{®} 3D XPoint^{®} memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

### iii. Wireless Power Receiver System

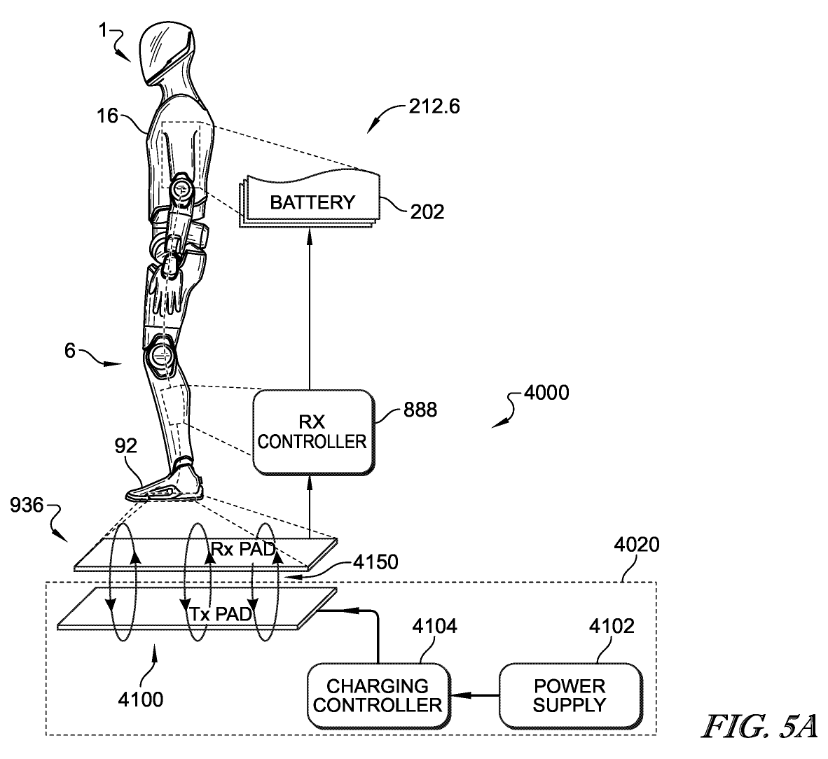

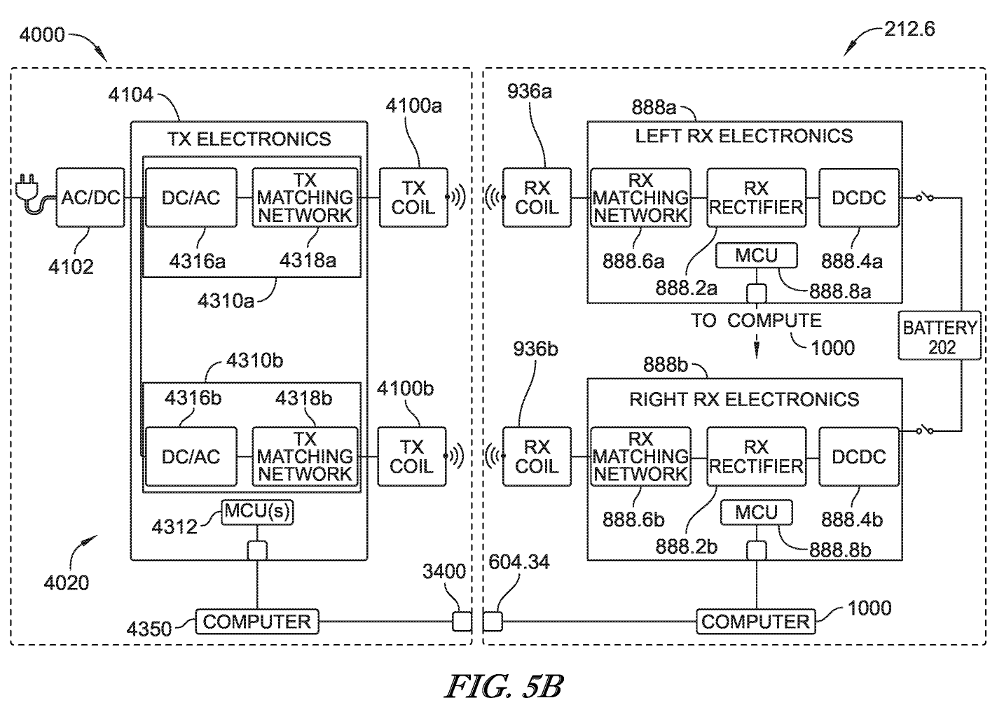

As illustrated in at least FIGS. 5A-7, the wireless power receiver system 212.6 is configured to (i) deliver power to charge the battery pack 202 and (ii) communicate charging information to another device, such as a docking station 3000. The wireless power receiver system 212.6 includes a wireless power receiver 212.6.2 electrically coupled to the battery pack 202 and communicatively coupled to compute 1000 and at least one communication interface 1.2.12. The wireless power receiver 212.6.2 may include a receiver coil assembly 936 and a charging controller 888 in each leg 6. Both charging controllers 888a, 888b are further coupled to compute 1000, which may be further coupled to at least one communication interface 1.2.12. In the illustrative embodiment, the at least one communication interface 1.2.12 includes a communication transceiver 604.34 configured to connect with a communication transceiver 3400 housed within the docking station 3000. In alternative embodiments, the robot 1 and/or docking station 3000 may be configured with other means of communication.

Including a receiving coil 936 and a charging controller 888 in each leg 6 provides for faster charging and redundancy. For example, if a receiving coil 936 is not functioning properly, the robot 1 may communicate a need for maintenance to an operator or a command center, while slowly charging the battery pack 202 using the other operational receiving coil 936. This change in power distribution, monitoring, and communication may be monitored by the individual charging controller 888, the charge monitor 1610, and/or other controllers 1600 contained in the robot 1.

### 1. Wireless Power Receiver

Referring to FIG. 5A-7, the wireless power receiver 212.6.2 includes a receiver coil assembly 936 (also referred to as receiver coil, charging coil, foot charging coil, or charging coil assembly) and a charging controller 888 in each leg 6 that are electrically coupled with the battery pack 202. In the illustrative embodiment, the receiver coil assembly 936 in each foot 92 is electrically coupled to a charging controller 888 housed in the leg 6 (e.g., shin 84). Each receiver coil assembly 936 is configured to receive power by electromagnetic induction. The charging controllers 888a, 888b are configured to (i) deliver power to the battery pack 202 and (ii) communicate with the compute 1000 and communication transceiver 604.34.

### a. Receiver Coil Assembly

In the illustrative example, the robot 1 includes receiver coil assemblies 936a, 936b arranged in each foot 92 and configured to create an alternating electric current when positioned within an oscillating magnetic field. In the example shown in FIG. 1, the robot 1 is configured to stand on a charging mat 3100, so that the receiver coils 936a, 936b are substantially aligned with the transmitter coils 4100a, 4100b of the charging mat 3100 to receive wireless power. With the receiver coil assembly 936 positioned within the oscillating magnetic field 4150 created by the wireless power transmitter device 4020 of the charging mat 3100, the receiver coil assembly 936 receives an alternating electric current. The alternating electric current is transferred to the receiver charging controller 888 to convert the AC power into DC power that may be used to charge the battery pack 202 of the robot 1. For example, the robot battery may be charged from a predetermined low level (e.g., 5%-25%, preferably 10%) to a predetermined high level (e.g., between 75%-95%, preferably 80%) in a predetermined amount of time (e.g., less than 15 minutes, less than 30 minutes, less than 60 minutes, or any value between 5 minutes and 240 minutes). In various embodiments, this arrangement may add weight in the foot 92 and may require active cooling (e.g. a fan in the leg 6) to dissipate heat generated by the coil assembly.

For example, each foot 92 of the robot 1 may be configured with a receiver coil assembly 936 enclosed by at least a sole of the foot 92. The receiver coil assembly 936 sized to be substantially similar to a main portion of the foot 92. The receiving coil includes a wire that may be wound to include a number of turns to form a planar coiled wire layer. For example, the wire may be Litz wire and the number of turns may be between 3 and 20, preferably between 5 and 10. The coiled wire layer may have a substantially oval or oblong shape dimensioned to be less than the perimeter of the foot base structure.

The sole may be configured to contact the ground or support surface on which the robot 1 may walk and may be formed of a material that allows the magnetic field to interact with the receiver coil assembly 936 to transfer power. The receiver coil assembly 936 may include at least a receiving coil. The receiver coil assembly 936 may include a base or housing configured to hold the receiving coil and shielding layers configured to shield against electromagnetic interference (EMI) and/or to insulate and resist heat buildup. For example, the shielding layers may include a nanocrystalline material. In various embodiments, a foot or shoe cover 934 may couple to, near, and/or over the sole to further enclose the receiver coil assembly 936 and other components of the foot 92. The shoe cover 934 may be made from a flame retardant material to protect against thermal damage. Additionally, the shoe cover 934 may be made of an energy absorbing material to absorb impact while the robot 1 is walking and/or reduce the noise generated from the robot 1 walking. However, this energy absorbing material may be more likely to pick up or collect foreign objects and/or debris while the robot 1 is walking. As such, it may be important to check or inspect the soles of the feet 92 prior to charging.

In various embodiments, the receiver coil assembly 936 may include a receiving coil module, a heat transfer device, a foot shield, and a toe shield. The coil module may include a receiving coil, a coil shield, and a module base. The heat transfer device is configured to be received in the foot base structure and coupled therein. The foot shield is positioned between the foot base structure and the receiving coil module, and shaped to substantially cover a lower side of the foot base structure including the heat transfer device. The foot shield, toe shield, and coil shield may each be configured to reduce electromagnetic interference.

The receiving coil includes a wire that may be wound to include a number of turns to form a planar coiled wire layer, a first end lead, and a second end lead. For example, the wire may be Litz wire and the number of turns may be between 3 and 20, preferably between 5 and 10. The coiled wire layer may have a substantially oval or oblong shape dimensioned to be less than the perimeter of the foot base structure of the foot 92. The first end lead and the second end lead may be insulated and extended from planar coiled wire layer to deliver power to the charge controller 888.

The coil shield has a substantially oval or oblong shape configured to overlay the shape of the receiving coil. The coil shield is substantially planar and may include one or more layers of shielding material. In an example, the coil shield may include a first layer configured to shield against electromagnetic interference (EMI) and a second layer configured to insulate and resist heat buildup, where the second layer may be positioned between the first layer and the receiving coil. For example, the first layer may be a nanocrystalline material and the second layer may include a polyimide film, such as Kapton® or other high-performance film. The coil shield includes a shield openings configured to allow passage of the first and second end leads of the receiving coil through the coil shield. In some embodiments, the coil shield may further include a slit or narrow gap opening that extends between the shield openings configured to reduce the eddy current losses. The coil shield may be adhered to the planar coiled wire layer with the first and second end leads extending through the shield openings.

The module base has a shape substantially similar to the foot base structure. For example, the module base is dimensioned to have a perimeter that is substantially the same as, or less than, the perimeter of the foot base structure, such that the charging module may be coupled to the foot base structure and be received within the sole of the foot 92. The module base includes a first side configured to face the foot base structure and a second configured to couple with the sole of the foot 92. A coil receptacle formed in the first side of the module base is shaped to receive the coiled wire layer of the receiving coil. The coil receptacle may include an oblong recess dimensioned to substantially match the depth, general shape, and total width based on the number of turns of the planar coiled wire layer. The coil shield may substantially enclose the coiled wire layer within the module base. The module base may be formed of a thermoplastic material. For example, the module base may include a polybutylene terephthalate (PBT) and fiberglass (FG) substrate and an ethylene vinyl acetate (EVA) surface material.

The heat transfer device is configured to be received into the compartment formed in the foot base structure. The heat transfer device includes a base plate and heat transfer units coupled to the base plate. The base plate is dimensioned to fit and substantially cover the compartment of the foot base frame. The base plate includes plate openings configured to allow passage of the first and second end leads of the receiving coil into the foot base structure. In various embodiments, a temperature sensor may be coupled within the foot 92 to monitor the thermal conditions. The robot 1 may further be configured with active cooling means to affect the temperature within the foot 92.

The foot shield is configured to substantially cover the lower side of the foot base structure. Similar to the coil shield, it may include one or more shielding layers. For example, a first foot shield layer may be configured to shield against electromagnetic interference (EMI), and a second foot shield layer may be configured to insulate or protect the first layer. In an example, the first foot shield layer may be a nanocrystalline material and the second layer may include polymer or plastic, such as polyethylene terephthalate (PET). Further, the foot shield includes first and second shield openings are configured to allow passage of the first and second end leads of the receiving coil.

### b. Charging Controllers

The charging controllers 888a, 888b are electrically coupled to respective receiver coil assemblies 936a, 936b in each foot 92. The charging controllers 888a, 888b each include receiver electronics configured to convert the alternating current (AC) induced in the receiver coil assembly 936 by the magnetic field to direct current (DC) to charge the battery pack 202 of the robot 1. Each of the right and left receiver charging controllers 888a, 888b may include (i) a receiver rectifier 888.2a, 888.2b, (ii) a DC to DC converter 888.4a, 888.4b, (iii) a receiver matching network 888.6a,888.6b, and (iv) a microcontroller unit 888.8a, 888.8b, as shown in FIG. 5B. For example, the matching network 888.6a, 888.6b, the rectifier 888.2a, 888.2b, and the DC/DC converter 888.4a, 888.4b may be configured to regulate voltage or current to appropriate levels for the robot's power loads, and a controller 888.8a, 888.8b may be configured to manage power flow. In certain embodiments, said rectifier 888.2a, 888.2b may be realized as a diode full-bridge rectifier or an active synchronous rectifier. This rectified DC voltage may then be supplied to the DC/DC converter 888.4a, 888.4b. In the illustrative embodiment, the DC converter 888.4a, 888.4b coupled to the battery pack 202 to provide power to charge the battery pack 202 arranged in the robot’s torso 16. In certain embodiments, a single charging controller 888 may include one set of receiver electronics for both the receiver coils 936a, 936b.

Additionally, the microcontroller unit 888.8a, 888.8b of each charging controller 888a, 888b is further connected to compute 1000 and configured to deliver information regarding the status and/or operation of the receiving coils 936 in foot 92. The individual microcontroller units 888.8a, 888.8 may be configured to collect and communicate information regarding the operation of the wireless power receiver 212.6.2, including voltage and/or current received by respective receiver coils 936a, 936b while charging, temperature and/or other sensor readings, and fault information.

### 2. Data Communication

The wireless power receiver system 212.6 is configured to communicatively couple the wireless power receiver 212.6.2 to compute 1000 and at least one communication interface 1.2.12 of the robot 1 to establish a data connection with docking station 3000. When communication is established, the robot 1 and docking station 3000 may communicate information, including: (i) when the robot 1 is at or on the charging mat 3100, (ii) when the robot 1 needs to reposition itself on the charging mat 3100 and/or docking station 3000, (iii) when to begin charging, (iv) how fast to charge, (v) how much power to supply to the battery or how much to charge the battery, and (vi) when charging of the battery pack 202 is complete.

### c. Compute

As illustrated in FIG. 3, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. DOCKING STATION

As illustrated in FIG. 1, the robot 1 is shown in a fully docked state, in which the robot 1 is positioned with its feet 92 on the charging mat 3100 of the docking station 3000 and supported at the waist 604 from the rear by a support cradle 3300. The rear engagement between the docking station 3000 and the robot 1 represents a significant departure from the design of conventional docks. In particular, conventional docks that facilitate forward engagement between a robot and a dock may be sufficient for mechanically stable wheeled platforms, but these conventional docks are inadequate for humanoid embodiments that pose a higher center of gravity, feature sensors, manipulators, and communication arrays on their anterior side, and need to occupy a minimal floor-based footprint while allowing for autonomous docking. This configuration also unconventionally leaves the forward-facing operational systems of the robot 1 entirely unobstructed, permitting the robot to continue monitoring its environment and/or communicating while securely docked. Other benefits of utilizing a rearward supporting design may be obvious to one of ordinary skill in the art based on the present disclosure and the accompanying figures. For example, the rearward supporting design may permit the robot 1 to respond to external stimuli, such as voice commands or visual alerts, even while in a docked and charging state.

This successfully docked configuration also represents the culmination of a fully autonomous process, wherein the robot 1 has, without human intervention, navigated to, approached, and securely engaged with the docking station 3000. Once the robot 1 is in this docked state, it can safely transition into an off, a deep low-power, or a standby mode. This transition is not merely limited to powering down its primary processors, but may also extend to the complete de-energization of its most energy-intensive subsystems, such as its powerful leg, torso, and arm actuators. This deep power-down mode, which would be exceedingly difficult or functionally impossible to achieve safely without the stable external physical support provided by the docking station 3000, serves to minimize parasitic energy consumption while the internal batteries of the robot 1 are being replenished. This unique capability for stable, deep-power recharging enables entire fleets of such robots to function continuously in demanding industrial environments with only minimal human oversight, thereby maximizing their operational uptime and utility. The physical support provided by the docking station 3000 also ensures the stability of the robot 1 against accidental bumps or environmental vibrations, thereby preventing falls that might otherwise occur if the robot 1 were attempting to recharge in a free-standing configuration without its actuators being fully energized for balance. In some embodiments, the robot 1 may transition through a graduated sequence of power states, such as from a standby mode to a low-power mode and then to a deep sleep mode, based on the estimated time to reach a full charge.

The docking station 3000 is designed to extend upwards from its base to engage with the posterior and lateral aspects of the robot 1, specifically engaging the robot at its waist 604 with the support cradle 3300. In this engaged position, where the robot 1 maintains a natural, upright posture, the docking station 3000 provides robust, multi-axis mechanical support, which effectively offloads the static gravitational load from the robot's own actuators and transfers that load onto the sturdy structure of the docking station 3000. Said upright posture may be particularly conducive to long-term autonomous operation by allowing the robot 1 to be physically supported by an external structure while being simultaneously and optimally positioned for receiving wireless charging power to its feet 92. Additionally, this upright posture may be advantageous for operations in human-centric environments where available floor space may be limited, and where the robot 1 should maintain a minimal physical footprint to avoid causing an obstruction to human workers or other equipment. In some embodiments, the docking station 3000 may be configured to engage the robot 1 at other body portions, such as the torso or the hip joint assembly, depending on the specific morphology of the humanoid robot.

This view in FIG. 1 also shows the power cord 3002 extending from the rear of the docking station 3000. The power cord 3002 is strategically placed at the rear of the unit to minimize its profile and to prevent it from becoming a trip hazard in a busy workspace. In some embodiments, the power cord 3002 can include a standard plug (not shown) to enable the docking station 3000 to receive power from a standard wall outlet (e.g., NEMA 5-15, NEMA 5-20, NEMA 14-50, CEE 7/2, GB 1002, GB 2099.1). In some alternative embodiments, the power cord 3002 can be configured to be wired directly into a permanent electrical junction box, which may be desirable for a more permanent and robust installation. In further embodiments, the power cord 3002 may include integrated strain relief and/or a locking connector mechanism to prevent accidental disconnection during robot docking and undocking events.

In general, these figures collectively depict the robot 1 in a stable, upright, and safely supported position, which is the successful and intended result of a robust, fully autonomous docking procedure. This advanced capability allows for safe, efficient, and frequent recharging cycles to occur without the need for any human intervention, which is a key enabler for the continuous and long-term deployment of humanoid robots in a wide range of industrial, commercial, and logistical applications. In addition, the robot 1 and the docking station 3000 may include electrical parts and systems that meet, exceed, satisfy, and/or are in full compliance with IEC 60204-1:2016, including its 2021 amendment (AMD1:2021), wherein the latest revisions of both of these standards are hereby incorporated by reference. Further, the robot 1 and/or the docking station 3000 may include safety features (e.g., communications protocols between the robot 1 and docking station 3000) that will prevent the docking station 3000 from emitting wireless electrical current in response to the belief or detection of an erroneous or unsafe connection. In some embodiments, the safety features may include a multi-stage handshake protocol between the robot 1 and the docking station 3000, wherein the docking station 3000 verifies the identity, model, and charge state of the robot 1 prior to energizing the transmitter coil assemblies.

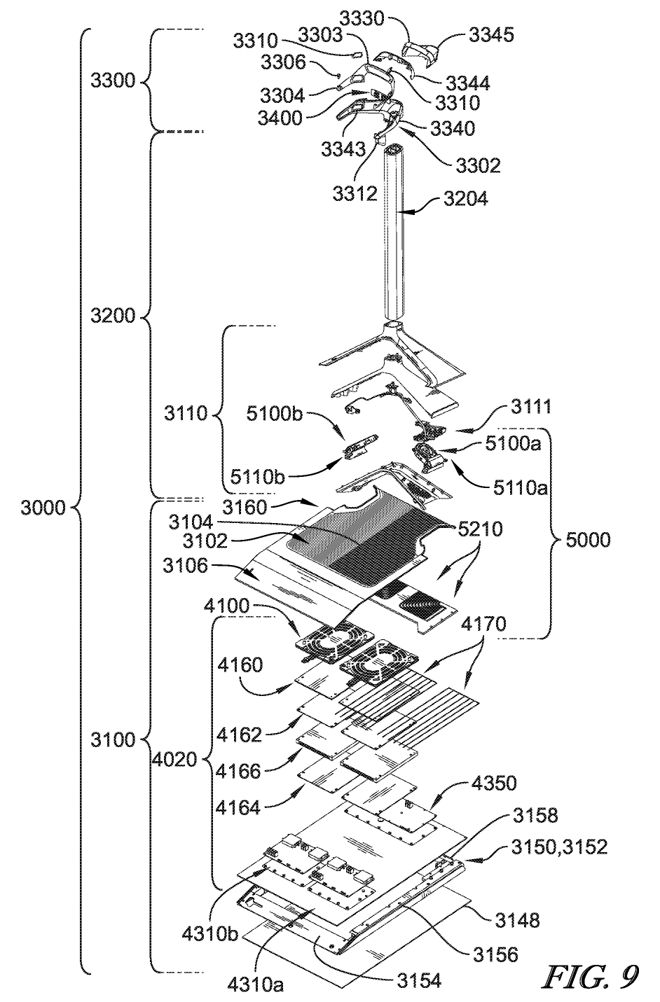

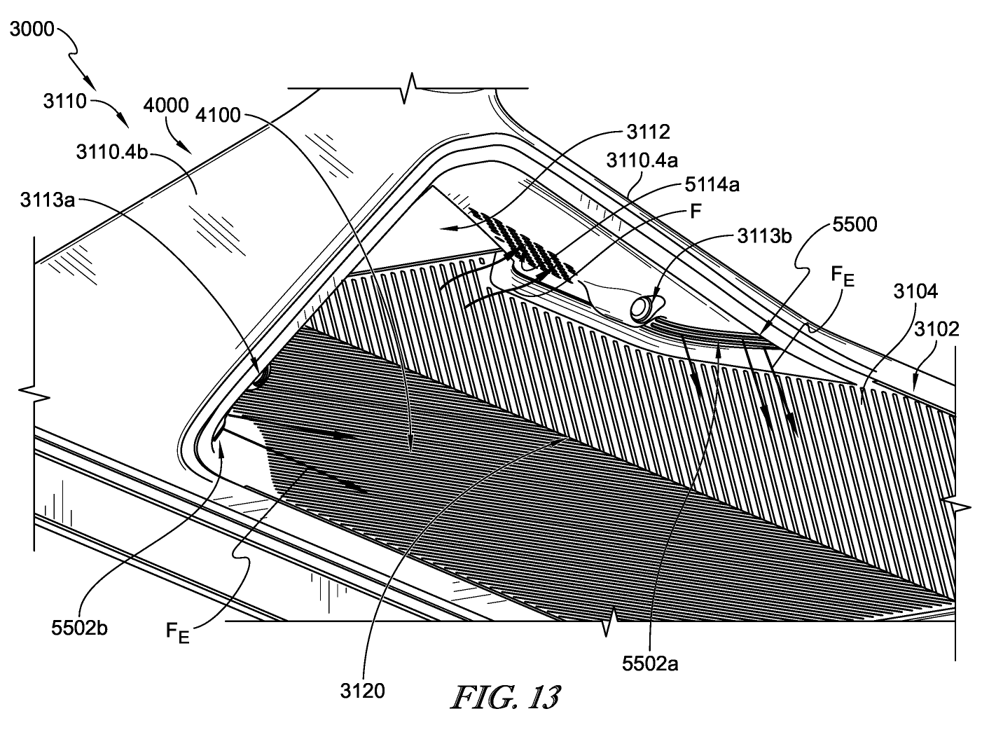

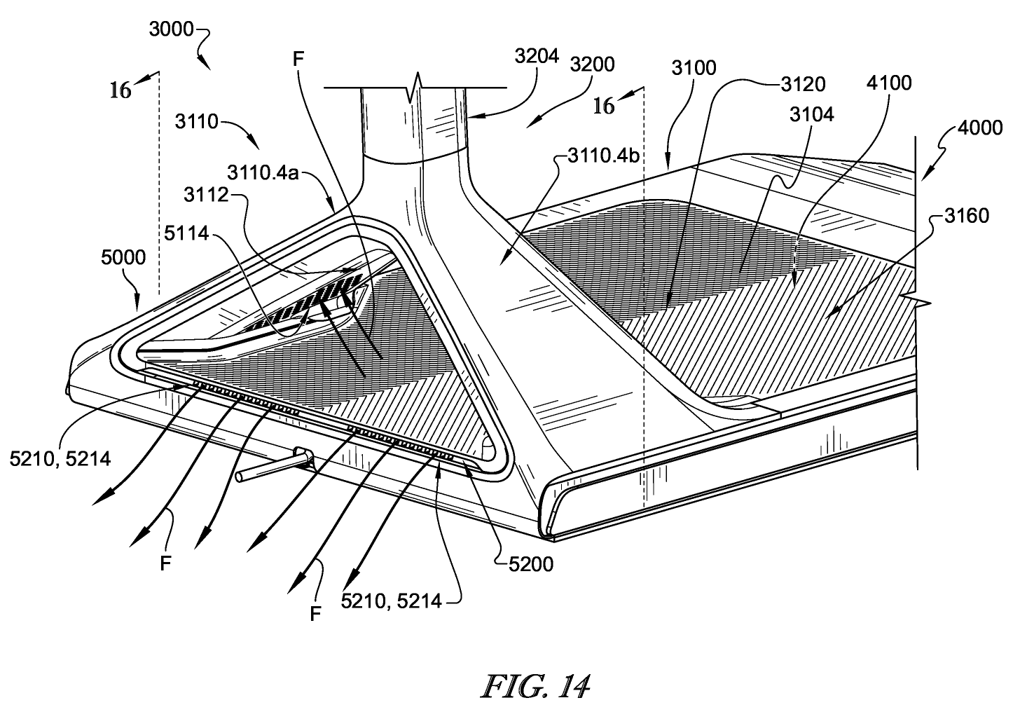

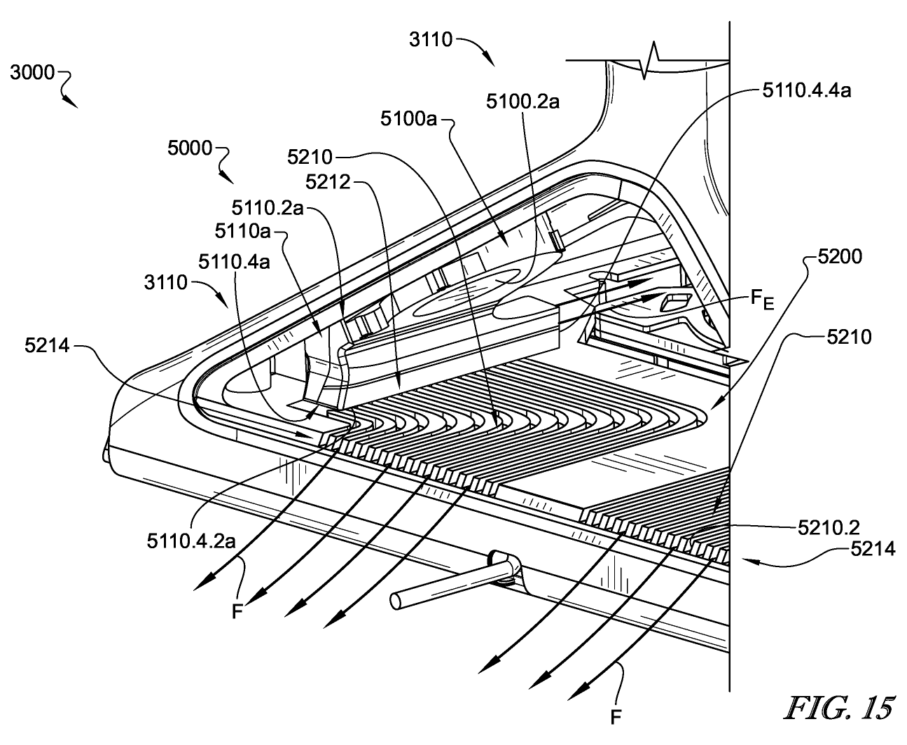

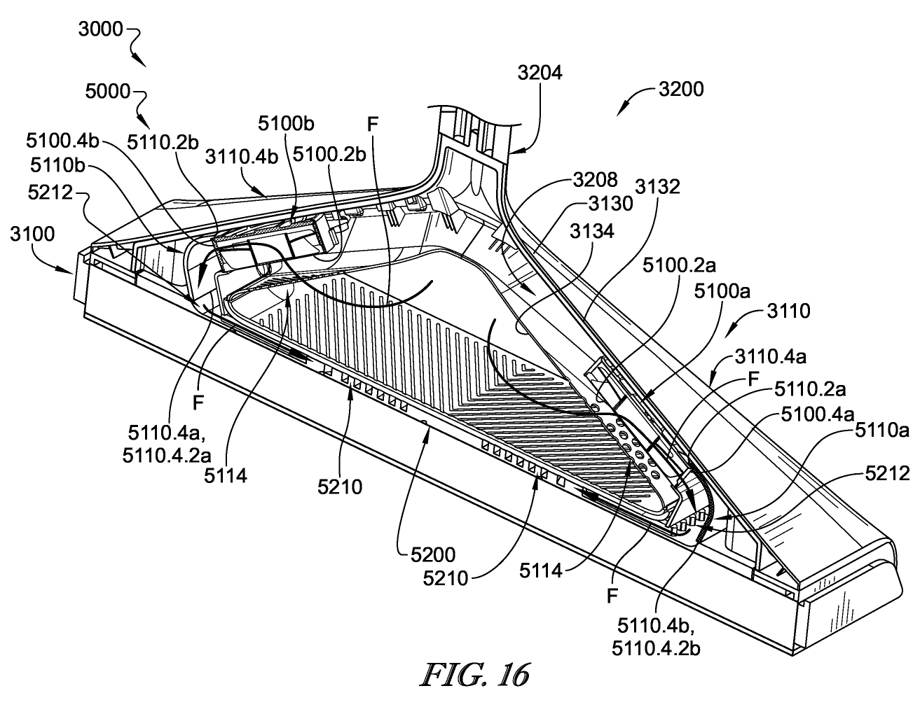

The docking station 3000 includes: (i) a charging mat 3100, (ii) a support stand 3200 (also referred to as a support frame assembly), (iii) a wireless power transfer (WPT) system 4000, (iv) a station electronics assembly 3500, (v) an active cooling system 5000, and (vi) a cleaning system 5500 as shown in FIGS. 9-16. The charging mat 3100 includes a base housing 3150 and a wireless power transmitter device 4020 (also referred to as wireless power transmitter, transmitter device, or wireless power transfer (WPT) device). The support stand 3200 is coupled to the charging mat 3100 and includes: (i) a flared base 3110, (ii) a vertical support portion 3204, and (iii) a support cradle 3300, where the support cradle 3300 is positioned above the charging mat 3100 and configured to mechanically couple with the robot 1. The station electronics assembly 3500 includes: (i) a sensor assembly 3111, (ii) a communication transceiver 3400, and (iii) a station computing device 4350. The WPT system 4000 includes the wireless power transmitter device 4020 in the charging mat 3100 configured to transfer power to the robot 1, the station computing device 4350, and the communication transceiver 3400 configured to form a data communication link with the robot 1. The active cooling system 5000 is configured to facilitate the removal of thermal energy generated by the wireless power transmitter device 4020 in the charging mat 3100. The cleaning system 5500 is configured to facilitate the removal of foreign objects or debris from the charging mat 3100. In some embodiments, the cleaning system 5500 may be integrated into the active cooling system 5000 as discussed in further detail below.

The WPT system 4000 includes the wireless power transmitter device 4020 in the charging mat 3100 configured to transfer power to the robot 1, where the robot 1 is configured to receive power by induction. In the illustrative embodiment, the robot 1 includes a wireless power receiver system 212.6, wherein the left foot 92a and the right foot 92b each include a receiver coil assembly 936a, 936b. The WPT system 4000 is configured to interface with a wireless power receiver system 212.6 contained in the robot 1. The WPT system 4000 also includes the station computing device 4350 coupled to the sensor assembly 3111 and the communication transceiver 3400. The station computing device 4350 is configured to establish a data communication link with the robot 1 via the communication transceiver 3400 to facilitate positioning of the robot 1 for charging. The computing device 4350 may also communicate information from the sensor assembly 3111 to facilitate the positioning of the robot 1.

### a. Charging Mat

The charging mat 3100 includes: (i) a wireless power transmitter device 4020 configured to inductively couple with the robot 1 for charging of its battery pack and (ii) a base housing 3150 configured to substantially enclose the wireless power transmitter device 4020. The charging mat 3100 features a low-profile design (e.g., with an upper surface that is less than 8 inches, preferably less than 5 inches, and most preferably less than 2 inches above a support surface) dimensioned to facilitate positioning of the robot 1 to couple with the docking station 3000, including spacing and placement of the robot's feet 92. In some embodiments, the low-profile design of the charging mat 3100 allows it to be flush-mounted into a floor recess, thereby producing a surface that is substantially level with the surrounding floor and imposing no elevation change for the robot 1 during the docking procedure.

### i. Base Housing

The base housing 3150 includes: (i) a base frame 3152, (ii) a base layer 3148 coupled to a bottom surface of the base frame 3152 forming a compartment 3170, and (iii) a platform cover 3160 coupled to an upper surface of the base frame 3152 that substantially encloses the compartment 3170. The base frame 3152 is dimensioned to substantially contain the wireless power transmitter 4020 within the compartment 3170 and to couple with the support stand 3200. The base housing 3150 is also configured with a gentle ramp which helps to facilitate the robot's foot placement during the docking process. The gentle ramp may minimize the lift height for the robot 1, thereby making the docking process more robust and reducing the likelihood of a trip or a stumble, while also allowing the docking station 3000 to meet various safety standards.

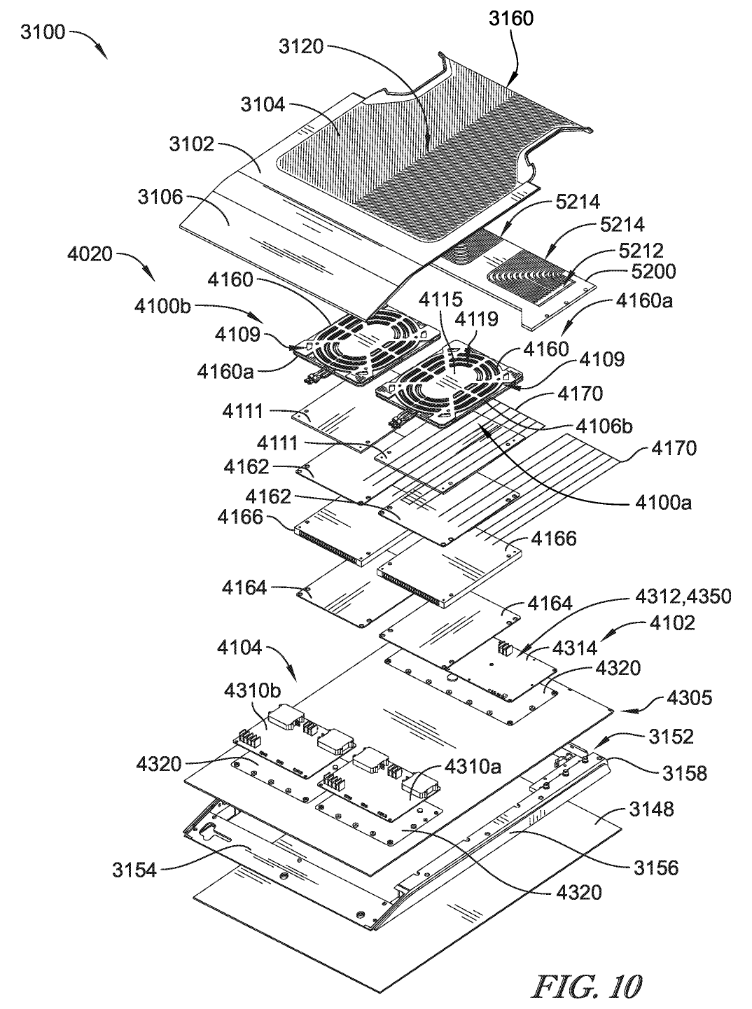

The base frame 3152 includes: (i) a front ramp portion 3154, (ii) a main support portion 3156, and (iii) a rear interface portion 3158 as shown in FIGS. 9 and 10. At least the main support portion 3156 and the rear interface portion 3158 may have a substantially C-shaped profile (in other embodiments, said profile may be U-shaped, V-shaped, or any other conventional shape) providing an internal shelf configured to receive and couple to the wireless power transmitter 4020, a bottom surface configured to receive the base layer 3148 configured to be in contact with the floor or support surface, and a top surface configured to receive the platform cover 3160. The left and right sides are substantially similar with mirrored features that include a gentle incline defining the front ramp portion 3154 configured to minimize the lift height of a foot 92 of the robot 1. The rear portion 3158 is configured to couple with the support stand 3200. The base layer 3148 couples to the bottom of the base frame 3152. This base layer 3148 provides a high-friction surface configured to inhibit the docking station 3000 from sliding on the floor and also can protect the floor surface from scratches. For example, the base layer 3148 may comprise a rubber sheet or any other similar material. Additionally/alternatively, the base layer 3148 may also include shielding layers to prevent EMI noise from radiating downward from the system. In some embodiments, the base layer 3148 may include a weighted or ballasted insert to further increase the stability of the docking station 3000 during docking and undocking maneuvers.

The platform cover 3160 provides a durable, protective covering for the internal components, engineered to withstand the static and dynamic loads exerted by the robot 1 during docking, charging, and undocking maneuvers. As shown in FIGS. 9 and 10, the platform cover 3160 can be composed of two different layers, wherein a first lower layer is designed as a support layer and the second upper layer is designed as a robot interface layer. For example, the first, lower layer may be made from a thicker (in comparison to the upper layer), durable material, and the second, upper layer is made from a thinner (in comparison to the lower layer), high-friction material. Specifically, the lower layer can be made from plastic, and the upper layer can be made from PPE foam or another flame-resistant compound. In other embodiments, the platform cover 3160 may be a single integrated layer fabricated from a reinforced composite material that provides both structural support and a high-friction interface surface.

The platform cover 3160 includes: (i) a substantially planar or flat portion 3102 and (ii) a ramped or angled portion 3106 as shown in FIGS. 9 and 10. The ramped or angled portion 3106 extends rearward from a frontal extent of the docking station and terminates at the start of the planar portion 3102. Said ramped or angled portion 3106 is coupled to the front ramp portion 3154 of the base frame 3152 and is not textured. In alternative embodiments, the ramped or angled portion 3106 may be extended along the entire side, or a portion of the sides, of the docking station 3000. This alternative design may help ensure that the docking station 3000 complies with ADA section 303 and/or OSHA requirements (e.g., 29 CFR 1926.501, which is incorporated herein by reference), wherein the slope of the ramped or angled portion 3106 is less than a specific ratio, such as 1:48, 1:10, or 1:8. Further, the ramped or angled portions 3106 that are located in the front or on the sides of the charging mat 3100 may be removable or may be made from a material that is different from that of the main body of the docking station 3000.

The planar portion 3102 extends rearward of the ramped or angled portion 3106 and is designed to overlay a major portion of the wireless power transmitter 4020. As such, the planar portion 3102 of the platform cover 3160 may include a wireless charging surface 3104. In other words, said wireless charging surface 3104 may occupy less than the entire planar portion 3102 and preferably more than a majority of the planar portion 3102. Said planar portion 3102, and more specifically the wireless charging surface 3104, is designed to support and underly the feet 92 of the robot 1 for wireless charging. In some embodiments, the wireless charging surface 3104 may include one or more alignment features, such as recesses or raised guides, that are contoured to correspond with the shape of the robot's feet 92 to promote consistent foot placement.

The planar portion 3102 and/or the wireless charging surface 3104 may be textured with a high-friction material and/or may include clear visual markings to provide a distinct target for the foot 92 placement of the robot 1. In the illustrative embodiment, the planar portion 3102 and/or the wireless charging surface 3104 is formed to include ribbing or grooves 3105 that may promote airflow under the robot's feet 92 when positioned on the charging mat 3100. This airflow under the foot 92 of the robot 1 may help foreign objects and/or debris to be dislodged or removed from the sole of the robot's foot 92 even when the robot 1 is in the fully docked state. Additionally, the wireless charging surface 3104 may be a distinctive color to be able to easily distinguish foreign objects and/or debris on the charging surface. For example, metal foreign objects may be gray or silver in color. The wireless charging surface 3104 may be a different distinctive color to ensure the metal foreign objects are easily detectable to the naked eye. In other embodiments, the wireless charging surface 3104 may not be textured (e.g., substantially smooth), may be transparent to show the internal electronics, may not include visual markings, and/or may include other indicia that are intended to communicate the brand, serial number, manufacture date, and/or any other information. In further embodiments, the ribbing or grooves 3105 may be oriented in a predetermined direction, such as a lateral direction from left to right, to direct the movement of dislodged debris away from the center of the wireless charging surface 3104 and toward the edges of the charging mat 3100.

### ii. Wireless Power Transmitter

The wireless power transmitter 4020 includes two transmitter coil assemblies 4100a, 4100b, a power supply unit 4102, and a charging controller 4104. The charging controller 4104 includes left and right transmitter power electronics 4310a, 4310b coupled to respective coil assemblies 4100a, 4100b and a transmitter controller 4312 (e.g., MCU). In various embodiments, the transmitter controller 4312 may also be coupled to or integrated with a station computing device 4350. The wireless power transmitter 4020 is received within the base housing 3150, where a base support plate 4305 is coupled to the base frame 3152.

The wireless power transmitter 4020 includes a pair of transmitter coil assemblies 4100a and 4100b, which are positioned adjacent to or near the wireless charging surface 3104 of the planar portion 3102 of the platform cover 3160. As such, the top surface of the transmitter coil assemblies 4100a and 4100b is within 50 mm, preferably within 25 mm, and most preferably within 5 mm of the wireless charging surface 3104 of said planar portion 3102 of the platform cover 3160. This arrangement causes the pair of transmitter coil assemblies 4100a and 4100b to be positioned directly beneath the wireless charging surface 3104. In addition to being positioned beneath and adjacent/near the wireless charging surface 3104 of the planar portion 3102, the transmitter coil assemblies 4100a and 4100b are arranged in a side-by-side configuration that corresponds to the neutral stance of the left and right feet 92 of the humanoid robot 1. This arrangement places the center of the coil assemblies within 400 mm, preferably within 300 mm, and most preferably within 250 mm of each other, while providing a gap of at least 100 mm and preferably more than 150 mm between the centers of said coil assemblies. The arrangement of the transmitter coil assemblies 4100a and 4100b of the wireless power transmitter 4020 in the charging mat 3100 involves a careful balancing of several factors, including power transfer efficiency, mechanical durability, thermal management, and seamless integration with the system's safety and foreign object detection architecture. In some embodiments, the side-by-side spacing between the transmitter coil assemblies 4100a and 4100b may be adjustable, for example, by using a sliding rail mechanism within the base housing 3150, to accommodate humanoid robots with different stance widths.

In the illustrative embodiment, the two coil assemblies 4100a, 4100b, the transmitter power electronics 4310a, 4310b, the transmitter controller 4312, and the power supply unit 4102 are shown positioned to be coupled to a base support plate 4305, which is a rigid substrate configured to support components of the wireless power transmitter 4020. In other embodiments, the power supply unit 4102 and/or the charging controller 4104 may not be coupled to base support plate 4305. Instead, said components may be housed in a separate structure that is distinct and physically separated from said docking station 3000. While the separate housing may be physically separated from the docking station 3000, it should be understood that the electronics contained within the housing are electrically coupled to the coil assemblies 4100a and 4100b arranged in the charging mat 3100.

### 1. Coil Assemblies

The wireless power transmitter 4020 includes two transmitter coil assemblies 4100a, 4100b, each coupled to the charging controller 4104. Each coil assembly 4100 may include (i) a coil module 4106, (ii) a shield 4111, (iii) a support plate 4162, (iv) a heat spreader 4166, and (v) a thermal interface material (TIM) layer 4164 as shown in FIGS. 9, 10, and 31-32. Each coil module 4106 includes a coil 4109 arranged within a carrier 4116 and covered by a protective cap 4160. In some embodiments, the TIM layer 4164 may be made of a thermally conductive silicon and may be used to facilitate thermal transfer. It should be understood that in other embodiments, the transmitter coil assemblies 4100a and 4100b may include fewer, additional, or different layers arranged to facilitate power transfer, minimization of EMI radiation, and thermal management. This layered design facilitates the transfer of heat away from the current-carrying coils 4109. In some embodiments, one or more of the layers may be bonded together using a thermally conductive adhesive to reduce thermal interface resistance between adjacent layers.

The transmitter coil modules 4106a, 4106b each include a collection of windings arranged as a coil 4109 having a predetermined pattern on a substrate or carrier 4116. In this embodiment, the coil 4109 is shown as a planar, racetrack-shaped, or ovular coil, which is a geometry that may be engineered to create an elongated and uniform charging area. The windings themselves are formed from an electrical conductor or wire 4117. In some embodiments, the wire 4117 may be Litz wire, which is made up of many fine, individually insulated strands woven together. This construction may be chosen to mitigate the effects of AC resistance at high frequencies, namely the skin effect, where current tends to flow only on the conductor's surface, and the proximity effect, where currents in adjacent conductors interact and further constrict the flow. By using Litz wire, these losses are reduced, which can increase the quality factor (Q-factor) of the coil 4109 and, consequently, its overall energy transfer efficiency.

The geometry of the coil 4109 can be selected and sized to accommodate the shape of the receiver coil assembly 936 that is arranged within the foot 92 of the robot 1, and to provide a significant degree of tolerance to minor misalignments in position and orientation. As such, the coil 4109 may be configured in a variety of shapes, including square, triangular, curvilinear (e.g., circular, oval, or elliptical), three-dimensional (e.g., helical or solenoidal coil), irregular, or amorphous, to optimize performance for a specific receiver coil design. Further, instead of being a winding of wire, the coil may be replaced with a solid bar, a flat planar piece of metal, printed circuit board (PCB) traces, conductive inks, polymers, or pastes printed onto a substrate, or any other known material configuration suitable for generating a magnetic field. In other embodiments, the transmitter coil assembly 4100 may also be part of a more complex array of coils. For instance, in some embodiments, the wireless charging surface 3104 may house multiple, concentric, or overlapping coils that are designed to create an even larger and more uniform effective charging area. Such advanced configurations may be selected to further enhance the robustness of the autonomous docking process by making the final placement of the robot's foot 92 even less precise. Further, the coils may be arranged in a phased array, could be actuated to allow for their physical repositioning to achieve optimal alignment, and/or may contain more than two coils that are arranged in a honeycomb or hexagonal pattern to create a contiguous charging surface. In yet another embodiment, the transmitter coil assembly 4100 may include a matrix of segmented coils, wherein each segment is individually addressable and may be activated or deactivated based on the detected position of the receiver coil assembly 936 to further improve coupling efficiency and reduce stray field emissions.

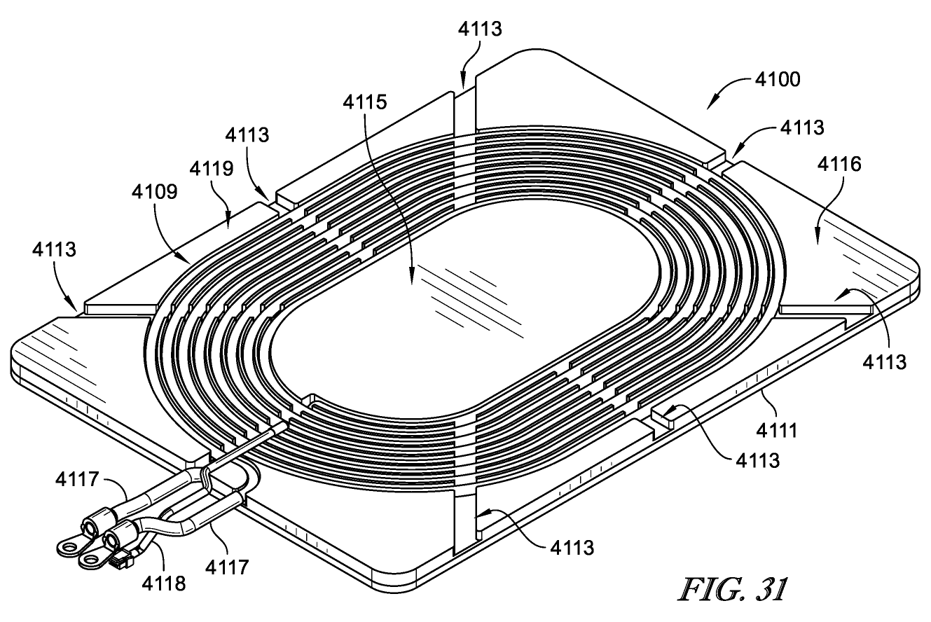

The carrier 4116 includes (i) a collection of straight grooves 4113 and (ii) a spiral groove or collection of concentric grooves 4119 as shown in FIGS. 31 and 32. The straight grooves 4113 extend across the carrier 4116 and intersect the grooves 4119. The grooves 4119 are configured to retain the wire 4117 in a predetermined geometry and spacing. This mechanical control over the coil's geometry may be a factor in performance, as the shape, turn-to-turn spacing, and overall dimensions of the coil 4109 influence the shape, strength, and uniformity of the generated magnetic field. In some embodiments, the predetermined geometry and spacing may be selected to improve or enhance the power-transfer efficiency of the transmitter coil assembly 4100. In some embodiments, the wire 4117 can rest within the grooves 4119 to increase the amount of surface area contact between the wire 4117 and the carrier 4116. This may be particularly beneficial when the carrier 4116 is made of a material that is electrically non-conductive and thermally conductive, as it enhances thermal transfer, such that the carrier 4116 can act as a thermal transfer device to help dissipate thermal energy generated by the coil 4109 during charging.

The carrier 4116 further defines a solid, raised oval central area 4115, which is circumscribed by the grooves 4113, 4119 and the windings of the coil 4109. The shape of this central area 4115 is configured to correspond to the general shape and contact area of the robot's foot 92. This region is constructed to be mechanically robust, capable of withstanding the compressive forces exerted by the weight of the robot 1 (e.g., a static load that is greater than 10kg per foot, preferably more than 25kg per foot, and most preferably approximately 40kg per foot, with dynamic peak loads potentially exceeding this during movement) as it steps on to and off of the charging mat 3100 during docking and undocking maneuvers. By providing a solid support structure directly under the primary contact point of the foot 92, the oval central area 4115 is configured to distribute the robot's weight and to reduce stress concentration on the windings of the coil 4109, which can enhance the long-term durability and reliability of the entire transmitter coil assembly 4100. In other embodiments, the carrier 4116 may be omitted entirely, and/or the central area 4115 may be omitted. In some embodiments, the central area 4115 may include one or more integrated alignment features, such as a subtle dome or depression, that interface with a corresponding feature on the sole of the robot's foot 92 to provide a tactile reference point for foot placement.

The transmitter coil assembly 4100 may further include a shield layer 4111 (e.g., a ferrite sheet), which functions as a magnetic shield. The shield layer 4111 is typically disposed on or integrated with the carrier 4116, on the side that is opposite the coil 4109 windings as shown in FIGS. 31 and 32. The primary function of the shield layer 4111 is to effectively manage the magnetic flux generated by the coil 4109. Ferrite materials, such as Manganese-Zinc (Mn-Zn) ferrite (e.g., TDK PC95 or DMR95), may be used for this purpose due to their high magnetic permeability and low core loss characteristics at the system's intended operating frequency (e.g., a frequency between 20 MHz and 200 kHz, and preferably between 70 and 100 kHz). In other embodiments, the shield layer 4111 may include or be made from nickel-Zinc (Ni-Zn) ferrite, amorphous magnetic materials, nanocrystalline materials, aluminum, copper, and/or magnetic composites. Furthermore, the shield layer 4111 may partially surround the coil, and/or the system may include a secondary, actively driven coil that generates a magnetic field to cancel out stray flux.

The high magnetic permeability of the shield layer 4111 provides a low-reluctance path for the magnetic field lines. This has the effect of guiding and concentrating the magnetic flux, directing it efficiently upwards toward the intended receiver coil 936 on the robot 1, while simultaneously reducing its undesirable radiation downwards into the base of the charging mat 3100. This flux guidance can improve the magnetic coupling between the transmitter and receiver coils, which can in turn enhance the overall power transfer efficiency of the system. Concurrently, the shield layer 4111 serves to shield the underlying components of the docking station, such as sensitive power and control electronics, from the strong, oscillating magnetic field. This shielding reduces the induction of eddy currents in underlying conductive structures, which would otherwise result in parasitic power losses, excessive heating, and the potential for electromagnetic interference (EMI) with the control circuitry. This also helps the system meet regulatory standards for electromagnetic emissions, such as FCC Part 15 and CISPR 25, the latest versions of both of which are incorporated herein by reference. In some embodiments, the shield layer 4111 may not be a single monolithic piece but can instead be constructed from a collection of individual ferrite bars or strips that are arranged in a parallel array. This segmented construction allows for a degree of flexibility and can help to mitigate the risk of fracture in the otherwise brittle ferrite material. In further embodiments, the segmented ferrite bars or strips may be encapsulated within a flexible polymer matrix to provide additional mechanical protection and to maintain their relative positions under vibration or thermal cycling.

In some embodiments, the transmitter coil assembly 4100 may be implemented as a "balanced coil," such as a bipolar coil that includes two identical circuits wound in a reverse orientation relative to each other. In such a configuration, when no foreign object 4112 is present, the magnetic fields generated by the two circuits will substantially cancel each other out, resulting in a substantially net-zero induced voltage at a designated sensing terminal. The introduction of a conductive foreign object 4112 can disrupt this delicate magnetic symmetry, breaking the null condition and producing a non-zero voltage that reliably signals the presence of the object 4112. In some embodiments, the balanced coil configuration may also serve a secondary purpose of reducing far-field electromagnetic emissions by virtue of the inherent field cancellation, which may assist in meeting regulatory compliance thresholds.

### 2. Transmitter Electronics

The wireless power transmitter 4020 may include the power supply unit 4102, charging controllers 4104a, 4104b, and a temperature sensor 4118. The charging controllers 4104a, 4104b may be communicatively coupled with a station computing device 4350 that may interface with other components (e.g., sensors, transceivers, controllers) housed in the docking station 3000. The wireless power transmitter 4020 includes charging controllers 4104a, 4104b coupled to respective transmitter coil assemblies 4100a, 4100b, where the charging controllers 4104a, 4104b receive power from the power supply unit 4102. In the illustrative embodiment, the charging controllers 4104a, 4104b and power supply unit 4102 are housed in the base housing 3150 of the charging mat 3100. The power supply unit 4102 supplies power to the charging controllers 4104a, 4104b, each of which regulate power delivery.

The charging controller 4104 includes left and right transmitter power electronics 4310a, 4310b and a transmitter controller 4312. In the illustrative embodiment, the left and right transmitter power electronics 4310a, 4310b of the charging controller 4104 may be embodied as printed circuit board assemblies (PCBA) configured to be coupled to the base support plate 4305. Similarly, the power supply unit 4102 may be configured on a main PCBA 4314. The main PCBA 4314 may further include or be coupled with a station computing device 4350 that includes a processor and memory. The transmitter controller 4312 may be a microprocessor (e.g., MCU) coupled to both transmitter power electronics 4310a, 4310b, individual microprocessors coupled to respective transmitter power electronics 4310a, 4310b, or the station computing device 4350 electrically coupled to both transmitter power electronics 4310a, 4310b, where the station computing device 4350 may also execute other functions.

In the illustrative embodiment, the power supply unit 4102 and the charging controller 4104 are configured to be coupled to the base support plate 4305. These electronics are configured to be protected from electromagnetic interference by a PCBA shield 3140 and from electrical shorts by insulating films 4320. In other embodiments, the power supply unit 4102 and charging controllers 4104a, 4104b may be arranged in a different manner. In other embodiments, the power supply unit 4102 and charging controllers 4104a, 4104b may reside in a separate housing, where they are electrically coupled to the transmitter coil assemblies 4100a, 4100b in the charging mat 3100. In some embodiments, the PCBA shield 3140 may be fabricated from a mu-metal alloy or a similar high-permeability material to provide enhanced shielding against both electric and magnetic fields.

The transmitter power electronics 4310a, 4310b may incorporate a resonant circuit design to enhance power transfer efficiency. This design may include strategically placed capacitors in series or parallel with the primary coils to form a resonant tank circuit precisely tuned to the operating frequency. By achieving resonance, the system minimizes reactive power losses and maximizes energy transfer efficiency. The resonance frequency may be dynamically adjusted to accommodate variations in load impedance or environmental factors. For example, the transmitter power electronics 4310a, 4310b may include DC converters 4316a, 4316b and matching networks 4318a, 4318b that optimize power transfer efficiency. In some embodiments, the resonant circuit design may be configured as one of a series-series (SS), series-parallel (SP), parallel-series (PS), or parallel-parallel (PP) compensation topology, with the topology being selected based on the coupling characteristics between the transmitter and receiver coils.

The transmitter power electronics 4310a, 4310b may include a variable frequency drive (VFD) or a phase-locked loop (PLL) control system to dynamically adjust the operating frequency in response to real-time coupling conditions. As the robot moves or shifts its position slightly during charging, the optimal coupling frequency may change due to variations in alignment and load impedance. A feedback loop incorporating impedance sensing and frequency tuning algorithms can continuously optimize the frequency, ensuring maximum power transfer efficiency while preventing detuning effects that may reduce charging performance. In some embodiments, the feedback loop may include a digital signal processor (DSP) that executes an adaptive control algorithm to compute the optimal frequency adjustment based on a comparison between measured and target impedance values.

To achieve higher efficiency and reduced power losses, the power electronics may leverage wide-bandgap semiconductor devices such as gallium nitride (GaN) or silicon carbide (SiC) transistors. These materials enable operation at significantly higher switching frequencies with lower losses compared to traditional silicon-based components. This advancement allows for more compact, lightweight power converters with improved thermal performance and reduced heat dissipation, making them suitable for high-power wireless charging applications. Additionally, the charging mat 3100 may incorporate a matrix of individually addressable coils, controlled through an intelligent coil selection algorithm. By selectively activating only the coils directly beneath the robot's feet, the system optimizes energy distribution, minimizing electromagnetic interference and improving efficiency. This adaptive approach ensures compatibility with robots of various sizes and configurations while reducing unnecessary energy dissipation in unoccupied regions of the mat. In some embodiments, the intelligent coil selection algorithm may use data from the foreign object detection system to determine which coils are safe to energize and which coils should remain inactive due to the proximity of detected debris or objects.

### 3. Heat Dissipation Features

The charging mat 3100 includes heat spreaders 4166, thermal conductors 4170, and/or the thermal transfer device 5200 that can be fabricated from a variety of metallic or other heat-conducting materials. For example, aluminum alloys, such as 6063 and 6061, are frequently employed in thermal transfer devices due to their favorable balance of good thermal conductivity, ease of formability, and cost-effectiveness. For applications demanding higher thermal performance, copper or copper alloys may be utilized, offering significantly enhanced thermal conductivity compared to aluminum. Furthermore, for scenarios that call for even higher thermal management capabilities, advanced materials such as pyrolytic graphite or graphite composites could be considered. These materials are renowned for their anisotropic thermal conductivity, exhibiting high conductivity along specific planes. In highly specialized implementations, liquids (e.g., water, glycol, liquid metal alloys) within sealed channels could be explored for their remarkably efficient heat transfer properties. The final selection of materials for the heat spreaders 4166 and the thermal transfer devices 5200 can be based on factors such as the anticipated thermal load, spatial constraints, weight considerations, and the target manufacturing cost.

Each heat spreader 4166 may be further coupled to the thermal transfer device 5200 by thermal conductors 4170 which extend from the heat spreader 4166 to the thermal transfer device 5200. The thermal conductors 4170a, 4170b extend through channels of the heat spreaders 4166 and are in contact with the interior surfaces of the channels to absorb and conduct the heat energy away from the WPT system 4000 and toward the thermal transfer device 5200. In some embodiments, the thermal conductors 4170 may be a solid piece of copper or other thermally-conductive material, and can implement conduction as a mechanism for allowing heat energy to flow from an area of high heat (e.g., near the transmitter coil assemblies 4100a, 4100b) to a relatively cooler area (e.g., the thermal transfer device 5200). In some embodiments, the thermal conductors 4170 may be configured as heat pipes. For example, the thermal conductors 4170 may be configured as cylindrical tubes incorporating a wick structure inside of the tube. A working fluid (e.g., water) absorbs heat at one end (the evaporator), turns into vapor, and travels to the cooler end (the condenser) where it releases heat and condenses. The wick then transports the liquid back to the evaporator via capillary action. In some embodiments, heat pipes may be highly effective at transferring heat over distances with little temperature drop and may be integrated into larger heat spreader and heat sink assemblies such as the thermal transfer device 5200 and/or the heat spreaders 4166. In further embodiments, vapor chambers may be used in place of or in combination with heat pipes, wherein the vapor chamber provides a two-dimensional heat spreading function that may be more effective at distributing thermal energy across a planar surface such as the base support plate 4305.

The heat spreaders 4166 and/or thermal conductors 4170 may be fabricated from a variety of metallic or other heat-conducting materials. For example, aluminum alloys, such as 6063 and 6061, are frequently employed in thermal transfer devices due to their favorable balance of good thermal conductivity, ease of formability, and cost-effectiveness. For applications demanding higher thermal performance, copper or copper alloys may be utilized, offering significantly enhanced thermal conductivity compared to aluminum. Furthermore, for scenarios that call for even higher thermal management capabilities, advanced materials such as pyrolytic graphite or graphite composites may be considered. These materials are renowned for their anisotropic thermal conductivity, exhibiting high conductivity along specific planes. In highly specialized implementations, liquids (e.g., water, glycol, liquid metal alloys) within sealed channels may be explored for their remarkably efficient heat transfer properties. The final selection of materials for the heat spreaders 4166 and the thermal transfer devices 5200 may be based on factors such as the anticipated thermal load, spatial constraints, weight considerations, and the target manufacturing cost.

In some embodiments, the thermal conductors 4170 may implement a circulating liquid coolant (e.g., water, glycol, or a specialized dielectric fluid) through a cold plate attached to the heat-generating component. The heat transfers from the component to the liquid, which is then pumped to a radiator where the heat is dissipated into the ambient air. In some embodiments, the thermal transfer device 5200 and/or the heat spreaders 4166 may be thermoelectric coolers (e.g., Peltier devices). These solid-state devices utilize the Peltier effect to create a temperature difference when an electric current is passed through them. One side of the device becomes hot while the other becomes cold. The cold side may be attached to a component to actively pump heat away to the hot side, which may be cooled by a conventional heat sink and fan. In some embodiments, the system may employ a hybrid approach in which a passive heat pipe network handles the baseline thermal load during standard charging modes and a thermoelectric cooler is engaged to supplement the passive network during high-power or rapid charging modes.

### a. Temperature Sensor

Each transmitter coil assembly 4100 may include at least one temperature sensor 4118 as shown in FIG. 32. The temperature sensor 4118 may be coupled to the charging controller 4104 or station computing device 4350. The temperature sensor 4118 may be physically coupled to or integrated within the transmitter coil module 4106, and positioned in close thermal contact with the wire 4117 or the carrier 4116 to facilitate accurate real-time temperature measurements. The primary function of the temperature sensor 4118 is to provide continuous thermal monitoring of the transmitter coil assembly 4100 during its operation. This is relevant as the flow of high-frequency alternating current through the wire 4117 can generate a significant amount of heat due to resistive losses (I²R losses). In one exemplary embodiment, the temperature sensor 4118 may be a Negative Temperature Coefficient (NTC) thermistor or another suitable thermal resistor.

The temperature data acquired by the sensor 4118 can be transmitted as a signal to the charging controller 4104 or another control unit within the docking station 3000. This data serves as an input for a closed-loop thermal management system. The thermal management system can be configured to take protective action if the temperature measured by the sensor 4118 exceeds a predetermined operational threshold. For instance, if the coil temperature approaches a limit that could risk damage to the wire's insulation, the carrier 4116, or adjacent components of the docking station 3000, the charging controller 4104 can be programmed to respond by reducing the transmitted power, thereby lowering the current in the wire 4117 and decreasing the rate of heat generation to reduce the risk of thermal runaway or damage. In some embodiments, where the temperature exceeds a maximum safety limit, the controller 4104 can terminate the power transmission entirely. In further embodiments, the thermal management system may implement a multi-threshold scheme, wherein a first threshold triggers a reduction in power, a second threshold triggers activation of the active cooling system 5000, and a third threshold triggers a complete shutdown of the wireless power transmitter 4020.

In one exemplary embodiment, the temperature sensor 4118 may be a Negative Temperature Coefficient (NTC) thermistor. Other examples include Amphenol Advanced Sensors (Thermometrics) type C100 and 95 series, the Vishay NTCLE100E3 series, the TDK (EPCOS) B57861S series, the Murata NXRT Series (e.g., NXRT15XH103FA1B040), the TE Connectivity GA series (e.g., GA10K3A1A), the Semitec AP-2 series, the Littelfuse DO-34 series, the Ametherm PANR series (e.g., PANR 103395), and the Honeywell 192-103LET-A01. It has been determined through testing that the design of the temperature sensor 4118 itself can be a factor; for instance, using an un-shielded wire for the thermistor can avoid having the sensor's own shielding be inductively heated by the magnetic field, which could otherwise lead to erroneous temperature readings. In some embodiments, multiple temperature sensors 4118 may be distributed at different radial positions along the coil 4109 to provide a spatial temperature profile rather than a single-point measurement.

### b. Support Stand

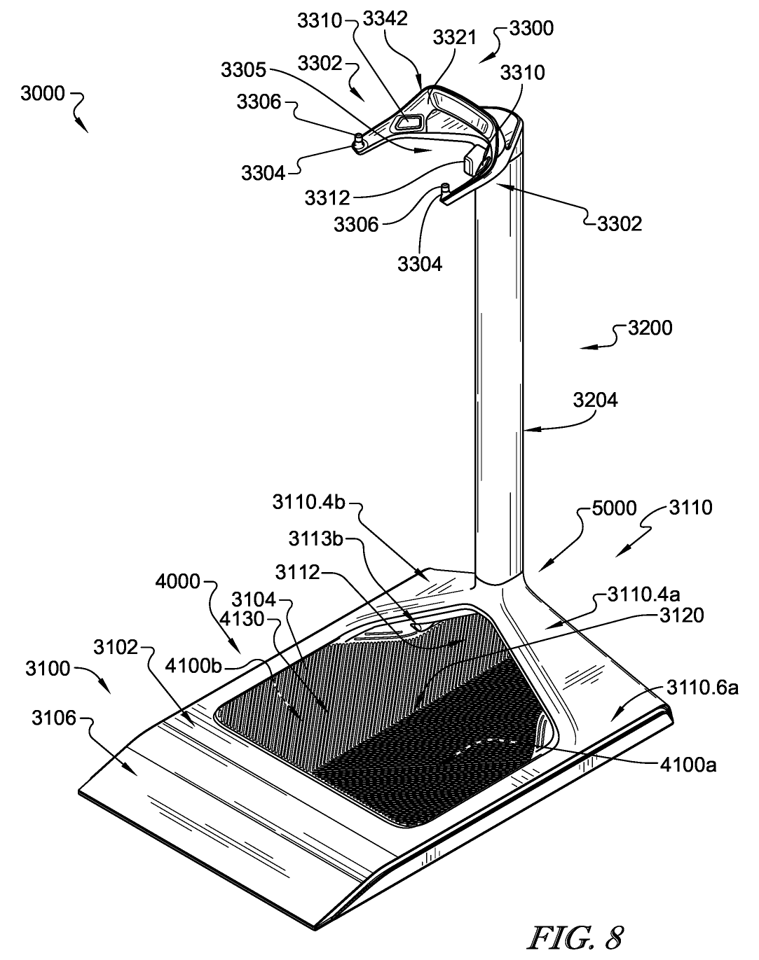

The support stand 3200 includes (i) a flared base 3110 that is integrated with or coupled to the rear portion 3158 of the base housing 3150 of the charging mat 3100, (ii) a vertical support portion 3204 that extends generally upward from the flared base 3110, and (iii) a support cradle 3300 configured to extend over the charging mat 3100 to couple with and support the robot 1 as shown in FIGS. 8-11. The materials for each component may be selected to optimize its particular performance characteristics. In some embodiments, the base housing 3150 may be constructed from a high-density, weighted polymer composite to provide a low center of gravity and improved stability against tipping, while the support stand 3200 may be formed from polymers, plastics, aluminum, or steel.

The support cradle 3300 is positioned in a forward-projecting, cantilevered manner relative to the vertical support portion 3204. This configuration allows the robot 1 to reverse backward into the support cradle 3300. This cantilevered design also ensures that the robot 1 coupled with the docking station 3000 is inherently stable by keeping the robot's center of mass positioned directly over the most stable part of the charging mat 3100, for example, the center 3120. The wide stance of the charging mat 3100 relative to the overall height of the support stand 3200 also increases the stability of the docking station 3000. This enables the robot 1 to be positioned in a forward-facing direction, wherein the support stand 3200, including the support cradle 3300, is positioned a predetermined distance that places the center of gravity of the robot 1 proximal to a center 3120 of the charging mat 3100, and/or places the robot's 1 feet 92 proximal to the center 3120 (e.g., in a target "sweet spot" of the charging coils in the charging mat 3100).

The support stand 3200 is designed to extend upwards from the charging mat 3100 to engage with the posterior and lateral aspects of the robot 1. Specifically, the support cradle 3300 is configured to engage with the robot 1 at its waist 604. In this engaged position, the robot 1 maintains a natural, upright posture and receives robust, multi-axis mechanical support, which effectively offloads the static gravitational load from the robot's own actuators onto the docking station 3000. Said upright posture may be conducive to long-term autonomous operation by allowing the robot 1 to be physically supported by the support stand 3200 while simultaneously positioned for receiving wireless charging power via the charging mat 3100. Additionally, this upright posture may be advantageous for operations in human-centric environments where available floor space may be limited, and where the robot 1 should maintain a minimal physical footprint to avoid causing an obstruction.

In various embodiments, the support stand 3200 may be removably attached to the charging mat 3100 to facilitate shipping and/or opportunity charging (e.g., charging while the robot 1 is performing a task). In some embodiments, the support stand 3200 may be removably attached using quick-release mechanical and electrical attachments or connectors. In other embodiments, the support stand 3200 may be permanently attached, adjustable, wall or floor mountable (wherein the charging mat 3100 is omitted), or omitted entirely to provide just the charging mat 3100. In some embodiments, the support stand 3200 may include a height adjustment mechanism, such as a telescoping section within the vertical support portion 3204, that allows the docking station 3000 to be configured for humanoid robots of different heights or waist heights.

In some embodiments, the support stand 3200 can be made of various materials such as stainless steel (e.g., SUS304), polymers or plastics (e.g., Acrylonitrile Butadiene Styrene (ABS), Polycarbonate (PC), Glass-Filled Nylon such as Nylon 6/6 GF30, Polyether Ether Ketone (PEEK)), aluminum (e.g., 6061-T6, 7075-T6), steel (e.g., 4130 Chromoly), fiberglass (e.g., G-10 Garolite fiberglass epoxy laminate), carbon fiber (e.g., T300), and/or combinations of these and any other appropriate materials. The selection of materials may be governed by the anticipated load, the target weight of the docking station 3000, the operating environment, and the manufacturing method. In some embodiments, different sections of the support stand 3200 may be fabricated from different materials, such as a steel vertical support portion 3204 for structural rigidity and a polymer support cradle 3300 for weight reduction and compliance against the robot's exterior surface.

### i. Flared Base

The flared base portion 3110 is configured to be coupled to the rear interface portion 3158 of the charging mat 3100. The flared base portion 3110 provides the mechanical interface at the rear portion 3158 of the charging mat 3100. It serves as the structural transition between the vertical support portion 3204 and the charging mat 3100 and provides a rigid connection. The flared base portion 3110 may also function as an aesthetic housing that conceals internal wiring and components routed between the charging mat 3100 and the support stand 3200.

As shown in FIGS. 8-11, the flared base 3110 has a triangulated structure having two legs or members 3110.4a, 3110.4b that extend from the vertical support portion 3204 to couple at the left and right extents of the charging mat 3100. The flared base portion 3110 includes an internal support structure 3132, an upper support shell 3130, and a lower support shell 3134. The upper and lower support shells 3130, 3134 form a flare cavity 3208 configured to (i) house components of the active cooling system 5000, (ii) house components of the sensor assembly 3111, and (iii) route wiring. The legs 3110.4a, 3110.4b may serve as mounting structures for base vision sensors 3113a, 3113b configured to monitor the state of the charging mat 3100 and the immediate docking area. An airflow channel 3112, formed between the flared base 3110 and the charging mat 3100, serves as an inlet for a thermal management system.

By transitioning from the narrow profile of the vertical support portion 3204 to a much wider footprint, the flare shape increases the stability of the docking station 3000. This helps prevent against any tipping or rocking moments that might be induced during the robot's docking maneuver. This flared shape also serves to distribute the stress from any load applied to the support stand 3200 over a much larger area of the charging mat 3100. The angled surfaces of the flare also act as integrated gussets, creating a naturally rigid triangulated structure that efficiently translates any lateral and bending forces into tension and compression, thereby providing substantial reinforcement to the overall structure. This method of construction, which in some embodiments can be achieved through a process like injection molding, casting, machining, or additive manufacturing, may result in a part that is both stronger and more rigid than a comparable bolted assembly.

### ii. Vertical Support Member

The vertical support portion 3204 of the support stand 3200 is configured to provide a structural support and load path between the support cradle 3300 and the charging mat 3100, via the flared base 3110. Further, the vertical support portion 3204 defines an interior cavity 3202 that provides a conduit through which one or more power and/or data busses may pass to deliver power and/or communications between the charging mat 3100 and electronic components housed within the support cradle 3300. In the illustrative embodiment, the vertical support portion 3204 has a substantially ovoid profile, but in some embodiments the profile may be any geometric shape in cross-section, including circular, square, triangular, polygonal, oval, or any other shape. In some embodiments, the interior cavity 3202 may include one or more cable management features, such as clips, channels, or guides, to secure and organize the power and data busses routed through it.

The vertical support portion 3204 extends generally upward from the flared base 3110, which is itself integrated with or securely coupled to the rear portion of the base platform surface 3102. The vertical support portion 3204 may be removably attached to the flared base 3110 in order to facilitate more compact shipping and easier transportation. To allow for said removal from the flared base 3110, the vertical support portion 3204 may be affixed to the flared base 3110 using quick-release mechanical and electrical attachments or connectors. In other embodiments, the vertical support portion 3204 may be permanently attached to the flared base 3110, may be adjustable in height, may be configured to be wall or floor mountable (wherein the charging mat 3100 is omitted), or may be omitted entirely to provide just the charging mat 3100 for a low-profile charging solution. Further, the vertical support member 3204 may be directly coupled to the mat without the flared based.

### iii. Support Cradle

The support cradle 3300 is coupled to and projects forward from the vertical support portion 3204 of the support stand 3200 as shown in FIGS. 8 and 9. The symmetrical, forward-projecting support cradle 3300 includes a main cradle body 3301 that provides the primary structural support for two outwardly extending cradle arms 3302. The support cradle 3300 includes: (i) a lower shell 3340, (ii) a cradle shell 3342, (iii) a rear shell 3344, and (iv) a tail shell 3345. The inner surface 3303 of the cradle 3300 is contoured to substantially match the complex three-dimensional geometry of the robot's waist 604. This contouring serves to distribute contact forces over a wide surface area, which helps prevent the creation of pressure points and ensures a snug, stable fit. In alternative embodiments, only a portion of the inner surface 3303 of the cradle 3300 may be contoured to substantially match the robot's exterior surface, or the inner surface of the cradle 3300 may not be contoured to substantially match the robot's exterior surface.

The cradle arms 3302 are defined by the lower shell 3340 and the cradle shell 3342 as shown in FIGS. 8 and 9. The cradle arms 3302 have a cantilevered configuration relative to the vertical support portion 3204 that helps define a retaining aperture 3305 that provides vertical support as well as horizontal bracing for the rear and lateral sides of the robot 1. The cradle arms 3302 extend symmetrically from the main cradle body 3301 and are formed with a curved shape to reduce point loads between the cradle arms 3302 and the vertical support portion 3204, thereby increasing the strength of the cradle arms 3302. This symmetry helps to simplify the docking process, as a symmetrical target is significantly easier for the robot's perception system to identify and model, and it allows the robot's navigation engine to generate more predictable and reliable docking trajectories. Each cradle arm 3302 terminates in a respective alignment post base 3304, from which a vertical alignment post 3306 extends upward.

Side gripper pads 3310, which may be made from a durable elastomer such as polyurethane with a specified durometer measurement, are positioned on the inner surface of the cradle arms 3302 as shown in FIGS. 8 and 9. These pads are supported by support posts 3311 that extend through apertures 3343 defined in the cradle shell 3342, in order to provide a soft, high-friction contact point, thereby helping to prevent any slippage without marring the exterior surface finish. A rear support pad 3312 is positioned centrally on the support cradle 3300 in order to provide stable, anti-rotational support to the back of the robot's waist 604. In some embodiments, the side gripper pads 3310 and/or the rear support pad 3312 may include embedded force sensors or pressure-sensitive elements that detect the contact force between the robot 1 and the support cradle 3300, allowing the station computing device 4350 to confirm a proper docking engagement.

An access opening 3320 is formed through a rear extent of the main cradle body 3301, allowing for the formation of a cradle handle 3330. The upper rim of the support cradle 3300 is integrated into an ergonomic cradle handle 3330, which allows for easy manual transportation and repositioning of the docking station 3000. The placement of the support cradle 3300 at the top of the structure leverages the stand's center of mass, making it feel balanced and lighter to lift than its actual weight might suggest, which may improve usability for human co-workers. In some embodiments, the cradle handle 3330 can also permit the robot 1 to pick up and transport its own docking station 3000 to a new (e.g., possibly more optimal) recharging location.

The cradle arms 3302 are shaped to form a guiding, funnel-like U-shaped geometry. This shape provides a form of passive mechanical guidance, creating a wide entry point that naturally corrects for any minor lateral misalignments as the robot 1 reverses into the docking station 3000. Each cradle arm 3302 terminates in a respective alignment post base 3304, from which a vertical alignment post 3306 extends upward. This symmetry helps to simplify the docking process, as a symmetrical target is significantly easier for the robot's perception system to identify and model. The vertical alignment posts 3306 of the cradle arms 3302 are designed to function as part of a high-precision kinematic coupling and are designed to engage with corresponding concave recesses 604.6.2 that are located on the waist 604 of the robot 1. This physical engagement provides definitive tactile feedback to the internal sensors of the robot 1 and ensures a highly repeatable final docked position. This high degree of precision is useful for optimizing the coupling efficiency for wireless power transfer, as even minor misalignments in the positioning of the coils can degrade the overall rate of charging. In some embodiments, the vertical alignment posts 3306 may incorporate a compliant tip, such as a spring-loaded or elastomeric cap, that provides initial tolerance during insertion and then seats firmly within the corresponding concave recesses 604.6.2 to maintain a rigid final alignment.

A rear support pad 3312 is coupled to the main body 3301, where the support cradle 3300 is coupled to the vertical support portion 3204. The rear support pad 3312 is positioned centrally to provide stable, anti-rotational support to the back of the robot's waist 604, as well as a soft, high friction contact point, preventing slippage without marring the robot's exterior finish. A communication transceiver 3400 is arranged within the structure of the cradle handle 3330 in order to facilitate high-bandwidth data communication with a corresponding transceiver 604.34 that is located on the robot 1 when it is docked. The docking station 3000 is configured such that when the robot 1 is received into the support cradle 3300 and docked, the communication transceiver 604.34 of the robot 1 and the communication transceiver 3400 of the docking station 3000 are substantially parallel to each other and separated by only a small or minimal air gap (e.g., 5 mm, 1 cm, 2 cm, or 5 cm).

The profile of the vertical alignment post 3306 may have a tapered or chamfered top surface. This geometry acts as a mechanical lead-in, effectively capturing the corresponding recess on the robot 1 and actively guiding it into final alignment, making the system more tolerant of small initial positional errors during the docking maneuver. While the primary function of the vertical alignment post 3306 is mechanical, its precise and highly repeatable engagement may make it a desirable location for incorporating additional functionalities. In some embodiments, the vertical alignment post 3306 may be configured to serve as a multi-function interface. For example, the vertical alignment post 3306 may be equipped with robust, spring-loaded electrical contacts that are designed to mate with corresponding conductive pads located within the recess of the robot's waist, thereby establishing a direct, high-amperage wired charging connection. This connection may be used to supplement the primary wireless charging system, thereby offering redundancy or enabling even higher-power rapid charging modes. In some embodiments, the vertical alignment posts 3306 may be configured to include various sensors that may be used to verify a nominal docking. For example, the vertical alignment posts 3306 may be configured to include integrated load cells that may be used to measure the amount of weight that is being placed upon each vertical alignment post 3306, in order to determine whether the robot 1 is fully docked and/or to determine that the robot 1 is evenly balanced upon the support cradle 3300. An uneven pressure distribution detected by the load cells would signal a misalignment, thereby prompting the robot 1 to make subtle micro-adjustments to its posture. In further embodiments, the vertical alignment posts 3306 may include proximity sensors, such as capacitive or inductive sensors, that detect the approach of the robot's waist 604 and provide approach distance data to the station computing device 4350, which may relay this information to the robot 1 via the communication transceiver 3400 for final-stage docking guidance.

### c. Station Electronics Assembly

The station electronics assembly 3500 of the docking station 3000 may include a station computing device 4350, a sensor assembly 3111, and a communications transceiver 3400. The station electronics assembly 3500 may be coupled to the wireless power transmitter 4020 and the active cooling system 5000 for integration of various systems. The station computing device 4350 may include or be coupled with one or more processors (e.g., transmitter controller 4312) contained in the docking station 3000. Additionally, the sensor assembly 3111, the communications transceiver 3400, the wireless power transmitter 4020, and the active cooling system 5000 may be communicatively coupled to the computing device 4350.

### i. Station Computing Device

The station computing device 4350 includes any combination of hardware, software, and circuitry to perform various computing functions that enable the docking station 3000 to operate semi- or fully-autonomously. Such functions may include current limiting, load balancing, coordinating with other docking stations, processing sensor information, communicating with the humanoid robot 1 based on the sensor information and goals, controlling the activation or deactivation of electrical components, and policy management. In some embodiments, the station computing device 4350 may maintain a local event log that records docking events, charging session parameters, fault conditions, and maintenance triggers.

The station computing device 4350 may operate as one or more general purpose processors or special purpose processors (e.g., digital signal processors, application specific integrated circuits (ASICs), field programmable gate arrays (FPGAs), etc.) that may be configured to execute computer-readable program instructions. Such instructions may be executed to provide controller operations for the docking station 3000. Specifically, the docking station 3000 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

The station computing device 4350 may incorporate machine learning algorithms to analyze historical charging data, adapt power delivery parameters, and optimize charging performance over time. By monitoring factors such as the robot's movement patterns, battery charge-discharge cycles, and environmental influences, the system can fine-tune parameters such as duty cycle, voltage, and resonance tuning. Predictive analytics may be employed to preemptively adjust charging characteristics, extending battery longevity. In some embodiments, the machine learning algorithms may include anomaly detection models trained on baseline sensor data from the sensor assembly 3111 to identify degradation trends in the transmitter coil assemblies 4100a, 4100b and/or the thermal management subsystem before a failure condition occurs.

### ii. Foreign Object Detection

The docking station 3000 includes a foreign object detection capability designed to identify the presence of foreign objects (e.g., coins, screws, paper clips, metal shavings, aluminum foil) or other debris on the wireless charging surface 3104 of the charging mat 3100. Because the transmitter coil assemblies 4100a, 4100b generate a powerful, high-frequency oscillating magnetic field during wireless power transfer, any nearby conductive material situated within the charging region 4130 is susceptible to rapid and intense inductive heating. Left undetected, such material presents a potential burn hazard to personnel, a risk of igniting nearby flammable materials, and a source of severe thermal damage to both the charging pad surface and the soles of the robot's feet 92. The foreign object detection capability therefore serves as a critical safety interlock for the wireless power transfer system 4000.

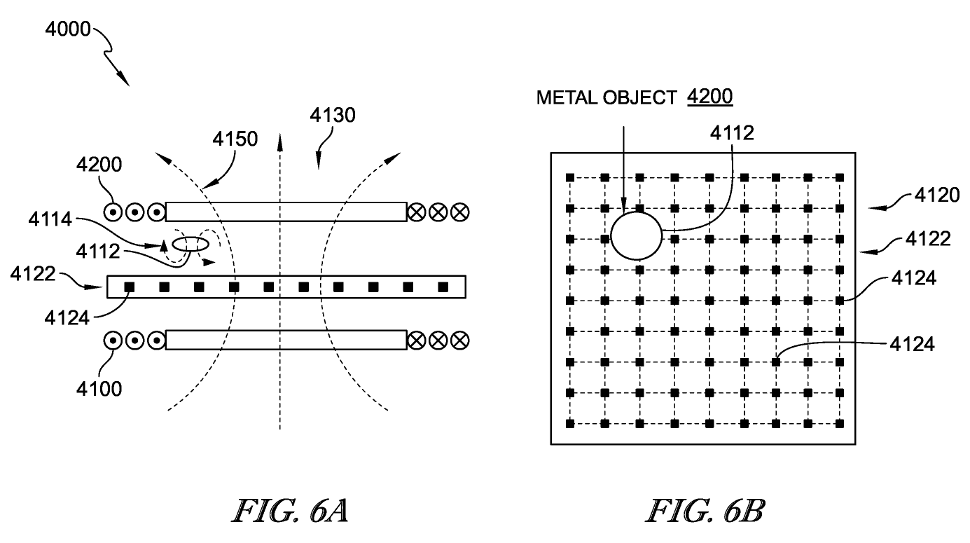

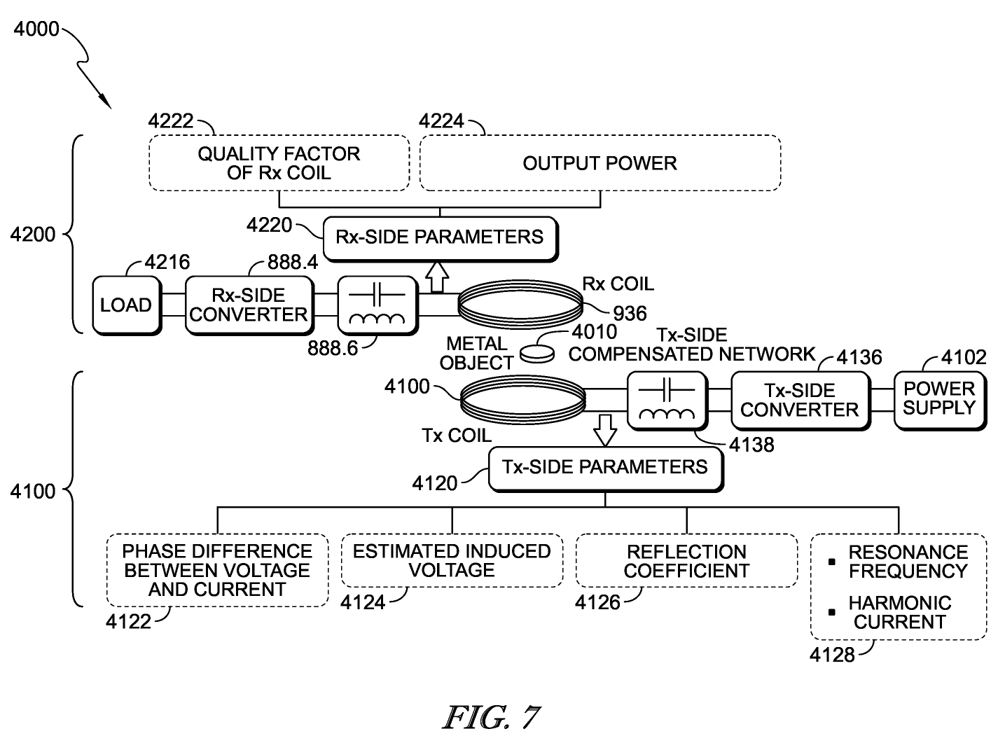

The physical principles that underlie these detection techniques are illustrated conceptually in FIGS. 6A–7, which depict a metallic foreign object 4112 situated within the charging region 4130 of a transmitter coil assembly 4100. As shown in FIGS. 6A–7, the wireless power transfer system 4000 is divided into a transmitter (Tx) side and a receiver (Rx) side, with the metallic foreign object 4112 positioned in the magnetic coupling path between them. On the transmitter side, a power supply 4102 provides initial energy to a Tx-side converter 4316 within the charging controller 4104. The converter 4316 includes a high-frequency inverter that drives the primary coil 4109 through a Tx-side compensated network 4318, which is an impedance matching network tuned for resonance. The energized Tx coil 4109 generates a primary magnetic field 4150 within the charging region 4130. On the receiver side, an Rx coil 936 captures energy from the primary magnetic field 4150 and delivers it through an Rx-side compensated network 4218 and an Rx-side converter 4212, 4214 to the load 4216 (e.g., the robot's battery and onboard systems).

When the metallic foreign object 4112 is introduced into this electromagnetic environment, it disrupts normal system operation in two principal ways—it produces localized heating of the foreign object and it degrades the efficiency of wireless power transfer—both of which arise from the induction of eddy currents in the foreign object 4112 and together form the basis for the detection techniques described herein. Specifically, in accordance with Faraday's Law of Induction, the time-varying magnetic flux of the primary magnetic field 4150 passing through the conductive body of the foreign object 4112 induces an electromotive force, which in turn drives circular loops of current—known as eddy currents—within the object. The magnitude of these eddy currents depends on the strength and frequency of the primary magnetic field 4150, the electrical conductivity and magnetic permeability of the foreign object's material, and the geometry and size of the object itself.

The first detectable consequence of these eddy currents is thermal dissipation. Pursuant to Joule's first law, the flow of induced eddy currents through the inherent electrical resistance of the metallic foreign object 4112 results in resistive power dissipation described by the formula P = I²R. This conversion of electrical energy into thermal energy causes the temperature of the foreign object 4112 to rise, potentially to levels that pose a risk of damage to adjacent materials such as the wireless charging surface 3104 or the sole of the robot's foot 92. For foreign objects composed of ferromagnetic materials, an additional heating mechanism—hysteresis loss—may contribute to the temperature increase as the magnetic domains within the material are repeatedly reoriented by the alternating magnetic field. Empirical testing has confirmed that these thermal effects are readily measurable: even at half of the system's maximum power output (e.g., 1 kW), a small paper clip resting on the wireless charging surface 3104 in free air at an ambient temperature of approximately 25°C can exhibit a temperature rise of approximately 9°C within 60 seconds of the transmitter coil assembly 4100 being energized, and an M4 screw under the same test conditions can exhibit a temperature rise of approximately 6°C within the same period. The magnitude of the temperature rise may vary depending on the thermal coupling between the foreign object 4112 and adjacent surfaces; for example, a foreign object sandwiched between the charging surface 3104 and the sole of a foot 92 may exhibit a different rate of heat accumulation and peak temperature than the same object in free air, due to differences in convective and conductive heat dissipation paths. In some embodiments, empirical testing data of this kind may be used to establish material-specific temperature-rise lookup tables stored on or accessible to the station computing device 4350. The station computing device 4350 may reference these lookup tables to correlate a detected thermal signature with a probable material type and size of the foreign object 4112, thereby informing the selection of an appropriate remediation action.

The second detectable consequence is a degradation of wireless power transfer performance. In addition to producing heat, the eddy currents induced in the foreign object 4112 generate a secondary magnetic field 4114 that, according to Lenz's Law, is oriented to oppose the change in the primary magnetic field 4150 that created them, as shown in FIG. 6A. This opposing secondary field 4114 interferes with and distorts the primary magnetic field 4150 generated by the transmitter coil assembly 4100, causing the foreign object 4112 to act as a parasitic load that absorbs energy intended for the receiver coil assembly 936. This parasitic energy absorption leads to a measurable decrease in the overall power transfer efficiency of the system 4000 and provides a second, complementary detection modality: the sensors 3113a, 3113b and the metallic object detection system 4900 may monitor changes in system electrical characteristics—such as shifts in impedance, quality factor, or transfer efficiency—to identify the presence of a foreign object even in the absence of a detectable thermal signature.

### 1. Imaging-Based Foreign Object Detection System

In the illustrative embodiment, the sensor assembly 3111 includes base sensors 3113a, 3113b and a sensor cable assembly 3115 that is electrically connected thereto. The base sensors 3113a, 3113b are configured to monitor the state of the charging mat 3100 and the immediate docking area, performing functions that include thermal monitoring of the wireless charging surface 3104, detection of foreign objects present on or proximate to the transmitter coil assemblies 4100a, 4100b, and provision of visual data to aid the robot 1 during docking maneuvers.

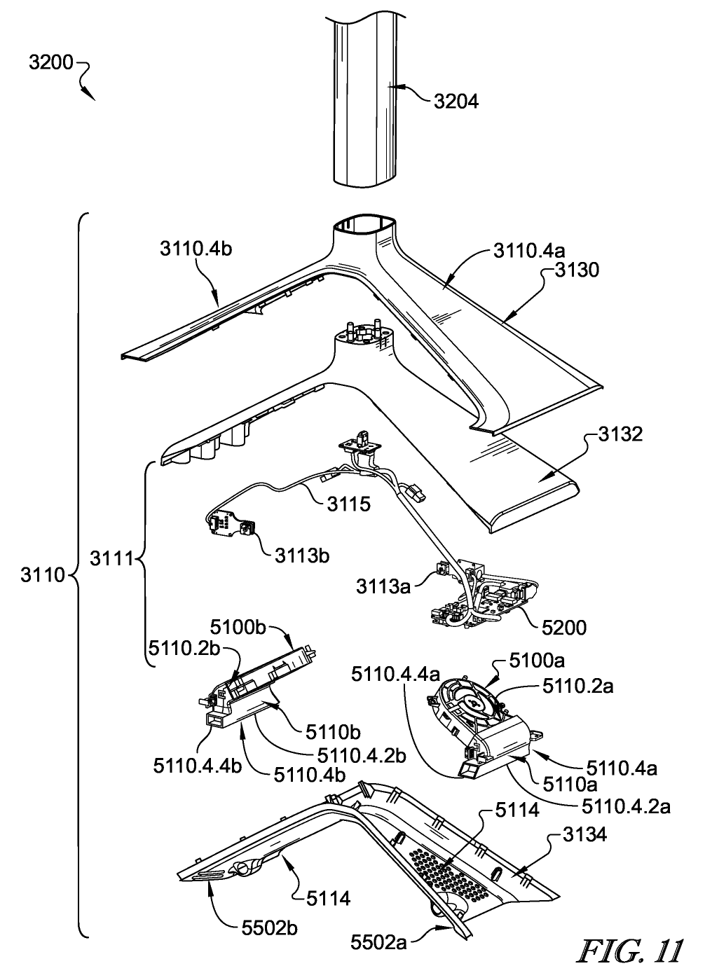

The base sensors 3113a, 3113b are positioned on the docking station 3000 and oriented to monitor the charging surface 3104 and the space above it. As shown in FIGS. 11–16, the base sensors 3113a, 3113b are located on the angled surfaces of the legs or members 3110.4a, 3110.4b of the flared base 3110, thereby affording each sensor a clear sightline to the wireless charging surface 3104 of the charging mat 3100. In other embodiments, the sensors 3113a, 3113b may be coupled to a portion of the charging mat 3100 (e.g., the wireless charging surface 3104), a portion of the support stand 3200 (e.g., the vertical support member 3204), or any other suitable aspect of the docking station 3000. The sensor cable assembly 3115 electrically connects to the base sensors 3113a, 3113b and is configured to provide power thereto, as well as to carry communications between the base sensors 3113a, 3113b and other electronic systems of the docking station 3000, including the station computing device 4350. In some embodiments, the sensor cable assembly 3115 may be based upon an existing wired communications standard, such as USB or power-over-ethernet (PoE). In some embodiments, the sensor cable assembly 3115 may include a shielded cable construction to reduce susceptibility to electromagnetic interference from the transmitter coil assemblies 4100a, 4100b during high-power charging operations.

In a presently described embodiment, the sensors 3113a, 3113b are temperature-based sensors, such as long-wave infrared (LWIR) thermal imagers (e.g., uncooled VOx microbolometer sensors such as the Infisense Tiny1-C or FLIR Lepton). These thermal imagers are configured to detect thermal signatures of foreign objects or debris present on the transmitter coil assemblies 4100a, 4100b and to create a continuous, real-time thermal map of the wireless charging surface 3104 and the soles of the robot's feet 92 throughout an entire charging cycle. Data from the thermal imagers may be processed by the station computing device 4350 to detect localized temperature increases, or "hotspots," which may be indicative of (i) poor alignment between the transmitter and receiver coils, (ii) the presence of non-metallic debris causing thermal insulation, or (iii) a malfunction in the charging components themselves. Temperature-based sensors may be particularly effective in detecting the thermal signature of metallic foreign objects being heated by induced eddy currents and in detecting the heat signature of warm-blooded living things (e.g., a cat resting on the charging surface 3104).

Additionally or alternatively, the sensors 3113a, 3113b may be vision-based, incorporating one or more small, wide-angle cameras. These cameras can provide the robot 1 with a close-up, downward-looking view of the wireless charging surface 3104 of the charging mat 3100—a perspective that may be partially or completely occluded from the robot's primary head-mounted cameras during the final moments of the reverse docking maneuver. To exploit this viewpoint, the wireless charging surface 3104, the vertical support member 3204, or any other aspect of the docking station 3000 may be augmented with high-contrast visual cues, such as painted foot outlines or embedded fiducial markers (e.g., QR codes or AprilTags). The vision-based sensors 3113a, 3113b may be specifically positioned and calibrated to detect these visual cues, and the robot's perception system 1420 may use the resulting imagery to perform a final visual-servoing sub-routine, making micro-adjustments to the position and orientation of the feet 92 to align them with the target markings. This provides a redundant layer of positioning validation that supplements data from the robot's own primary rear-facing camera and its internal odometry and proprioception, thereby increasing the overall success rate of the docking maneuver, particularly in environments with variable lighting conditions or where minor physical disturbances could occur. In some embodiments, the fiducial markers may be retro-reflective or may include integrated LEDs that are activated by the docking station 3000 upon detecting the robot's approach, to improve marker visibility under low-ambient-light conditions.

Whether implemented as thermal imagers, vision-based cameras, or a combination thereof, the geometric placement of the sensors 3113a, 3113b on the flared base 3110 defines respective fields of view 4300a, 4300b that are schematically represented in the figures as the triangular regions designated by reference numerals 4300a and 4300b. While the fields of view 4300a, 4300b and a corresponding overlap region 4302 are depicted as triangular in the illustrated example, these shapes are for purposes of discussion only; other shapes (e.g., ovals or other rounded shapes, other polygonal shapes) may be defined by the use of other types, arrangements, or quantities of sensors. The fields of view 4300a, 4300b are configured to exhibit substantial overlap in the overlap region 4302, which is located intermediate to the two transmitter coil assemblies 4100a, 4100b. This overlapping coverage provides redundant visual or thermal monitoring of the entire charging surface 3104 and is specifically configured to mitigate the problem of sensor occlusion that arises when the robot 1 is positioned upon the charging mat 3100, as the robot's own feet 92 and lower leg assemblies 6 can become significant visual obstructions during the final moments of the docking sequence.

Because each of the fields of view 4300a, 4300b encompasses a three-dimensional region of the charging mat 3100, the data from both sensors may be combined to form a stereoscopic field of view. The station computing device 4350 may process this stereoscopic depth information to identify objects in three dimensions, including the height and shape of foreign objects resting on the charging mat 3100 and the precise placement and orientation of the feet 92. In some embodiments, the stereoscopic depth information may be used to distinguish between flat debris (e.g., a paper clip lying flat) and raised objects (e.g., a bolt standing upright), which may inform the selection of an appropriate cleaning method. In some embodiments, the FOD system may include additional sensors to provide additional fields of view that further reduce the number of potential blind spots; for example, additional sensors may be configured to observe areas diagonally forward and outward from the feet 92 of the robot 1.

The operational advantage of this overlapping sensor arrangement can be appreciated by considering the sequence of events that occurs during docking. As the robot's right foot 92 descends upon the right-side transmitter coil assembly 4100a, the direct line of sight from the right-side sensor 3113a to the area immediately surrounding and potentially underneath that foot 92 becomes progressively obscured. However, by virtue of the geometric arrangement of the sensors, the left-side sensor 3113b, observing from a contralateral vantage point, maintains a completely unobstructed view of this zone, thereby significantly reducing the likelihood of a foreign object 4112 remaining undetected. Conversely, when the left foot 92 is positioned on the left transmitter coil assembly 4100b, the right-side sensor 3113a provides redundant observation to cover any areas that are occluded from the left-side sensor 3113b. This reciprocal, overlapping coverage enables a complete visual or thermal inspection of the entire charging surface 3104 from at least two distinct vantage points, thereby increasing the probability of detecting a foreign object irrespective of its position or its partial occlusion by the robot 1 itself. Such redundancy enhances both the safety and operational efficacy of the foreign object detection system and contributes to the overall robustness of the docking maneuver. The visual or thermal data from the sensors 3113a, 3113b may additionally be utilized by the robot's perception system 1420 to provide closed-loop positional feedback, enabling the robot's control system to make fine adjustments to the position and orientation of the feet 92 relative to target markings on the charging surface 3104. This provides a valuable, independent layer of positioning validation that supplements data from the robot's own proprioceptive sensors and rear-facing cameras, thereby increasing the overall success rate of autonomous docking, particularly in complex environments with variable lighting conditions or where minor physical disturbances might occur.

### 2. Field-Based Foreign Object Detection System

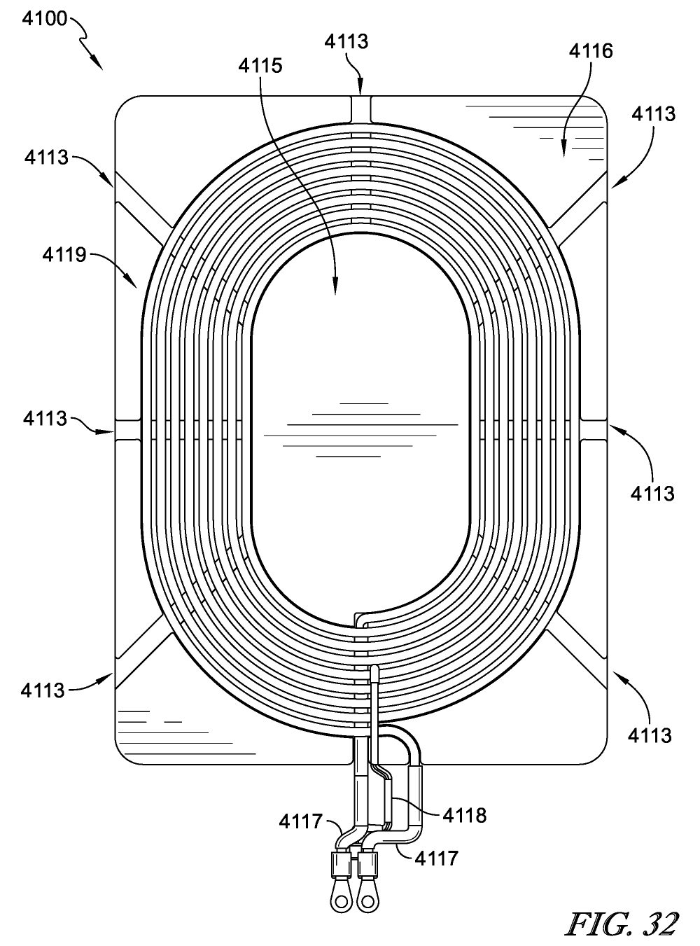

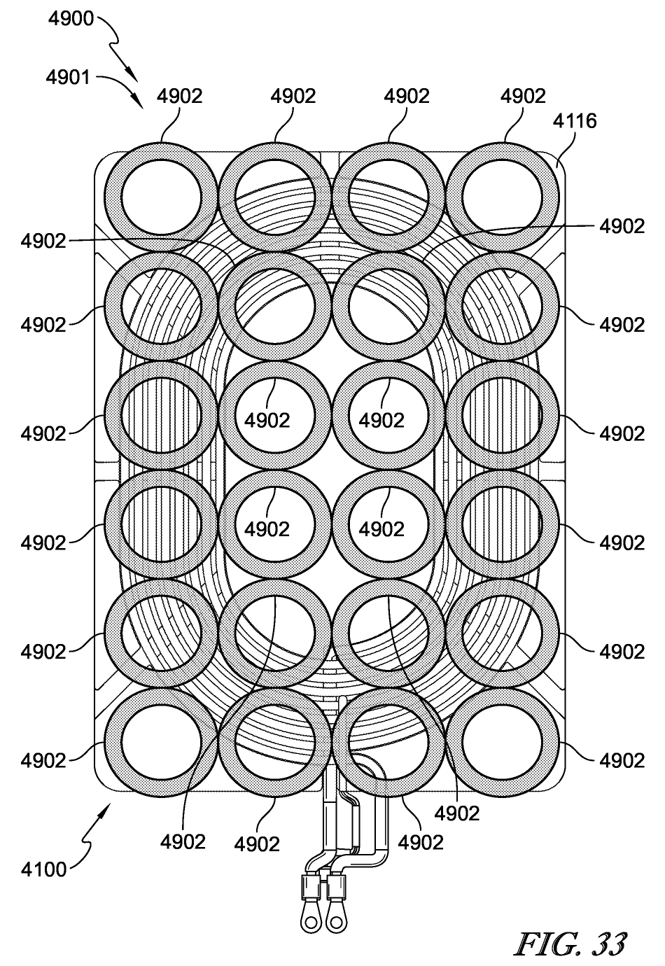

In addition to, or instead of, the sensors 3113a, 3113b, the sensor assembly 3111 may further include a field-based foreign object detection (FOD) system 4900. The field-based FOD system 4900 includes an auxiliary sensor coil array 4901 disposed over each transmitter coil assembly 4100a, 4100b, as illustrated in FIGS. 33–39. That is, a respective auxiliary sensor coil array 4901 is associated with each of the transmitter coil assemblies 4100a, 4100b so that the field-based FOD system 4900 provides independent sensing coverage for each charging zone of the docking station 3000. In some embodiments, the auxiliary sensor coil array 4901 constitutes a component of a multi-layered safety architecture of the wireless power transfer (WPT) system 4000, wherein the multi-layered safety architecture employs a combination of field-based sensing, imaging-based sensing, and parameter-based monitoring to provide comprehensive foreign object detection coverage. The auxiliary sensor coil array 4901 is specifically designed for high-sensitivity detection of metallic foreign objects that may be present on or near the wireless charging surface 3104. In operation, the dedicated field-based FOD system 4900 is configured to distinguish the unique electrical signature of a foreign object 4112 from other electrical variations that may arise from non-hazardous sources, such as slight misalignment of the receiver coil assembly 936 relative to the transmitter coil assembly 4100. In particular, the change in reflected impedance caused by a very small metallic object—such as a coin, a screw, a metal washer, a paper clip, metal shavings, or a piece of aluminum foil—can fall within the normal operational variance caused by variations in the robot's foot placement on the wireless charging surface 3104. This overlap in impedance signatures can render simpler, single-parameter detection methods potentially unreliable for distinguishing between benign operational variations and the presence of a true foreign object 4112. Accordingly, the dedicated field-based FOD system 4900 provides a more sensitive and spatially direct method for detecting localized disturbances in the magnetic field 4150 generated by the transmitter coil assembly 4100, as will be described in further detail below.

As one component of this multi-layered safety architecture, the field-based FOD system 4900 may incorporate a tunnel magnetoresistance (TMR) sensor matrix configured to spatially resolve the magnetic field distribution between the transmitter coil assembly 4100 and the receiver coil assembly 936. The TMR sensor matrix comprises a two-dimensional array of individual TMR sensor elements disposed beneath or adjacent to the transmitter coil assemblies 4100a, 4100b, with the sensor elements distributed across the charging region 4130 at a spacing selected to provide sufficient spatial resolution for detecting objects of a target minimum size (e.g., objects having a footprint on the order of a coin or smaller). Each TMR sensor element measures the local magnetic field strength at its position, and the collective readings from the array are assembled by the station computing device 4350 into a spatial magnetic field map representing the instantaneous field distribution across the charging region 4130. During an initial calibration phase, which may be performed at manufacturing or upon installation of the docking station 3000, the station computing device 4350 records a baseline magnetic field map for one or more known alignment conditions of the receiver coil assembly 936 relative to the transmitter coil assembly 4100. During subsequent operation, the station computing device 4350 continuously compares the real-time magnetic field map against the stored baseline map and identifies deviations that exceed a predetermined threshold. Various examples of sensors that could be used as the TMR sensors include, without limitation, the TDK TAS214x and TAD214x series, the Allegro MicroSystems CT100, CT310, CT8150, and CT8152, the NVE Corporation AAT series (e.g., AAT006-10E) and ASR series (e.g., ASR002-10E), and the MultiDimension Technology (MDT) TMR2102, TMR2104, TMR29xx series (e.g., TMR2905, TMR2922), and TMR9082.

The TMR sensor matrix enables the FOD system 4900 to perform multiple detection functions, including detecting misalignment of the receiver coil assembly 936 relative to the transmitter coil assembly 4100, identifying the presence of metallic objects within the charging region 4130, and monitoring the overall charging performance of the WPT system 4000. When a metallic object, such as the foreign object 4112, is present within the charging region 4130, the foreign object 4112 induces a localized offset or perturbation in the magnetic field 4150 that deviates from the expected field distribution for a given alignment condition. The TMR sensor matrix detects and quantifies this offset by measuring the resulting spatial deviation in the magnetic field distribution across the charging region 4130, thereby enabling the FOD system 4900 to identify the presence, and in some embodiments the approximate location, of the foreign object 4112 on the wireless charging surface 3104. In some embodiments, the outputs of the individual TMR sensor elements may be read sequentially via a multiplexer circuit connected to the station computing device 4350, and in other embodiments, the TMR sensor elements may be read in parallel to reduce the scan cycle time and increase the temporal resolution of the field map.

Complementing the field-based spatial detection provided by the TMR sensor matrix and the auxiliary sensor coil array 4901, the multi-layered safety architecture of the WPT system 4000 may further employ parameter-based monitoring of the electrical operating characteristics of the WPT system 4000 to identify the presence of a foreign object 4112. In particular, the presence of the foreign object 4112 within the charging region 4130 can alter the reflected impedance as seen by the transmitter coil assembly 4100. This alteration in reflected impedance can detune the resonant circuit of the WPT system 4000 by changing its effective inductance and its quality factor (Q-factor), thereby shifting the WPT system 4000 away from its optimal operating frequency. Such detuning can reduce power transfer efficiency and may cause the power electronics to operate outside of their designed safe operating parameters. As noted above, the detection of such impedance changes through parameter-based monitoring alone can be compounded by the fact that the impedance variation caused by a small foreign object 4112 can be of a similar magnitude to the impedance variation caused by a slight misalignment of the receiver coil assembly 936. This similarity in impedance signatures underscores the advantage of combining the spatially resolved field-based detection of the TMR sensor matrix with the parameter-based monitoring techniques described herein, so as to provide more robust and reliable foreign object detection across a range of operating conditions.

The parameter-based monitoring of the WPT system 4000 can be performed on either the transmitter side (Tx-side) or the receiver side (Rx-side) of the system, or on both sides simultaneously for enhanced detection reliability. On the Tx-side, the parameters 4120 that can be monitored by the FOD system include, but are not limited to: (i) the phase difference between the voltage and current 4122, (ii) the estimated induced voltage 4124, (iii) the reflection coefficient 4126 of the transmitter coil, and (iv) the resonance frequency or harmonic current 4128 of the system. The presence of the metallic foreign object 4112 within the charging region 4130 can cause detectable deviations in one or more of these Tx-side parameters 4120, and these detected deviations can be used by the charging controller 4104 to trigger a FOD event signal change. In response to the FOD event signal change, the charging controller 4104 may initiate one or more protective actions, such as reducing power output, halting power transmission, or generating an alert to a supervisory control system.

On the Rx-side, the parameters 4220 that can be monitored by the FOD system include, but are not limited to: (i) the quality factor (Q-factor) of the receiver coil 4222, (ii) the output power 4224 delivered to the load 4216, and (iii) the surface temperature of the charging surface 3104. By acting as a parasitic load within the magnetic field 4150, the foreign object 4112 can absorb a portion of the transmitted energy, thereby lowering the quality factor of the receiver coil assembly 936 and causing a measurable drop in the output power 4224 delivered to the load 4216.

The concurrent monitoring of both Tx-side parameters 4120 and Rx-side parameters 4220, in conjunction with the spatially resolved field-based detection provided by the TMR sensor matrix and the auxiliary sensor coil array 4901, enables the multi-layered safety architecture of the WPT system 4000 to reliably detect and respond to the presence of a foreign object 4112 across a wide range of object sizes, materials, and placement conditions within the charging region 4130. Because the individual detection modalities described above have different strengths and different susceptibilities to false positives, the charging controller 4104 or the station computing device 4350 may implement a detection fusion logic that combines the outputs of the multiple modalities to produce a unified FOD determination with a higher confidence level than any single modality alone. In some embodiments, the detection fusion logic may employ a weighted voting scheme in which each detection modality contributes an independent detection score—for example, a binary detection flag or a continuous confidence value—and the system triggers a FOD event when the weighted sum of the individual scores exceeds a predetermined detection threshold. In such embodiments, the weights assigned to each modality may be predetermined based on empirical characterization of each modality's sensitivity and false-positive rate for objects of various sizes and materials, or the weights may be adaptively adjusted during operation based on the prevailing operating conditions (e.g., current power level, alignment quality, or ambient temperature). In other embodiments, the detection fusion logic may employ a threshold-based decision tree in which the system first evaluates the output of the highest-sensitivity modality (e.g., the TMR sensor matrix or the auxiliary sensor coil array 4901) and, if that modality reports a potential detection, cross-checks the result against one or more corroborating modalities (e.g., the parameter-based monitoring or the thermal imaging data from the sensors 3113a, 3113b) before committing to a FOD event determination. This cross-checking reduces the incidence of false-positive detections that could unnecessarily interrupt charging operations. In still other embodiments, the detection fusion logic may employ a machine-learning classifier trained on historical sensor data from multiple modalities to identify patterns indicative of a foreign object 4112 versus patterns indicative of benign operational variations. Regardless of the particular fusion approach, the combined use of spatially resolved field-based detection, system-level parameter monitoring, and imaging-based thermal or visual detection provides a comprehensive and robust safety architecture that is more reliable than any single detection method operating in isolation.

FIGS. 33–39 illustrate seven alternative embodiments of the auxiliary sensor coil array that may be employed within the field-based FOD system 4900. Before describing each embodiment in detail, it is useful to identify the operational principles and design considerations that are common to all seven embodiments, so that the description of each individual embodiment can focus on the features that distinguish it from the others.

In each of the seven embodiments, the auxiliary sensor coil array is disposed over or adjacent to the transmitter coil assembly 4100, and includes a collection of individual sensor coils that are arranged to provide coverage over the active area of the transmitter coil assembly 4100. The operational principle common to all embodiments is based on the law of electromagnetic induction: the time-varying magnetic field generated by the primary transmitter coil assembly 4100 induces a baseline voltage across the terminals of each sensor coil, and the introduction of a conductive foreign object into the magnetic field creates a localized distortion—caused by the secondary magnetic field generated by eddy currents within the object—that alters the magnetic flux passing through nearby sensor coils and produces a measurable change in their induced voltage. The sensor coil arrays may be operated in a passive mode, in which the sensor coils derive their excitation from the primary magnetic field generated by the transmitter coil assembly 4100 during power transfer, or in an active mode, in which a separate, dedicated driver circuit generates its own low-power, high-frequency magnetic field specifically for sensing, allowing the FOD system 4900 to operate even when the main power transfer is inactive.

In several of the embodiments described below, the sensor coil array may be implemented using a balanced or differential configuration, a technique sometimes referred to as the "current balance theory." In such configurations, pairs or groups of sensor coils are wound or connected in opposing directions such that, in the presence of the uniform primary magnetic field, the voltages induced in them effectively cancel each other out, resulting in a net-zero signal. This balanced state provides a very stable baseline with a high signal-to-noise ratio. The presence of a localized foreign object breaks this symmetry, as the object will inevitably be physically closer to some coils than others, affecting one coil in a pair more than its counterpart. This asymmetry produces a non-zero differential signal that is readily detectable by the system's control electronics, including in the presence of significant background noise or fluctuations in the main power field.

A recurring design challenge across all embodiments is the avoidance of "blind zones" or "dead zones"—areas where a foreign object might go undetected because it is positioned at a location of perfect or near-perfect symmetry with respect to a sensor coil or a balanced pair of sensor coils, causing its effect on the magnetic field to be nullified. The seven embodiments described below employ different geometric strategies—including grid patterns, elongated coils, multi-layer overlapping coils, hexagonal tessellations, and symmetric strip arrangements—to reduce or eliminate such blind zones.

In each embodiment, the signals from the sensor coils (or balanced pairs thereof) are monitored by a dedicated control unit, which in some embodiments may be part of the charging controller 4104. The control unit processes the signals—for example, by using an analog-to-digital converter (ADC) to measure the voltage or inductance from each sensor coil—and analyzes the pattern of changes across the entire array to detect the presence of a metallic foreign object, and in some embodiments to estimate its size and location on the charging surface. Upon detecting a signal pattern indicative of a metallic foreign object, the control unit is configured to take immediate protective action, such as terminating or reducing power transmission, to mitigate any hazardous heating of the object. Furthermore, in some implementations, information related to the detected object, such as its presence, estimated size, or location, can be transmitted to the robot 1. The robot 1 can be configured to respond to this information by, for example, aborting the docking procedure, alerting a human operator, or initiating a cleaning or removal protocol before re-attempting to charge.

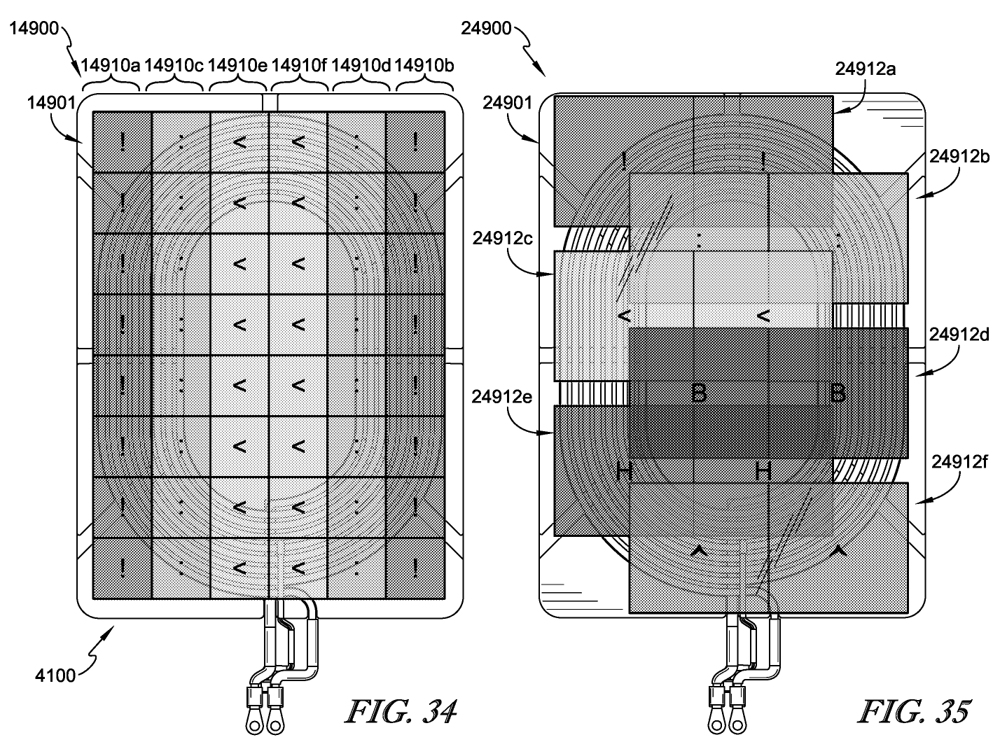

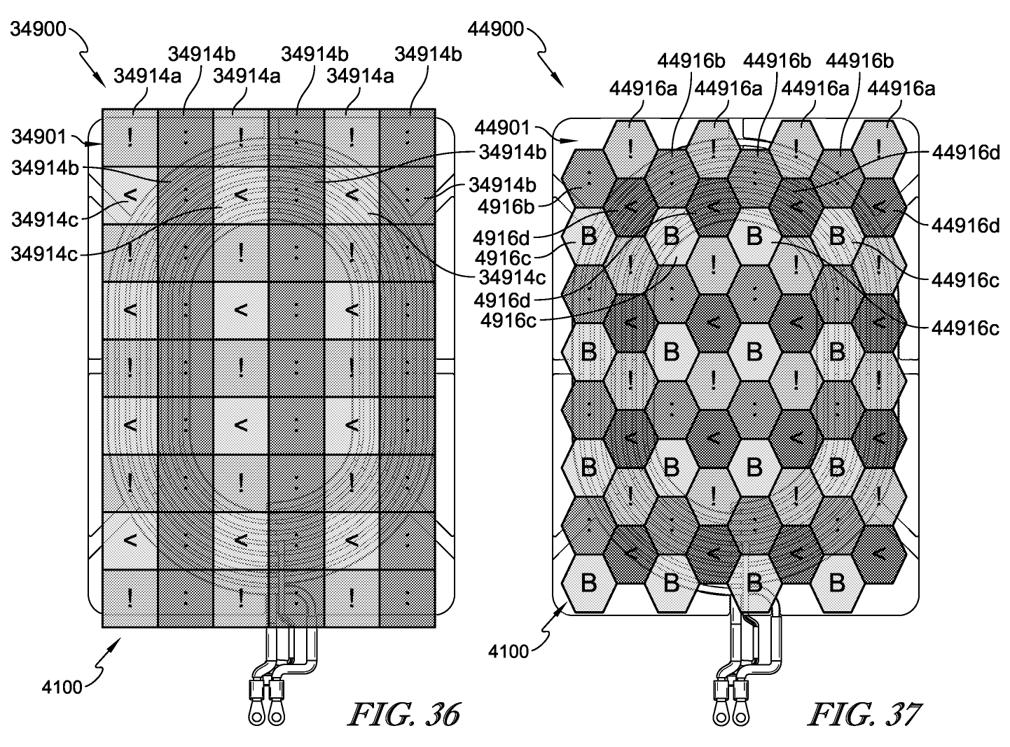

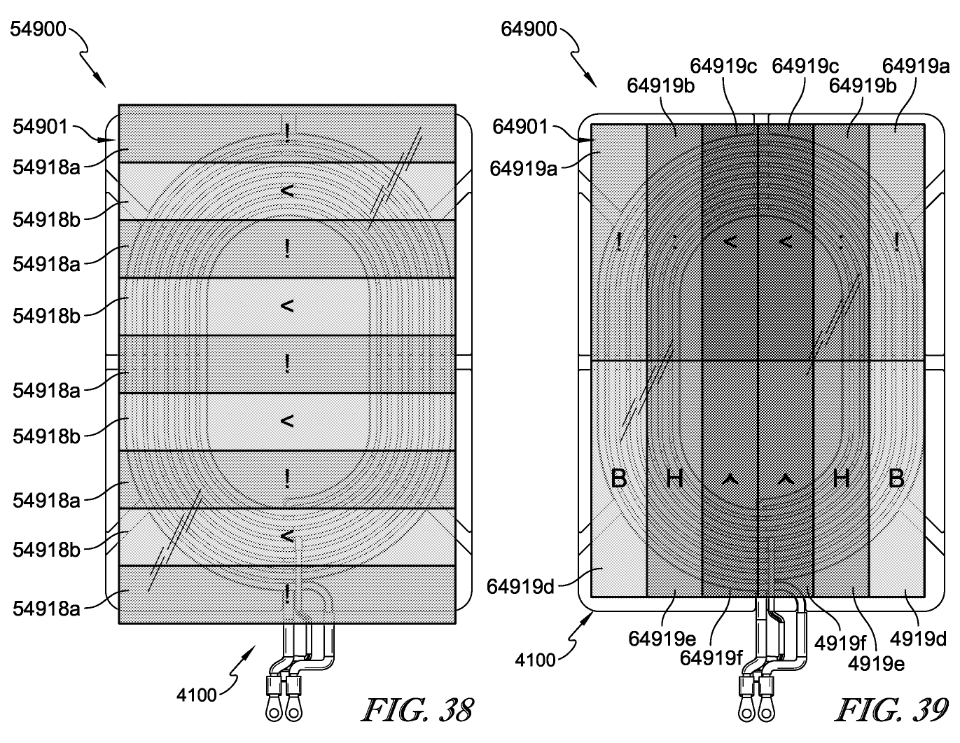

FIG. 33 shows a first embodiment of a field-based FOD system 4900 which has a grid-like sensor coil array 4901. FIG. 34 shows a second embodiment of a field-based FOD system 14900 which has an elongated coil array 14901. FIG. 35 shows a third embodiment of a field-based FOD system 24900 which has a multi-layer coil array 24901. FIG. 36 shows a fourth embodiment of a field-based FOD system 34900 which has a two-layer balanced coil array 34901. FIG. 37 shows a fifth embodiment of a field-based FOD system 44900 which has a multi-layer hexagonal coil array 44901. FIG. 38 shows a sixth embodiment of a field-based FOD system 54900 which has a horizontally-oriented coil array 54901. FIG. 39 is a seventh embodiment of a field-based FOD system 64900 which has a symmetric self-inductance-based coil array 64901.

### a. First Embodiment — Grid-Like Sensor Coil Array

As shown in FIG. 33, a first embodiment of a field-based FOD system 4900 includes an auxiliary sensor coil array 4901. The auxiliary sensor coil array 4901 includes a collection of individual sensor coils 4902, which are arranged in a grid-like pattern to provide comprehensive and redundant coverage over the active area of the underlying transmitter coil assembly 4100. Each sensor coil 4902 is an inductive element specifically configured to be sensitive to localized changes in the magnetic field generated by the primary transmitter coil assembly 4100. The physical design of each sensor coil 4902, including its size, number of turns, and the material of its conductor, can be configured to enhance its sensitivity to small objects while carefully managing its own power consumption and susceptibility to environmental noise. The trade-off between sensitivity and practicality is a key design consideration; smaller individual coils 4902 offer higher spatial resolution for detecting very small objects but may have a reduced detection range, potentially imposing constraints on the thickness of the protective top cover of the charging mat.

The grid-like arrangement of the sensor coils 4902 addresses the blind-zone challenge by ensuring that it is geometrically improbable for a metallic foreign object to be positioned in such a way that its effect on the magnetic field is perfectly canceled out across the entire array. By analyzing the pattern of voltage changes across the entire array 4901, the system 4000 can not only detect the presence of a metallic foreign object but can also estimate its size and location on the charging surface with a high degree of accuracy. This spatial analysis allows the system to distinguish between a small, localized object and a larger area of interference that might be caused by simple misalignment of the main power coils.

### b. Second Embodiment — Elongated Coil Array

FIG. 34 is a top plan view of an exemplary transmitter coil assembly 4100, illustrating a second alternative embodiment of a field-based foreign object detection (FOD) system 14900. As shown in FIG. 34, the second alternative embodiment of the field-based FOD system 14900 includes an auxiliary sensor coil array 14901. The auxiliary sensor coil array 14901 is composed of a collection of individual sensor coils 14910a-14910f, which in the illustrated example are arranged as three laterally nested pairs (e.g., 14910a-14910b, 14910c-14910d, 14910e-14910f) of adjacent, lengthwise coils (e.g., six total in this example) to provide comprehensive coverage over the active area of the underlying transmitter coil assembly 4100. In this particular embodiment, each of the sensor coils 14910a-14910f has an elongated oval geometry. This arrangement of multiple adjacent, smaller coils represents an example method to achieve high-resolution spatial sensing across the charging pad. The purpose of this array 14901 is to detect the presence and lateral location of a conductive foreign object, such as a metal screw or coin, by sensing the distortion it creates in the magnetic field.

The lengthwise adjacent arrangement of the sensor coils 14910a-14910f reduces blind zones by making it geometrically improbable for a metallic foreign object 4112 to be positioned such that its effect on the magnetic field is perfectly canceled across the entire array. By analyzing the pattern of voltage changes across the array 14901, the system 4000 can detect the presence of a metallic foreign object 4112 and estimate its lateral location on the charging surface.

### c. Third Embodiment — Multi-Layer Coil Array

FIG. 35 is a top plan view of an exemplary transmitter coil assembly 4100, illustrating a third alternative embodiment of a field-based foreign object detection (FOD) system 24900. As shown in FIG. 35, the third alternative embodiment of the field-based FOD system 24900 includes a multi-layer auxiliary sensor coil array 24901. This architecture addresses the blind-zone challenge by distributing sensor coils across multiple, partly overlapping layers. The sensor coil array 24901 includes a collection of individual sensor coils, which are grouped into distinct layers. Each of the coils, designated as 24912a-24912f, provides a distinct sensing channel that can be continuously and independently monitored by the FOD system's control unit. In the illustrated embodiment, the array 24901 includes at least two layers of sensor coils, with the coils in one layer partly overlapping the coils in an adjacent layer. For instance, the sensor coil array 24901 can include a first layer of substantially horizontal sensor coils (e.g., 24912a, 24912c, and 24912e) and a second layer of substantially horizontal sensor coils (e.g., 24912b, 24912d, and 24912f). By partly overlapping the coils 24912a-24912f, the limitations of single-layer sensor arrays can be at least partly overcome. An object that is located in a blind spot for the first coil layer can still create a detectable disturbance in the second coil layer, and vice-versa, because it becomes geometrically less probable for a foreign object to be simultaneously symmetrical to the coils in all layers.

The multi-layer design also improves the system's ability to locate the foreign object with a significant degree of precision. By analyzing which specific coils in which specific layers are reporting an anomaly, the control system can accurately estimate the position of the object on the charging surface. For example, a simultaneous detection event on coil 24912a and coil 24912b would indicate the object's location is at or near the intersection of those two distinct sensing regions. This approach provides a process for foreign object detection that is less susceptible to the influence of external factors like power coil misalignment. In some embodiments, the multi-layer sensor coil array 24901 may include three or more layers with coils offset at different angular orientations relative to one another to further reduce the probability of a symmetric null condition.

### d. Fourth Embodiment — Two-Layer Balanced Coil Array

FIG. 36 is a top plan view of an exemplary transmitter coil assembly 4100, illustrating a fourth alternative embodiment of a field-based foreign object detection (FOD) system 34900. As shown in FIG. 36, the fourth alternative embodiment of the field-based FOD system 34900 includes a two-layer balanced auxiliary sensor coil array 34901. This architecture is specifically designed to achieve sensitive metal object detection (MOD) while simultaneously mitigating the effects of electromagnetic interference between adjacent sensor coils. The sensor coil array 34901 includes a collection of individual sensor coils, which are arranged in a grid-like pattern and organized into at least two distinct layers to provide comprehensive coverage over the active area of the underlying transmitter coil assembly 4100. For illustrative purposes, the coils designated with reference numeral 34914a may represent a first layer of sensor coils, while the coils designated 34914b and 34914c may represent a second layer. The various shadings and symbols (e.g., '!', '<', ':') within the cells are used to visually differentiate the individual sensor coils and their symmetrical relationships within the drawing and do not represent a particular operational state.

A notable aspect of this embodiment is the implementation of a "balanced coil" design. The sensor coils 34914a-34914c within the array 34901 are arranged in a symmetric relationship with respect to the primary transmitter coil's magnetic field. For instance, a coil on the left side of the array may be paired with a corresponding, symmetrically positioned coil on the right side. In a balanced configuration, these paired coils can be connected differentially to the detection circuitry. In the absence of any foreign object, the magnetic field from the primary coil can induce substantially equal and opposite voltages in the paired sensor coils, resulting in a net-zero or null signal at the output. This self-balancing characteristic can obviate the need for a separate reference coil to establish a baseline measurement. Furthermore, by organizing the coils into two separate physical layers, the system can reduce the electromagnetic interference between adjacent sensor coils, which can improve the signal-to-noise ratio and the overall reliability of the detection measurement.

The operational principle of this embodiment is based on detecting a minute change in the inductance of the sensor coils. When a metallic foreign object is introduced onto the charging surface, it disrupts the symmetry of the magnetic field. The localized field distortion will affect the coil closest to it more significantly than its symmetrically paired counterpart, thereby breaking the balanced condition. This imbalance causes a detectable change in the self-inductance of the affected coil. To enhance the sensitivity to this change, the detection circuitry may incorporate a serial-resonance Maxwell bridge or a similar highly sensitive circuit topology. Such a circuit can translate a small inductance variation into a large, easily measurable voltage change. As has been demonstrated in experimental results for similar systems, the introduction of a small metallic foreign object, such as a paper clip, can cause the output voltage of the detection circuit to change dramatically from a baseline of hundreds of millivolts to several volts. In some embodiments, the detection circuitry may include automatic calibration logic that periodically re-measures and stores the baseline inductance values for each sensor coil pair to compensate for environmental drift caused by temperature changes or aging of components.

### e. Fifth Embodiment — Multi-Layer Hexagonal Coil Array

FIG. 37 is a top plan view of an exemplary transmitter coil assembly 4100, illustrating a fifth alternative embodiment of a field-based foreign object detection (FOD) system 44900. As shown in FIG. 37, the fifth alternative embodiment of the field-based FOD system 44900 includes a multi-layer hexagonal coil array 44901. This architecture employs an arrangement of sensor coils in a tessellated hexagonal pattern for metal object detection (MOD). The sensor coil array 44901 includes a collection of individual sensor coils, designated as 44916a-44916d, where each is represented by a hexagonal cell in the grid. The coils 44916a-44916d are organized into multiple, overlapping layers to monitor a substantial portion of the active area of the underlying transmitter coil. For illustrative purposes, the coils designated with reference numeral 44916a may represent a first set of coils, while those designated 44916b, 44916c, and 44916d may represent coils in other sets or layers within the array. The various shadings and symbols (e.g., '!', '<', 'B') within the hexagonal cells are used to visually differentiate the individual sensor coils and their symmetrical and layered relationships within the drawing and do not represent a particular operational state.

The use of a three-layer or four-layer hexagonal layout is configured to significantly improve FOD performance when compared to single-layer arrays. The interlocking, layered nature of the hexagonal array makes it geometrically improbable for an object to achieve a position of symmetry with respect to all of the sensing coils in its vicinity, which can facilitate the reliable detection of the foreign object regardless of its placement.

In the illustrated example, the sensor coil array 44901 is decoupled from the primary transmitter (Tx) and receiver (Rx) coils. The sensor coils 44916a-44916d are configured to be highly sensitive to the localized field distortions caused by a foreign object, while being substantially less sensitive to the main magnetic field of the power transfer system itself. In some embodiments, such decoupling can enhance the signal-to-noise ratio of the detection system. In some embodiments, the hexagonal sensor coils 44916a-44916d may be fabricated on a flexible printed circuit board (PCB) substrate to allow the sensor coil array 44901 to conform to a non-planar surface of the carrier 4116 or shield layer 4111.

### f. Sixth Embodiment — Horizontally-Oriented Coil Array

FIG. 38 is a top plan view of an exemplary transmitter coil assembly 4100, illustrating a sixth alternative embodiment of a field-based foreign object detection (FOD) system 54900. As shown in FIG. 38, the sixth alternative embodiment of the field-based FOD system 54900 includes an auxiliary sensor coil array 54901. This architecture arranges sensor coils in a stacked, horizontally-oriented configuration to achieve spatial sensing along the longitudinal (front-to-back) axis of the charging surface. The auxiliary sensor coil array 54901 includes a collection of individual sensor coils, designated alternately as 54918a and 54918b. In the illustrated embodiment, these sensor coils 54918a, 54918b are arranged as a series of adjacent, substantially horizontal (or lateral) coils that are positioned next to one another along the major lengthwise axis of the underlying primary transmitter coil assembly 4100. The different shadings and reference numerals (54918a vs. 54918b), along with the schematic symbols (e.g., '!', '<', '>'), are used to visually differentiate the individual sensor coils from one another in the drawing and do not represent a particular operational state.

The control system for the FOD module is configured to monitor the signals from each of the sensor coils 54918a, 54918b independently. By analyzing which specific coil or coils report a deviation from their baseline signal, the system can estimate the longitudinal position of a foreign object on the charging surface. For example, if a foreign object were placed near the bottom edge of the charging pad (proximate to the electrical leads in the drawing), it would primarily affect the bottom-most sensor coil 54918a. Conversely, an object placed near the top edge would primarily affect the top-most sensor coil 54918a. An object in the middle would affect one of the central coils (e.g., 54918b).

This architecture, being conceptually similar to the vertically-oriented array 14901 shown in FIG. 34 but rotated by 90 degrees, provides an alternative method for dividing the charging surface into distinct sensing zones. The choice between a vertical or horizontal arrangement could be dictated by various engineering factors, such as the specific geometry of the primary transmitter coil, the expected distribution of the magnetic field, and the manufacturing constraints of the sensor array's printed circuit board (PCB). In some embodiments, the horizontally-oriented array 54901 may be combined with a vertically-oriented array (e.g., array 14901) to create a two-dimensional sensing grid that provides both lateral and longitudinal position estimates for detected foreign objects.

### g. Seventh Embodiment — Symmetric Self-Inductance-Based Coil Array

FIG. 39 is a top plan view of an exemplary transmitter coil assembly 4100, illustrating a seventh alternative embodiment of a field-based foreign object detection (FOD) system 64900. As shown in FIG. 39, the seventh alternative embodiment of the field-based FOD system 64900 includes a symmetric sensing coil array 64901. This architecture is a specific implementation of an active metal object detection (MOD) method that is based on the principle of self-inductance measurement. The auxiliary sensor coil array 64901 includes a collection of individual sensor coils, designated as 64919a-64919f. These coils 64919a-64919f are arranged as a series of adjacent, substantially vertical (longitudinal) strips that are positioned symmetrically about the central axis of the underlying primary transmitter coil. For example, the sensor coil 64919b on the left side of the central axis is a symmetrical counterpart to the sensor coil 64919b on the right side. Similarly, coils 64919a, 64919d, and 64919e are arranged in symmetric pairs. The central coils 64919c and 64919f are themselves symmetric about the central axis. The various shadings and symbols (e.g., '!', '<', 'B', 'H', 'A') within the areas corresponding to each coil are for the purpose of visually differentiating the individual sensor coils from one another in the drawing and do not represent a particular operational state.

Unlike passive FOD systems that measure the voltage induced by the main power transfer field, this is an active detection method. the sensor coil array 64901 is part of a dedicated measurement circuit, such as a self-inductance-based resonant circuit (SIRC), which can operate independently of the main power transfer electronics. This circuit actively drives a signal through the sensor coils and measures their self-inductance. In some embodiments, the dedicated measurement circuit may operate at a frequency that is distinct from the power transfer frequency, thereby providing a degree of frequency-domain isolation between the sensing function and the charging function.

Each pair of symmetric coils (e.g., the two 64919b coils) can be treated as a single detection channel, and the system can compare the self-inductance of one coil to its counterpart. In the absence of a foreign object, the inductances of the paired coils will be substantially identical. When a foreign object is introduced, it will typically be closer to one coil than its symmetric partner, causing a differential change in their respective self-inductances. This imbalance can be used as a clear indicator of the object's presence. By analyzing which specific channel (e.g., which symmetric pair) reports an inductance mismatch, the system can estimate the lateral position of the foreign object on the charging surface. The sensitivity of this detection method is influenced by factors such as the quality factor (Q-factor) of the sensor coils and the size of the foreign object, which are carefully considered in the design of the SIRC and the physical construction of the coils themselves. Because this is an active system, it can provide detection coverage both before and during power transfer, making it well suited for pre-charge scanning operations. In some embodiments, the SIRC may include a temperature compensation circuit that adjusts the baseline inductance measurements to account for changes in coil resistance and permeability caused by temperature variations during charging.

### 3. Other Foreign Object Detection Systems

In addition to the auxiliary sensor coil arrays and the tunnel magnetoresistance (TMR) sensor matrix described above, the docking station 3000 may include one or more supplemental or alternative sensor modalities to extend the variety of detectable foreign object types and to introduce redundancy into the foreign object detection system. By way of example and not limitation, an array of thermally conductive members thermally coupled to respective thermistors and distributed proximate to the periphery of the charging mat 3100 may supplement or replace the TMR sensor matrix for purposes of detecting thermal anomalies across the charging surface 3104. Several categories of supplemental sensor modalities that may be employed in various embodiments of the docking station 3000 are described in turn below. For each category, representative commercial sensor families are identified by way of non-limiting example to illustrate the types of sensors that may be suitable; it will be understood that such identifications are not intended to limit the scope of the disclosed embodiments to any particular manufacturer, product line, or specification.

In some embodiments, the docking station 3000 may incorporate one or more inductive sensors configured to generate a localized, low-power alternating magnetic field and to detect perturbations in that field attributable to the proximity of metallic objects. Because inductive sensors are self-exciting—that is, they generate their own interrogation field independently of the transmitter coil assemblies 4100a, 4100b—they are particularly well suited for pre-charge scanning operations performed before the transmitter coil assemblies 4100a, 4100b have been energized, thereby enabling identification of metallic foreign objects 4112 prior to the delivery of any charging power to the system. Inductive sensors suitable for use in such embodiments include, without limitation, the Omron E2E series, the Turck NI series, the Pepperl+Fuchs NBB series, and the IFM Electronic IGT205.

In other embodiments, one or more eddy current sensors may be disposed within or adjacent to the charging mat 3100 to detect the presence and proximity of electrically conductive foreign objects by measuring variations in an induced eddy-current field. The sensitivity of eddy current sensors to changes in the conductivity and geometry of nearby objects renders them well suited to identifying conductive foreign objects 4112 that may not produce a sufficient thermal signature for detection by the TMR sensor matrix or the thermistor array described above. Eddy current sensors suitable for use in such embodiments include, without limitation, the Micro-Epsilon eddyNCDT series, the Kaman KD-2306 series, and the Lion Precision ECL202.

In still other embodiments, magnetic field sensors such as Hall effect sensors may be disposed within or adjacent to the charging mat 3100 to detect anomalies in the primary magnetic field 4150 when the transmitter coil assemblies 4100a, 4100b are energized at a reduced, pre-check power level. Such sensors are responsive to perturbations introduced by metallic foreign objects 4112 situated within the magnetic flux path extending between the transmitter coil assemblies 4100a, 4100b and the receiver coil assemblies 936, and they may accordingly serve as a complementary detection modality to the thermal imagers or the TMR sensor matrix described herein. Hall effect sensors suitable for use in such embodiments include, without limitation, the Allegro A1302/A1324, the Honeywell SS490 series, the Infineon TLE49x6 family, and the Texas Instruments DRV5053.

In yet other embodiments, one or more capacitive sensors may be disposed on or proximate to the charging surface 3104 to detect changes in local capacitance caused by the presence of foreign objects. Because capacitive sensors respond to changes in the dielectric environment rather than solely to the presence of conductive materials, they are capable of detecting both metallic and non-metallic foreign objects, thereby broadening the detectable foreign object population beyond those identifiable through purely magnetic or inductive techniques. Capacitive sensors suitable for use in such embodiments include, without limitation, the Carlo Gavazzi EC series, the Rechner KAS series, the Microchip MTCH101 capacitive touch controller, and the Analog Devices AD7147 CapTouch controller.

In other embodiments, one or more photoelectric sensors, one or more infrared thermal sensors, or a combination thereof, may be employed to optically or thermally detect objects on or proximate to the charging surface 3104. Photoelectric sensors may be configured to detect the interruption of a transmitted light beam or the reflection of emitted light from a foreign object, while infrared thermal sensors may be configured to detect thermal radiation emitted by or reflected from a foreign object whose temperature differs from that of the charging surface 3104. Photoelectric sensors suitable for use in such embodiments include, without limitation, the Omron EE-SY series and the Keyence PZ-G series. Infrared thermal sensors suitable for use in such embodiments include, without limitation, the Melexis MLX90614, the STMicroelectronics STTS751, and the Texas Instruments TMP117.

In further embodiments, Q-factor analysis circuitry integrated within a wireless power controller integrated circuit may be used to detect foreign objects by monitoring the quality factor of the resonant circuit formed by the transmitter coil assemblies 4100a, 4100b and associated tuning components. The presence of a conductive foreign object 4112 within the magnetic field 4150 introduces additional resistive losses into the resonant circuit, thereby reducing the quality factor thereof. This reduction may be detected and quantified by the controller integrated circuit to signal the presence of the foreign object 4112 and, in certain implementations, to estimate a size or position of the foreign object 4112 based on the magnitude and spatial distribution of the quality factor reduction. Wireless power controller integrated circuits suitable for performing such Q-factor analysis include, without limitation, the NXP MWCT1xxx series, the STMicroelectronics STWBC family, the Würth Elektronik WPCC series, and the Analog Devices LTC4125.

In still further embodiments, a power loss monitoring system, which may be implemented as a core function of a Qi-certified wireless power controller integrated circuit, may be leveraged to detect foreign objects by comparing the power transmitted by the transmitter coil assemblies 4100a, 4100b with the power received by the receiver coil assemblies 936. A discrepancy between the transmitted power and the received power that exceeds a predetermined threshold is indicative of power being absorbed by a foreign object 4112 disposed within the magnetic field 4150, and detection of such a discrepancy may be used to trigger a fault condition, to reduce or cease power delivery, or to initiate a remedial action such as a cleaning procedure. Wireless power controller integrated circuits suitable for performing such power loss monitoring include, without limitation, the Renesas P9242-R, the Texas Instruments BQ500212A, the IDT P9221-R, and the NXP NXQ1TXH5.

It should be appreciated that any of the foregoing sensor modalities may be employed individually in a given embodiment of the docking station 3000, or any two or more of the foregoing sensor modalities may be combined within a single docking station 3000 to provide complementary and redundant detection capabilities. Such combinations may collectively span a broader range of foreign object materials, geometries, and positions on or near the charging surface 3104 than any single sensor modality alone, and may further provide fault tolerance in the event that one sensor modality is unable to detect a particular foreign object type. The selection and combination of sensor modalities for a particular embodiment may be determined based on, among other factors, the expected operating environment, the types of foreign objects most likely to be encountered, and the desired level of detection confidence.

In some embodiments, the sensors 3113a, 3113b of the docking station 3000 may include expanded sensing modalities that extend beyond foreign object detection to further enhance the safety, diagnostics, and maintenance capabilities of the docking station 3000. For example, inductive or Hall-effect sensors may be included not only to detect metallic foreign objects 4112 but also, upon detection, to automatically trigger the cleaning system 5500 without requiring intervention by the station computing device 4350 or the control system 1000 of the robot 1. For diagnostic purposes, small cameras, steerable endoscopes, or ultrasonic probes may be mounted within a support cradle 3300 of the docking station 3000 to conduct an automated health check of the robot's mechanical, electrical, and structural components during a charging cycle, taking advantage of the period during which the robot 1 is stationary and held in a known position. In other embodiments, the docking station 3000 may also serve as a calibration fixture by using integrated cameras and lasers to verify the calibration of the robot's own sensor suite, including for example LiDAR sensors and cameras carried by the robot 1, while the robot 1 is held in a known, stable position within the support cradle 3300. This calibration capability leverages the mechanical stability and positional repeatability of the docking station 3000 to provide a controlled environment in which sensor calibration can be performed automatically, without requiring a separate calibration facility or manual intervention by a human operator.

### 4. Foreign Object Detection Architectures

The sensing architectures employed by the FOD system may be classified as passive, active, or hybrid, depending on how the sensing coils or other sensor elements are energized. Embodiments that utilize the TMR sensor matrix for foreign object detection are generally classified as passive sensing embodiments. In a passive configuration, the excited transmitter coil assembly 4100a or 4100b generates an induced voltage on the sensing coils during the process of wireless power transmission. That is, the sensing coils derive their excitation energy from the magnetic field 4150 already being generated by the transmitter coil assembly 4100a or 4100b for the purpose of power transfer, and no separate or independent excitation source is required for the sensing coils. A limitation of passive sensing, however, is that the sensing coils cannot detect the presence of metallic foreign objects 4112 prior to the initiation of power transmission, because the sensing coils are not energized until the transmitter coil assembly 4100a or 4100b begins its power-transfer cycle.

To overcome this limitation, active sensing embodiments may be employed in other configurations of the docking station 3000. Active sensing embodiments generally include additional sensors and/or an independent power supply that is used to excite the sensing coils separately from and independently of the transmitter coil assemblies 4100a, 4100b. Because excitation of the sensing coils in an active configuration is decoupled from the power-transmission cycle, the active sensing methods are capable of detecting the presence of metallic foreign objects 4112 both before the initiation of wireless power transfer and during an ongoing charging session, thereby providing detection coverage during time periods that are inaccessible to passive sensing methods.

In still further embodiments, passive and active sensing features may be combined within a single docking station 3000 to provide a hybrid FOD system that is more robust and more comprehensive than either approach alone. In such a hybrid configuration, the FOD system may use active sensing to perform a pre-charge scan of the wireless charging surface 3104 before the initiation of power transmission, confirming that the charging surface 3104 is free of metallic foreign objects 4112, and then transition to passive sensing during the active charging cycle to provide ongoing monitoring. This hybrid approach provides continuous foreign object detection coverage throughout the entire docking and charging procedure, from the moment the receiver coil assemblies 936 of the robot 1 approach the transmitter coil assemblies 4100a, 4100b of the docking station 3000 through the completion of the charging session, without requiring the independent excitation source to remain active for the entire duration of the charging cycle.

### a. Pre-Charge Inspection and Cleaning Procedures

In addition to the sensor-based detection capabilities described above, the docking station 3000 and the robot 1 may cooperate to execute pre-charge inspection and cleaning procedures that reduce the likelihood of foreign objects being present on the charging surface 3104 when charging commences. In some embodiments, the robot 1 may be configured to remove a foot cover 934 from each foot 92 prior to stepping onto the charging mat 3100. While the foot cover 934 protects the underlying structure of the foot 92 during locomotion, the energy-absorbing material of the foot cover 934 may be more likely to pick up or collect foreign objects or debris while the robot 1 is walking. To avoid tracking such foreign objects and debris onto the charging surface 3104, the robot 1 removes the foot covers 934 before stepping onto the charging mat 3100. In some embodiments, the removed foot covers 934 may be placed on a designated storage fixture integrated into the docking station 3000 or located adjacent thereto, ensuring that the foot covers 934 are securely stored and readily available for re-attachment to the feet 92 after the charging cycle is complete.

In other embodiments, the robot 1 may be configured to inspect and clean the soles of its feet 92 without reliance on the docking station 3000 and its associated FOD system. For example, the robot 1 may inspect the soles of the feet 92 using cameras positioned on different extents of the robot 1, such as cameras 108.2.2, 108.2.4 mounted on a head and neck assembly 10 of the robot 1. If a foreign object is detected by the robot's own vision system, the control system 1000 of the robot 1 may trigger a cleaning procedure in which the robot 1 cleans the soles of its feet 92 using an external cleaning surface 5501 that is separate from the docking station 3000. The external cleaning surface 5501 may include, for example, a brush, a wiper, an adhesive surface, a sticky surface, or another surface configured to dislodge or capture foreign objects or debris. In one embodiment, the control system 1000 commands the robot 1 to sequentially lift each foot 92 and wipe the sole of the respective foot 92 across the cleaning surface 5501 to mechanically dislodge and remove the detected foreign object or debris. In another embodiment, the control system 1000 commands the robot 1 to step onto the cleaning surface 5501, which causes the foreign object or debris to adhere or stick to the cleaning surface 5501, thereby passively dislodging and removing the foreign object or debris from the soles of the feet 92 without requiring the robot 1 to execute a wiping motion.

The robot 1 may perform this self-cleaning step at various points during a docking procedure 6000. For example, the robot 1 may perform the self-cleaning step before and/or after removing the foot covers 934 and before stepping on the charging mat 3100, without first inspecting the soles of the feet 92. In other embodiments, the robot 1 may perform the self-cleaning step before and/or after removing the foot covers 934 and before stepping on the charging mat 3100, but only after first inspecting the soles of the feet 92 using the cameras on the robot 1 and confirming that a foreign object is present. In still other embodiments, the robot 1 may perform the self-cleaning step after the soles of the feet 92 have been inspected by the FOD system of the docking station 3000 and a foreign object has been detected by the docking station's sensors 3113a, 3113b. In yet other embodiments, the robot 1 may perform the self-cleaning step after a cleaning attempt by a cleaning system 5500 of the docking station 3000 has been determined to be ineffective at removing the foreign object or debris, thereby providing a secondary cleaning capability when the docking station's own cleaning system 5500 is insufficient. In further embodiments, the control system 1000 may command the robot 1 to perform the self-cleaning step at other points during the docking procedure 6000 as determined by the control system 1000 based on sensor data, historical cleaning effectiveness, or other factors.

The system further employs a cyber-physical approach that tightly integrates the motor control of the robot 1 with the sensors 3113a, 3113b of the docking station 3000 to ensure that the entire charging surface 3104 can be inspected without occlusion. During the pre-charge inspection and during an active charging cycle, the docking station 3000 may instruct the robot 1, via a communication link between the docking station 3000 and the control system 1000, to sequentially lift each foot 92. This systematic, coordinated foot-lifting reduces or eliminates the blind spots on the charging surface 3104 that would otherwise be created by the feet 92 during a static charging process in which both feet 92 remain in contact with the charging surface 3104. By lifting each foot 92 in turn, the sensors 3113a, 3113b are afforded an unobstructed view of the portion of the charging surface 3104 that was previously covered by the lifted foot 92, and the FOD system can therefore inspect the entire charging surface 3104 without requiring the robot 1 to step off the charging mat 3100 entirely. Additionally, lifting each foot 92 makes it easier for the cleaning system 5500 of the docking station 3000 to dislodge or remove any foreign objects or debris from the soles of the lifted foot 92 and from the newly exposed portion of the charging surface 3104. This cyber-physical foot-lifting protocol may be executed before the robot 1 is positioned on the charging mat 3100, as part of the initial docking sequence, and/or after the robot 1 is in a fully docked position on the docking station 3000, as part of an ongoing monitoring and cleaning protocol during the charging cycle.

With the feet 92 inspected and cleaned, the docking procedure 6000 repeats the analysis of the charging area to confirm that no foreign objects remain on the charging surface 3104 or on the soles of the feet 92. If a foreign object is detected upon this re-inspection, the cleaning step is repeated and the charging surface 3104 is cleaned again. This iterative inspect-and-clean cycle may be repeated until the FOD system confirms that no foreign objects are present, at which point the docking procedure 6000 proceeds with the remaining charging steps. Throughout the charging session, the FOD system provides continuous monitoring for any new thermal anomalies or other indications of foreign object presence, ensuring that any object introduced to the charging surface 3104 during the charging cycle—for example, an object that falls onto the charging mat 3100 from an external source—is promptly detected and addressed.

### b. Response Protocols Upon Detection of a Foreign Object

Upon the detection of a metallic or other foreign object 4112 at any point during the docking procedure 6000 or during an active charging cycle, one or more response protocols may be initiated by the docking station 3000. In one embodiment, the charging sequence is immediately aborted, and an error signal is transmitted to the robot 1, the docking station 3000, and/or a central command center 2750A-X, thereby flagging the docking station 3000 and/or the robot 1 as requiring manual inspection and cleaning by a human operator. In another embodiment, the docking station 3000 automatically activates the cleaning system 5500, which may include a power fan, a wiper blade, or another self-cleaning mechanism, upon detecting the presence of a foreign object 4112, and thereafter re-initiates the FOD scan to confirm that the foreign object 4112 has been successfully removed. In yet another embodiment, the docking station 3000 instructs the robot 1 to perform a position change, such as lifting its feet 92 one at a time, and then activates the cleaning system 5500 to dislodge and remove the foreign object 4112 from the charging surface 3104 beneath and around the robot's feet 92.

In a further embodiment, the docking station 3000 may perform a combination of these response methods. For example, the docking station 3000 may first attempt to remove the foreign object 4112 using the cleaning system 5500 in conjunction with reducing the current flowing to the transmitter coil assemblies 4100a, 4100b. It should be understood that the current-flow reduction may be performed before the cleaning procedure, such as a wiping action or a blower action, is performed, so that the thermal risk posed by the foreign object 4112 is mitigated before the cleaning system 5500 engages. In other embodiments, the cleaning procedure may be performed before the current reduction, for example in cases where the foreign object 4112 is determined to pose a low thermal risk and rapid mechanical removal is prioritized. In all cases, the primary objective of the response protocol is to prevent any damage, whether thermal, structural, electrical, or otherwise, to the docking station 3000 or to the robot's feet 92, and to restore the docking station 3000 to a safe operating condition as quickly as possible.

### 5. Foreign Object Detection Process

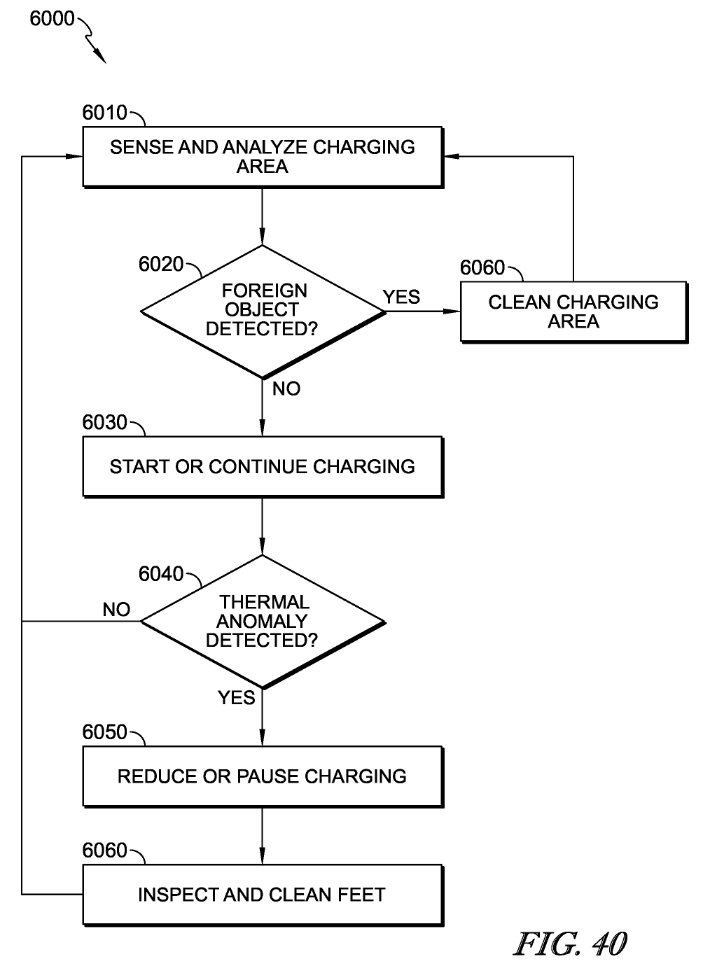

The docking station 3000 incorporates an integrated safety framework that unifies foreign object detection, closed-loop thermal management, and autonomous cleaning into a continuous, multi-phase process that governs the wireless charging of the humanoid robot 1 before, during, and after each charging cycle. This framework, described herein with reference to an example process 6000 illustrated in FIG. 40, draws upon data from multiple sensor modalities, dedicated control units, and the robot's own articulated mobility to detect, classify, and remediate hazards present on or near the wireless charging surface 3104 of the charging mat 3100, and to maintain the temperature of every component and foreign body within the system below limits prescribed by applicable safety standards, such as IEC 62368-1.

The process 6000 begins at step 6010, at which data streams generated by the base sensors 3113a and 3113b are received and processed by a dedicated control unit. The dedicated control unit may be the charging controller 4104, one or more of the charging controllers 888, the station electronics assembly 3500, or any suitable combination thereof. The control unit applies one or more detection and classification techniques to the incoming sensor data. In some embodiments, these techniques include computer vision algorithms that perform spatial analysis of the charging surface 3104, identifying anomalies based on shape, reflectance, texture, or contrast relative to a known baseline image of the unobstructed charging surface 3104. In other embodiments, the control unit employs machine learning models, such as convolutional neural networks or other trained classifiers, that have been trained on labeled datasets of the charging surface 3104 in both clean and contaminated states. These models may classify detected anomalies by type—for example, metallic debris, organic material, fabric, or other foreign matter—and assign a risk score to each anomaly based on factors including its size, material composition as inferred from thermal or spectral characteristics, and proximity to the transmitter coil assemblies 4100a and 4100b. The risk score may be used downstream in the process 6000 to determine the urgency and nature of the remedial action to be taken.

At step 6020, the FOD system evaluates the processed sensor data and determines whether a foreign object 4112 is present on the charging surface 3104. If a foreign object is detected, the system 4000 triggers an alert that is communicated to the robot 1 over a wired or wireless communication link. The robot 1 may respond to the alert in one or more ways depending on its current operational state. If the robot 1 is in the process of approaching or stepping onto the docking station 3000, the robot 1 may halt the docking procedure entirely, thereby preventing the robot 1 from attempting to place its feet 92 on a surface that may present a tripping hazard, that may cause a foreign object to become lodged against or embedded within the sole of a foot 92, or that may otherwise impede the proper alignment of the feet 92 with respect to the transmitter coil assemblies 4100a and 4100b necessary for efficient power transfer. If the robot 1 has already docked and charging is in progress, the robot 1 may instead abort the active charging sequence so that the foreign object can be addressed without risk of continued energy transfer into or near the object. In some embodiments, both response modes may be available to the robot 1, and the selection between them may be made automatically based on the robot's docking state at the time the alert is received.

Because the foreign object must be removed before charging can safely proceed, the process 6000 advances from step 6020 to step 6060 when a positive detection occurs. At step 6060, the charging controller 4104 or another control unit within the docking station 3000 initiates a cleaning procedure directed at the charging surface 3104 and, where warranted, the robot's feet 92. The cleaning procedure may take several forms, and more than one form may be employed in sequence if an initial cleaning pass does not fully resolve the contamination. In a first embodiment, the docking station 3000 directs the on-board cleaning system 5500 to perform an automated cleaning operation. The cleaning system 5500 may sweep, vacuum, or otherwise mechanically clear the charging surface 3104 to remove identified foreign objects. Prior to or during this operation, the FOD system may signal the robot 1 to step off the docking station 3000 so that the entire charging surface 3104 is physically accessible to the cleaning system 5500 without obstruction by the robot's feet 92. In a second embodiment, the FOD system may direct the robot 1 to clean its own feet 92, for example by brushing or scraping the soles of the feet 92 against a dedicated cleaning surface or mechanism provided on or adjacent to the docking station 3000, if the detected foreign object is determined to be adhered to or embedded in the sole of a foot 92 or the foot cover 934 rather than resting freely on the charging surface 3104. In a third embodiment, the docking station 3000 may dispatch a network notification to summon human or automated cleaning or maintenance services to inspect the charging area and manually remove the foreign objects. Any combination of these embodiments may be employed, and the selection among them may be informed by the type, location, and risk score of the detected foreign object as determined at step 6020.

Following the completion of the cleaning procedure at step 6060, the process 6000 returns to step 6010, at which the FOD system reanalyzes the charging surface 3104 using the same sensor-driven detection and classification pipeline described above. This re-verification loop ensures that no foreign objects remain on the charging surface 3104 before charging is initiated or resumed. If the re-analysis at step 6020 again indicates the presence of a foreign object—for instance, because the initial cleaning pass was unable to dislodge a firmly adhered contaminant—the process 6000 repeats steps 6060 and 6010 as many times as necessary until the charging surface 3104 is confirmed to be clear.

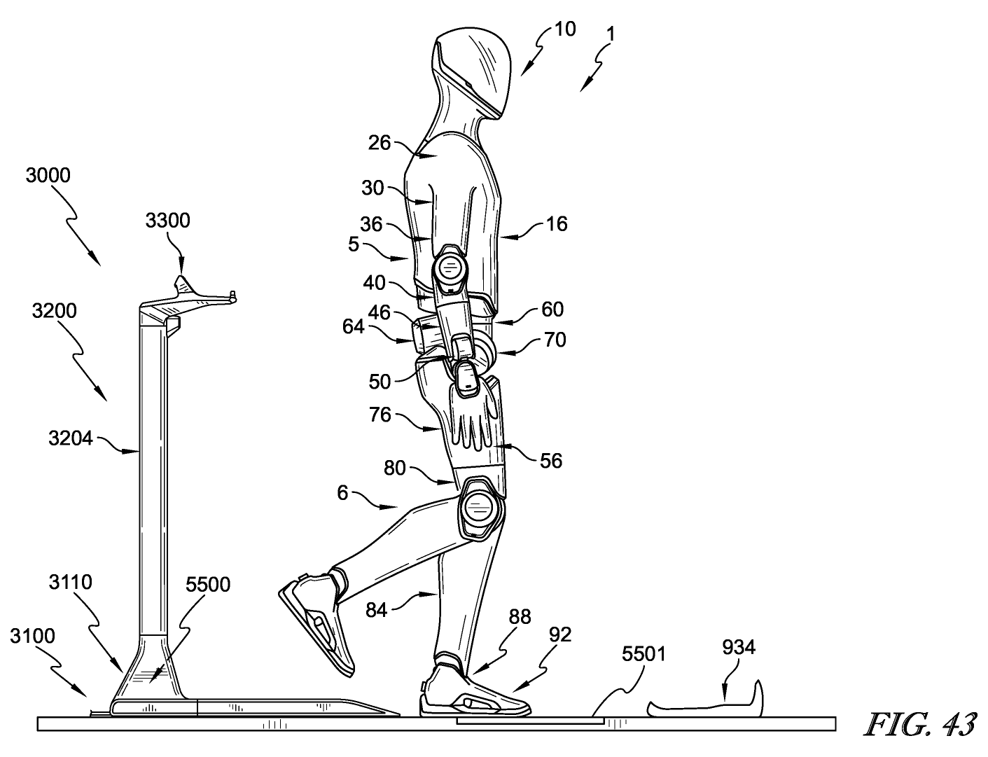

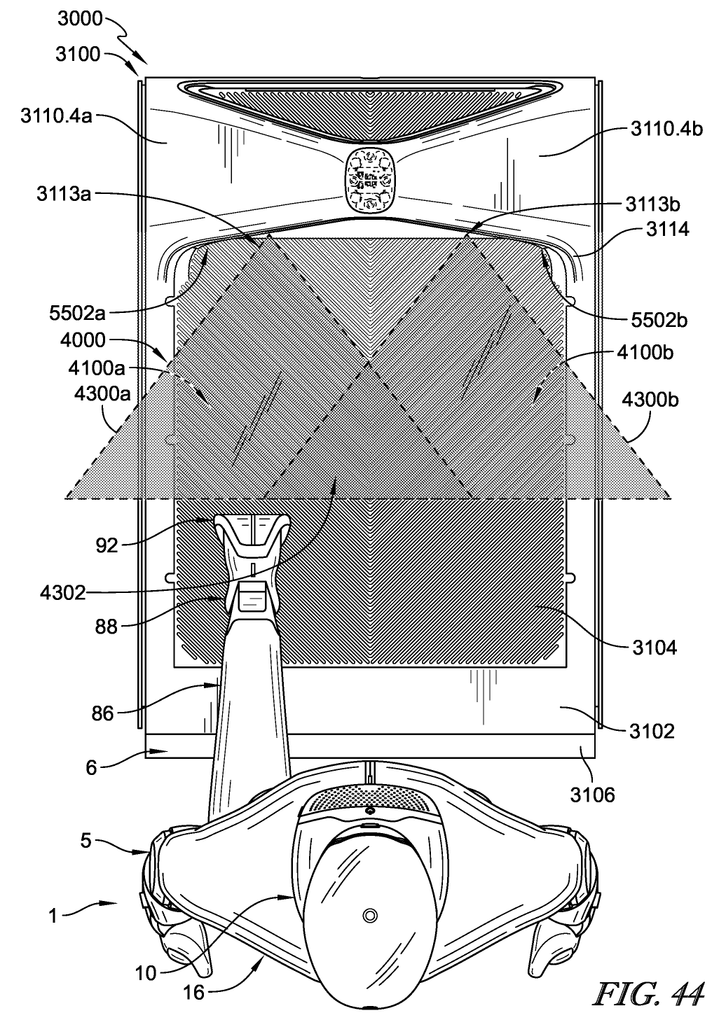

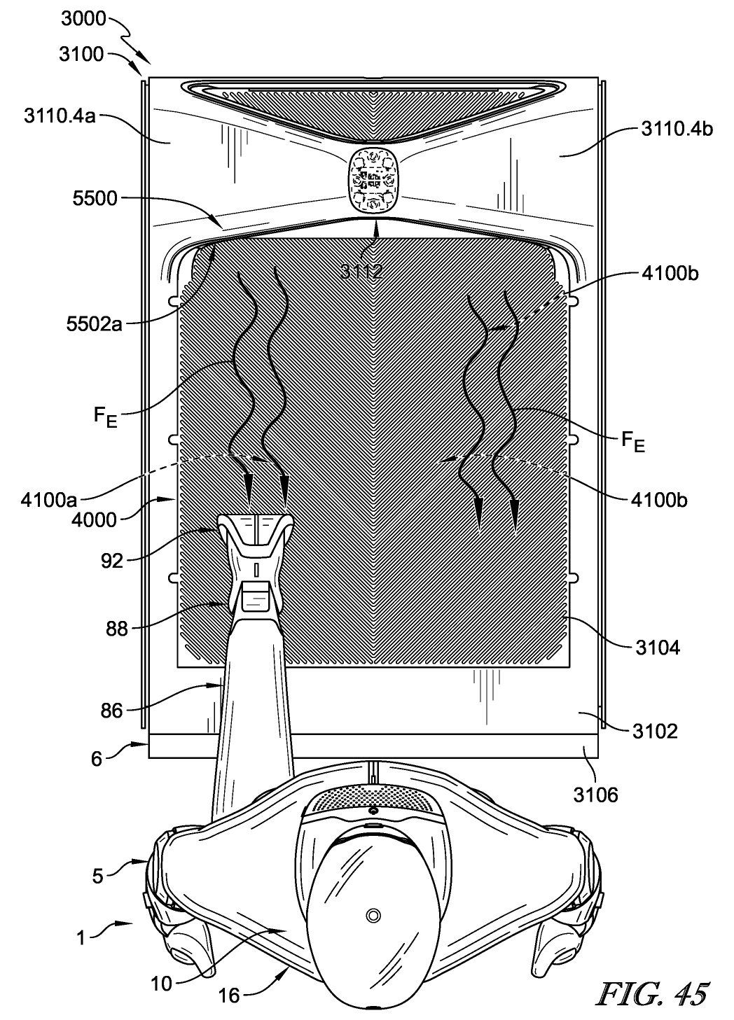

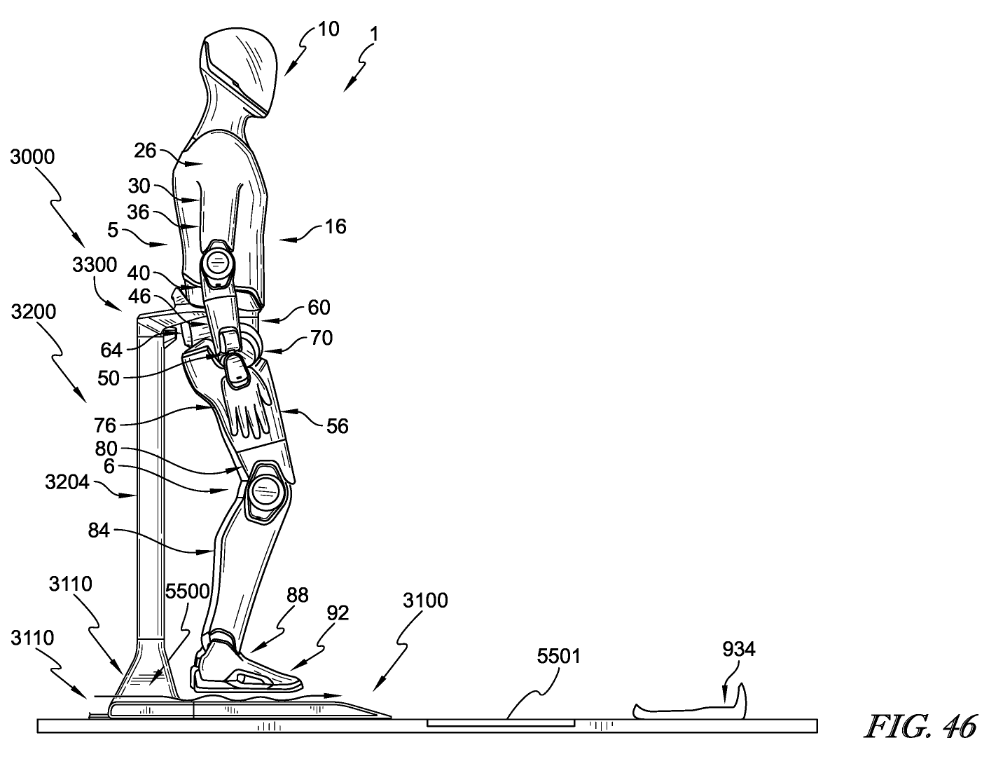

To improve the thoroughness of the pre-charging inspection, the FOD system may additionally leverage the robot's own articulated mobility in an interactive detection phase, as illustrated in FIGS. 43 through 46. Upon detecting that the robot 1 is in a position suitable for charging—whether the robot 1 is in the process of docking as suggested in FIG. 43 or has reached the fully docked position on the docking station 3000 as suggested in FIG. 46—the control system 1000 of the robot 1 commands the robot 1 to sequentially lift each foot 92 for a brief period, for example, approximately one second per foot. While a given foot 92 is lifted, as suggested in FIG. 44, the sole of that foot 92 and the region of the charging surface 3104 directly beneath it, including the underlying transmitter coil assembly 4100, are simultaneously exposed to the completely unobstructed field of view of the sensors 3113a and 3113b. The FOD system thereby performs a combined visual and thermal inspection of both the charging surface 3104 and the sole of each foot 92 in turn, ensuring that no metallic debris or other foreign matter has become attached to or embedded in the foot 92 or the foot cover 934. This interactive detection phase is particularly valuable because a foreign object that is carried on the underside of a foot 92 may not be detectable by sensors observing only the charging surface 3104 while the foot 92 is in contact with it. In some embodiments, the interactive foot-inspection phase is integrated as a mandatory preliminary step that is executed each time the robot 1 approaches or docks with the docking station 3000, thereby establishing a clean baseline before any power transfer occurs.

Once the FOD system confirms, at step 6020, that the charging surface 3104 and the robot's feet 92 are free of foreign objects, the process 6000 advances to step 6030, at which charging is initiated or, if charging was previously paused due to a detected anomaly, resumed. To initiate or resume charging, the charging controller 4104 energizes the transmitter coil assemblies 4100a and 4100b to an increased or full power level, causing the assemblies to generate an alternating magnetic field. This alternating magnetic field is inductively coupled to corresponding receiver coil assemblies disposed within the soles of the robot's feet 92, thereby wirelessly transferring electrical power from the docking station 3000 to the robot 1.

With charging now active, the process 6000 transitions into a continuous thermal monitoring phase in which the temperature sensor 4118 and the base sensors 3113a and 3113b monitor the temperature of the wireless charging surface 3104, the transmitter coil assemblies 4100a and 4100b, and the soles of the robot's feet 92 on an ongoing basis. The temperature data acquired by these sensors is transmitted as one or more signals to the charging controller 4104 or another control unit within the docking station 3000, where the data serves as a primary input to a closed-loop thermal management system. The closed-loop nature of this system means that temperature readings are continually fed back into the control logic, and the control logic continually adjusts operating parameters—principally the magnitude of the charging current and the intensity of active cooling—to maintain all monitored temperatures within predefined safe operational limits.

The physical design of the temperature sensor 4118 itself has been found, through empirical testing, to be a significant factor in the accuracy and reliability of the thermal management system. In particular, using an un-shielded wire for the thermistor element of the temperature sensor 4118 avoids a condition in which the sensor's own metallic shielding is inductively heated by the alternating magnetic field generated by the transmitter coil assemblies 4100a and 4100b during active power transfer. If a shielded thermistor wire were used, the eddy currents induced in the shield by the alternating magnetic field would generate parasitic heat local to the sensor, elevating the temperature reading above the true temperature of the surrounding components and potentially causing the thermal management system to respond to phantom anomalies rather than genuine thermal events. Accordingly, in certain embodiments, the temperature sensor 4118 employs an un-shielded thermistor wire to ensure that the measured temperature faithfully represents the thermal state of the charging surface 3104 and adjacent structures. To mitigate the susceptibility of the un-shielded thermistor wire to electromagnetic interference (EMI) from the transmitter coil assemblies 4100a and 4100b, the temperature sensor 4118 may employ one or more EMI-mitigation techniques, such as differential signaling between the thermistor element and the station computing device 4350, low-pass filtering applied to the thermistor output signal to reject high-frequency noise at or near the power transfer frequency, and routing the un-shielded thermistor wire through a region of the charging mat 3100 where the magnetic field intensity is at a local minimum. In some embodiments, two or more of these EMI-mitigation techniques may be used in combination to provide robust noise rejection while preserving the thermal-measurement accuracy benefits of the un-shielded wire construction.

If, at any point during the charging cycle, the temperature measured by the sensor 4118 or the sensors 3113a, 3113b exceeds a predefined safe operational threshold, the station computing device 4350 of the docking station 3000 automatically engages a closed-loop thermal management protocol. The protocol may involve one or more graduated protective actions, selected and combined based on the magnitude and rate of the detected temperature rise. A first protective action involves automatically reducing or throttling the charging current supplied to the transmitter coil assemblies 4100a and 4100b, thereby directly lowering the rate of resistive and hysteretic heat generation in the wire 4117, the carrier 4116, and adjacent structures. A second protective action involves activating the active cooling system 5000 at a higher intensity, or activating it for the first time if it was not already running, to increase the rate of convective or conductive heat dissipation from the charging mat 3100. A third protective action combines both current reduction and increased active cooling simultaneously to address especially rapid or severe temperature excursions. A message or signal may be sent to a remote human operator or a central command center in conjunction with any of these protective actions, ensuring that human oversight is maintained even during fully autonomous operation.

The specific manner in which the charging current is adjusted may vary depending on the embodiment and the severity of the thermal event. In a first thermal management embodiment, the docking station 3000 may be operating at a high charge rate, for example a rate of approximately 2C, when the temperature of an object on or near the charging surface 3104 is identified to exceed a predetermined warning value. In response, the station computing device 4350 first turns off charging completely, ceasing all power transmission through the transmitter coil assemblies 4100a and 4100b, and maintains this fully de-energized state until the temperature of the object has dropped below the predefined warning value. Once the temperature has dropped below the predefined value, the station computing device 4350 slowly ramps up the charging current in a controlled, incremental manner. During this ramp-up phase, the temperature of the object may increase above its cooled baseline, but the rate of current increase is regulated such that the temperature remains below the predetermined warning value at all times. This approach ensures that charging resumes as quickly as thermal conditions safely permit, while preventing the system from immediately returning to a high charge rate that could reproduce the original overtemperature condition. In a second thermal management embodiment, once the temperature of the object exceeds the predetermined warning value, the station computing device 4350 does not immediately cease charging but instead slowly ramps down the charging current in a controlled, decremental manner, progressively reducing the rate of heat generation until the temperature of the object decreases below the predetermined warning value. This second approach avoids the complete interruption of charging and may be preferred when the detected temperature exceedance is moderate and the thermal trajectory suggests that a gradual reduction in power will be sufficient to restore safe thermal equilibrium. In either embodiment, the station computing device 4350 may additionally or alternatively activate or increase the intensity of the active cooling system 5000 to supplement the current-based regulation and accelerate the return to nominal operating temperatures.

If the temperature measured by the sensor 4118 or sensors 3113a, 3113b approaches a critical limit that could risk damage to the insulation of the wire 4117, the structural integrity of the carrier 4116, or other adjacent components of the docking station 3000 or the robot's feet 92, the charging controller 4104 is programmed to respond by automatically and immediately reducing the transmitted power, thereby lowering the current in the wire 4117 and rapidly decreasing the rate of heat generation to prevent component degradation or failure.

At step 6040 of the process 6000, the thermal management system evaluates the continuously acquired temperature data to determine whether a new thermal anomaly has arisen since charging was initiated or last resumed at step 6030. A new thermal anomaly that appears after charging has commenced may have several causes. In a first scenario, a foreign object may have fallen onto the charging surface 3104 after the pre-charging FOD inspection confirmed the surface to be clear, for example as a result of debris dislodged from the robot's body or from the surrounding environment. In a second scenario, a foreign object may be detected even after the charging surface 3104 has been cleaned at step 6060, which may indicate that the foreign object is not resting freely on the charging surface 3104 but is instead adhered to or embedded in the bottom of one of the robot's feet 92, where it was occluded from the sensors during the initial inspection and has now begun to heat anomalously under the influence of the alternating magnetic field.

If a new thermal anomaly is detected at step 6040, the process 6000 advances to step 6050, at which the charging controller 4104 takes immediate protective action. The controller 4104 may partly de-energize the transmitter coil assemblies 4100a and 4100b, reducing the transmitted power to a level that limits further heating of the detected anomaly while maintaining a reduced rate of charge. Alternatively, if the temperature associated with the anomaly exceeds a maximum safety limit—for example, a limit derived from the thermal thresholds specified in IEC 62368-1—the controller 4104 may terminate power transmission entirely by fully de-energizing the transmitter coil assemblies 4100a and 4100b, thereby eliminating the magnetic field that is driving the anomalous heating and reducing the risk of thermal runaway, fire, or damage to the charging mat 3100, the robot's feet 92, or the foreign object itself.

Following the protective action at step 6050, the process 6000 advances to step 6060, at which the feet 92 of the robot 1 and the charging surface 3104 are inspected and, if needed, cleaned to remove the foreign object responsible for the thermal anomaly. The inspection at step 6060 may include the interactive foot-lifting sequence described above with reference to FIGS. 43 through 46, in which the robot 1 sequentially lifts each foot 92 to expose its sole and the underlying charging surface 3104 to the unobstructed view of the sensors 3113a and 3113b. This foot-lifting sequence is particularly relevant in the second scenario described above, in which the foreign object is suspected to be carried on the underside of a foot 92 rather than resting on the charging surface 3104. After inspection and any necessary cleaning, the process 6000 returns to step 6010 for re-verification, and the cycle of detection, cleaning, re-verification, and charging continues until the charging cycle can proceed without interruption.

Throughout each charging cycle, the thermal data acquired by the temperature sensor 4118 and the base sensors 3113a and 3113b is logged by the station computing device 4350 and may be transmitted, either in real time or in periodic batches, to a central command center 2750A-X. By aggregating and analyzing the thermal history of each charging cycle over many successive cycles, the central command center 2750A-X or associated analytics systems may perform predictive maintenance analysis. This analysis may identify gradual trends—such as a progressive increase in steady-state coil temperatures, a lengthening of the time required for temperatures to stabilize after charging initiation, or an increasing frequency of thermal anomaly events—that may indicate a degrading component in the docking station 3000 or in a specific robot 1 before the degradation progresses to the point of an outright failure. For example, a gradual upward drift in the peak temperature recorded at the transmitter coil assemblies 4100a and 4100b across successive charging cycles may indicate degradation of thermal interface materials within the charging mat 3100, fouling of heat dissipation pathways, or a developing electrical fault in the coil windings, any of which may warrant preemptive servicing of the docking station 3000. Similarly, a pattern of recurring thermal anomalies localized to a particular foot 92 of a particular robot 1 may indicate that the receiver coil assembly or thermal interface in that foot 92 requires inspection or replacement. By enabling such early detection, the predictive maintenance capability reduces unplanned downtime and contributes to the overall reliability and safety of the fleet of robots 1 and their associated docking stations 3000. The FOD system is configured throughout to operate such that the temperature of any foreign object 4112 detected on or near the charging surface 3104 does not exceed the limits prescribed by applicable safety standards, such as IEC 62368-1, thereby facilitating the safe, reliable, and fully autonomous operation of the humanoid robot 1 across a broad range of deployment environments.

### iii. Communication Interface

The station electronics assembly 3500 may include a communication transceiver 3400 or other means of data communication configured to communicate with the robot 1. In the illustrative embodiment, the communication transceiver 3400 is positioned in the support cradle 3300 and configured to couple with a corresponding wireless transceiver 604.34 positioned within the waist portion 604 of the robot 1. When docked, the two transceiver assemblies are brought into a face-to-face arrangement, separated by a small or minimal air gap (e.g., 5mm, 1cm, 2cm, 5cm). This arrangement allows the robot 1 to offload large volumes of sensor data or receive major firmware updates while docked. The external support provided by the cradle 3300 allows the robot 1 to maintain stable alignment between the transceivers to maintain wireless high-bandwidth communications with the docking station 3000. In other embodiments, the docking station 3000 may be configured with other means of data communication, such as a direct optical data link or an ultra-wideband (UWB) radio link.

The communication transceiver 3400 may be communicatively coupled to other electronic components of the docking station 3000 and/or to external systems by means of a communication bus. For example, the communication bus may be a 10GBase-T ethernet cable (e.g., a CAT-6, CAT-6a, or CAT-7 cable) routed to extend down through the interior of the vertical support portion 3204 to connect to compatible transceivers that are located in the vertical support portion 3204, in the charging mat 3100, and/or to exit the docking station 3000 for connection to other external equipment (e.g., to plug into a wall-mounted ethernet jack that is connected to a local area network (LAN)). In operation, the communication transceiver 3400 acts as a wired-to- wireless communication bridge in order to provide high bandwidth, bidirectional communication between the robot 1 and the docking station 3000 and/or other external systems and servers. In some embodiments, the communication transceiver 3400 may support multiple wireless protocols, such as Wi-Fi 6E and Bluetooth Low Energy, to provide both high-bandwidth data transfer and low-power control signaling over independent channels.

### d. Active Cooling System

As discussed previously, the WPT system 4000 can generate a great deal of heat during operation. The overall arrangement of the WPT system 4000 and the active cooling system 5000 is configured to facilitate the removal of thermal energy from the docking station 3000. The active cooling system 5000 generates air flow paths F through portions of the charging mat 3100 and the support stand 3200 to cool components of the WPT system 4000 in the docking station 3000. This integrated thermal management infrastructure is configured to mitigate heat generated during high-power wireless charging operations, thereby supporting desired performance, longevity, and operational safety of the docking station 3000 and the robot 1.

The active cooling system 5000 includes: (i) a pair of fan assemblies 5100a, 5100b, (ii) a pair of air ducts 5110a, 5110b, and (iii) a thermal transfer device 5200. The fan assemblies 5100a, 5100b (also referred to as air moving devices), are arranged within the support stand 3200 and configured to generate the air flow path F. The air ducts 5110a, 5110b are coupled to an outlet 5100.4a, 5100.4b of a respective fan assembly 5100a, 5100b to receive air drawn in through inlet apertures 5114 formed in the support stand 3200 by the fan assemblies 5100a, 5100b and direct the air toward the thermal transfer device 5200. The thermal transfer device 5200 is configured to receive thermal energy or heat generated by the WPT system 4000. The thermal transfer device 5200 is positioned within the air flow path F so that air exhausted by the fan assemblies 5100a, 5100b flows along the thermal transfer device 5200 (e.g., plurality of heat transfer features 5210). In this way, heat is transferred to the air flow path from the components of the WPT system 4000 in thermal communication with the thermal transfer device 5200.

The active cooling system 5000 is configured as a modular and readily replaceable or interchangeable component, offering significant advantages in terms of manufacturing, maintenance, and potential future upgrades. For example, the fan assemblies 5100a, 5100b, the air ducts 5110a, 5110b, and the thermal transfer device 5200 may each be individually replaceable without disassembling the entire docking station 3000, thereby reducing service time and cost. This thermal management strategy can contribute to maintaining operating temperatures within the docking station 3000, mitigating component degradation, and supporting consistent power transfer. The illustrated examples provided in the figures show the integrated nature of these components, demonstrating how the wireless charging elements may be cooled to reduce overheating and support the operation of the docking station 3000 while charging the robot 1.

### i. Fan Assemblies

As shown in FIGS. 6-15, the active cooling system 5000 includes two fan assemblies, a left fan assembly 5100a and a right fan assembly 5100b, that are arranged within the flared base 3110. The fan assemblies 5100a, 5100b are configured to generate a forced airflow along the air flow path F to actively cool the heat-producing components of the WPT system 4000, particularly the transmitter coil assemblies 4100a, 4100b. Specifically, the fan assemblies 5100a, 5100b ingest or draw in cool, ambient air through the inlet apertures 5114 formed in the flared base 3110 into the respective air duct 5110a, 5110b. As such, the inlet apertures 5114 are formed in a lower extent of the base 3110, and specifically in the lower support shell 3134 of said base 3110.

The left fan assembly 5100a is arranged in the left leg 3110.4a of the flared base 3110 and the right fan assembly 5100b is arranged in the right leg 3110.4b of the flared base 3110. Each of the fan assemblies 5100a, 5100b is arranged: (i) between the upper support shell 3130 and the lower support shell 3134 in the flare cavity 3208, (ii) between the internal support structure 3132 and the lower support shell 3134, and (iii) towards flared ends 3110.6a, 3110.6b of the flared base portion 3110 closer to the charging mat 3100. In such a configuration, the fan assemblies 5100a, 5100b are protected from external objects, and the system avoids ingesting dust that vertically falls onto the upper surfaces of the flared base 3110. The positioning of the fan assemblies 5100a, 5100b within the structural envelope of the flared base 3110 also reduces acoustic transmission to the surrounding environment, as the shells 3130, 3134 serve as sound-attenuating barriers.

Each fan assembly 5100a, 5100b includes: an inlet end 5100.2a, 5100.2b and an outlet end 5100.4a, 5100.4b, as shown in FIGS. 6-15. The inlet end 5100.2a, 5100.2b of each fan assembly 5100a, 5100b is arranged at or near the inlet apertures 5114 such that the inlet end 5100.2a, 5100.2b is located at an elevation above the charging mat 3100. Due to the configuration of the fan assembly 5100a, 5100b, the air flow path into the docking station starts at a point that is elevated above the platform surface 3102. Said distance between the platform surface 3102 and the lowest inlet aperture 5114 that can allow for the generation of the air flow path may be greater than 15 mm, preferably greater than 40 mm, and most preferably greater than 75 mm. As such, the lowest inlet aperture 5114 is positioned at a distance that is greater than 5 mm, preferably greater than 15 mm, and most preferably greater than 35 mm above the upper surface of the wireless charging surface 3104. Meanwhile, the inlet end 5100.2a, 5100.2b is positioned at a distance that is greater than 10 mm, preferably greater than 25 mm, and most preferably greater than 40 mm above the upper surface of the wireless charging surface 3104. This elevated configuration distances the fan assemblies 5100a, 5100b from dirt, dust, and other contaminants that may be found on the platform cover 3160 or other parts of the charging mat 3100 or the surrounding floor or ground, which aids in keeping the active cooling system 5000 in a functioning state.

The inlet end 5100.2a, 5100.2b faces the charging mat 3100 and is angled relative to the wireless charging surface 3104. Specifically, an acute angle (e.g., smaller than 65 degrees, preferably smaller than 45 degrees, and most preferably smaller than 35 degrees) is formed between the charging mat 3100 and each fan assembly 5100a, 5100b. Thus, the fan assemblies 5100a, 5100b ingest air in an upward direction (e.g., relative to gravity) through the collection of air inlets (e.g., apertures 5114) formed in the lower support shell 3134. Such a configuration limits the size of an object that can enter because the object would need to be light enough to be drawn upwards (e.g., against gravity) through the air ducts 5110a, 5110b. In contrast, fans configured to draw air in from the side on a linear path may be located near to the ground where debris is most likely to be found, can allow much larger particles to enter the system with considerably less force. The fan assemblies 5100a, 5100b are not positioned on a 90-degree angle in order to reduce restrictions in air flow, however, in some embodiments such positioning may be used.

The outlet end 5100.4a, 5100.4b of each fan assembly 5100a, 5100b is arranged closer to the thermal transfer device 5200 in comparison to the inlet end 5100.2a, 5100.2b. The outlet end 5100.4a, 5100.4b is axially offset from the inlet end 5100.2a, 5100.2b to exhaust the air downward into the air duct 5110a, 5110b such that the air is directed toward the thermal transfer device 5200. As will be described in greater detail below, the outlet end 5100.4a, 5100.4b is positioned within the air ducts 5110a, 5110b. However, in other embodiments, the air ducts 5110a, 5110b may be omitted, and the outlet end 5100.4a, 5100.4b may be positioned proximate, near, or adjacent to the thermal transfer device 5200.

In some embodiments, the inlets may include a removable filter between the apertures 5114 and an inlet of the fan assemblies 5100a, 5100b that can further protect the active cooling system 5000 from the ingestion of dust, dirt, and other debris, and may be replaced or refreshed (e.g., washed and reused) in order to maintain a sufficient air flow capacity. The removable filter may be composed of a mesh, a foam, a fibrous mat, or another porous medium with a pore size selected to balance particulate capture with acceptable pressure drop. In other embodiments, the fan assemblies 5100a, 5100b may be configured as centrifugal (e.g., blower) fans. Centrifugal fans are distinguished by their operational principle of drawing air in axially (parallel to the fan's rotational axis) and expelling it radially (perpendicular to the fan's axis). This inherent design characteristic renders them particularly effective for generating high static pressure, which may be a useful attribute when attempting to propel air through restrictive pathways, such as the narrow channels 5210 of the thermal transfer device 5200, or other ducted systems. Their superior capability to overcome significant air resistance makes them suitable for applications that call for a focused and directed airflow, which is useful for efficient thermal energy removal from densely packed component arrangements.

In further embodiments, the fan assemblies 5100a, 5100b may be configured as axial fans. Axial fans operate by moving air predominantly in an axial direction, parallel to their axis of rotation. Axial fans generally exhibit high efficiency in moving large volumes of air in relatively open spaces or environments where there is minimal resistance to airflow. While they typically produce less static pressure compared to centrifugal fans, their design may be advantageous for applications where a high volumetric flow rate is prioritized or where noise reduction is a principal design constraint. The choice between use of centrifugal and axial fans for the fan assemblies 5100a, 5100b may be based upon specific design considerations, including but not limited to the desired airflow volume and pressure, available spatial envelopes, stringent noise constraints, and the overarching thermal management strategy for the docking station.

In some implementations and under some predetermined conditions that may be indicative of blocked or impeded air flow (e.g., reduced cooling is detected, fan motor current is abnormally high), active cooling system 5000 can provide a signal to humans or to the robot 1 that a problem has been detected, and the human or the robot 1 can respond by cleaning the inlets 5114. In some similar situations, the fan assemblies 5100a,5100b may be controlled to temporarily reverse direction, which can cause a pulse of air to flow out of the inlets 5114 in an attempt to dislodge and/or blow out any debris that may have accumulated in a way that impedes the ingestion of air. The signal may be conveyed through a visual indicator (e.g., an LED on the docking station 3000), an audible alert, or a wireless message transmitted to the robot 1 or to a fleet management system. The reversal of fan direction may be performed at periodic intervals as a preventative maintenance measure, or it may be triggered on demand in response to sensor readings that exceed a predetermined threshold.

### ii. Air Ducts

The active cooling system 5000 includes the air ducts 5110a, 5110b arranged within the flared base 3110, as shown in FIGS. 6-15. The air ducts 5110a, 5110b are configured to direct the airflow generated by the fan assemblies 5100a, 5100b toward the thermal transfer device 5200. Each air duct 5110a, 5110b is coupled to the outlet end 5100.4a, 5100.4b of the respective fan assembly 5100a, 5100b and extends toward the thermal transfer device 5200 to direct the air toward the heat transfer features 5210 of the thermal transfer device 5200. Each air duct 5110a, 5110b is shaped to channel at least a portion of the airflow generated by the fan assemblies 5100a, 5100b and direct it efficiently toward the thermal transfer device 5200. In the illustrative embodiment, each air duct 5110a, 5110b is also shaped to channel at least a portion of the airflow generated by the fan assemblies 5100a, 5100b and direct it efficiently toward outlet openings 5502a, 5502b in the flared base portion 3110 for cleaning the wireless charging surface 3104 of the charging mat 3100 as discussed in further detail below.

As shown in FIGS. 6-15, the active cooling system 5000 includes two air ducts 5110a, 5110b, a left air duct 5110a for the left fan assembly 5100a and a right air duct 5110b for the right fan assembly 5100b. The left air duct 5110a is arranged in the left leg 3110.4a of the flared base 3110 and the right air duct 5110b is arranged in the right leg 3110.4b of the flared base 3110. Each of the air ducts 5110a, 5110b is arranged: (i) between the upper support shell 3130 and the lower support shell 3134 in the flare cavity 3208, (ii) between the internal support structure 3132 and the lower support shell 3134, (iii) towards flared ends 3110.6a, 3110.6b of the flared base portion 3110 closer to the charging mat 3100, and (iv) between the respective fan assembly 5100a, 5100b and the thermal transfer device 5200. The air ducts 5110a, 5110b may be formed as integral molded structures or as discrete components that are fastened or bonded within the flare cavity 3208.

Each air duct 5110a, 5110b includes: an inlet end 5110.2a, 5110.2b, an outlet end 5110.4a,5110.4b, and a curved section 5110.6a, 5110.6b as shown in FIGS. 6-15. The inlet end 5110.2a, 5110.2b of each air duct 5110a, 5110b is coupled to the outlet end 5100.4a, 5100.4b of the respective fan assembly 5100a, 5100b to receive the exhausted air from the fan assembly 5100a, 5100b. The outlet end 5110.4a, 5110.4b of each air duct 5110a,5110b is arranged adjacent to the heat transfer features 5210 of the thermal transfer device 5200 to direct the airflow generated by the fan assemblies 5100a, 5100b through the heat transfer features 5210 to dissipate the heat generated by the WPT system 4000. The curved section 5110.6a, 5110.6b extends between the inlet end 5110.2a, 5110.2b and the outlet end 5110.4a, 5110.4b. The curved section 5110.6a, 5110.6b is shaped to turn and direct the air from the inlet end 5110.2a, 5110.2b to the outlet end 5110.4a, 5110.4b, and the radius of curvature of the curved section 5110.6a, 5110.6b may be selected to minimize pressure losses and turbulence-induced noise.

As shown in FIGS. 9-16, the outlet end 5110.4a,5110.4b may have a first outlet opening 5110.4.2a, 5110.4.2b and a second outlet opening 5110.4.4a, 5110.4.4b. The first outlet opening 5110.4.2a, 5110.4.2b of each air duct 5110a, 5110b directs at least a portion of the airflow (i.e., the air flow path F) generated by the fan assemblies 5100a, 5100b through the heat transfer features 5210 to dissipate the heat generated by the WPT system 4000. The second outlet opening 5110.4.4a, 5110.4.4b of each air duct 5110a, 5110b directs at least a portion of the airflow (i.e., the air flow path Fₖ) generated by the fan assemblies 5100a, 5100b through the outlet openings 5502a, 5502b in the flared base portion 3110 over the wireless charging surface 3104 of the charging mat 3100. In some embodiments, the air duct 5110a, 5110b may have a bifurcation wall that divides the internal volume of the air duct 5110a, 5110b into a first passage leading to the first outlet opening 5110.4.2a, 5110.4.2b and a second passage leading to the second outlet opening 5110.4.4a, 5110.4.4b, thereby apportioning the airflow between the cooling function and the cleaning function.

### iii. Thermal Transfer Device

The active cooling system 5000 includes a thermal transfer device 5200, as shown in FIGS. 5-6 and 8-15. The thermal transfer device 5200 is configured to receive thermal energy or heat generated by the WPT system 4000 and transfer the heat from the WPT system 4000 to the air flowing through the air flow path F. The thermal transfer device 5200 is positioned towards a rear extent of the charging mat 3100, rearward of the transmitter coil assemblies 4100a, 4100b (e.g., from the perspective of a docked robot). The thermal transfer device 5200 is designed with heat transfer features 5210 (e.g., a network of channels) that run from inlet ends 5212 to outlet ends 5214. The channel network 5210.4 defined between the partition walls 5210.2 is configured to guide a forced airflow from the fan assemblies 5100a, 5100b across the thermal transfer device's surface, thereby dissipating thermal energy conducted from the WPT system 4000.

As shown in FIGS. 5-6 and 8-15, the thermal transfer device 5200 includes a network of channels 5210. The channels 5210 may be formed within the thermal transfer device 5200 through a subtractive process such as machining, etching, or stamping. Alternatively, walls 5210.2 may be formed separately and coupled to (e.g., welded, brazed, soldered, fastened, thermal epoxied, etc.) a surface of the thermal transfer device 5200 to form the network of channels 5210. The channels 5210 originate from inlet ends 5212, defined near lateral sides 5200.2a, 5200.2b of the thermal transfer device 5200 and terminate at outlets 5214, which are positioned proximally to the rear of both the thermal transfer device 5200 and the charging mat 3100. The thermal transfer device 5200 may be fabricated from a material exhibiting high thermal conductivity, such as copper, aluminum, or an alloy thereof, to promote efficient conduction of heat from the WPT system 4000 into the walls 5210.2 and surrounding surfaces of the channels 5210.

The arrangement of the channels 5210 is such that the air is directed from the inlet ends 5212 to the outlet ends 5214 as shown in FIGS. 5-6 and 8-15. In the illustrative embodiment, the channels 5210 each extend laterally inward from the inlet ends 5212, substantially perpendicular to and away from the lateral sides 5200.2a, 5200.2b of the thermal transfer device 5200, before transitioning through a curved, approximately 90-degree bend towards the rear extent of the charging mat 3100. The channels 5210 then terminate at outlets 5214 at the rear of the charging mat 3100. In other embodiments, the geometry of the internal channels 5210 within the thermal transfer device 5200 may be configured in alternative arrangements to further enhance the efficacy of the heat transfer process. For instance, rather than being substantially straight, the channels 5210 may be formed into a serpentine or wavy pattern. Such a configuration would increase the overall length of the airflow path, thereby increasing the residence time of the air within the thermal transfer device 5200 and allowing for more complete thermal absorption.

The channels 5210 may also vary in thickness, height, orientation, and spacing to optimize airflow and heat transfer depending on the specific cooling needs and design constraints. For example, the channels 5210 may: (i) have a rectangular cross-sectional shape, (ii) a curved cross-sectional shape, or (iii) have any other suitable cross-sectional shape that is known to one of skill in the art. Furthermore, the channels 5210 may be configured to induce turbulence in the airflow, which disrupts the laminar boundary layer adjacent to the channel walls 5210.2 and improves the convective heat transfer coefficient. In another embodiment, the walls 5210.2 of the channels 5210 may be augmented with features such as fins, ribs, or other forms of turbulators. These features may serve a dual purpose of substantially increasing the total surface area available for heat exchange while also inducing turbulence into the airflow, further enhancing the rate of heat dissipation.

In some embodiments, the predetermined geometry, whether it be a pin-fin array, offset strip fins, or another configuration, may be determined through a detailed thermal and fluid dynamics analysis to balance heat transfer performance with the resultant increase in pressure drop across the thermal transfer device 5200, a balance which may be dynamically managed by a control system configured to adjust the speed of the fan assemblies 5100a, 5100b in response to real-time thermal data from one or more sensors, such as temperature sensors 4118 configured to provide real-time thermal monitoring capabilities, which may be utilized for dynamic control of the active cooling system 5000 and for mitigating the risk of thermal runaway conditions that may affect component integrity or operational efficiency. The control system may implement a proportional-integral-derivative (PID) control algorithm, or another closed-loop control strategy, to regulate the rotational speed of the fan assemblies 5100a, 5100b based on feedback from the temperature sensors 4118. The temperature sensors 4118 may be positioned at multiple locations within the charging mat 3100, including near the transmitter coil assemblies 4100a, 4100b and on or adjacent to the thermal transfer device 5200. In some embodiments, the control system may operate the fan assemblies 5100a, 5100b at a reduced speed during idle or low-power states and ramp the speed to a higher level as thermal loading increases, thereby conserving energy and minimizing acoustic output when full cooling capacity is not called for.

In some embodiments, the channels 5210 may be configured to utilize fluid impingement to further improve heat transfer. For example, the channels 5210 may be configured such that at one or multiple locations within the thermal transfer device 5200, the airflow 5910 may be caused to impinge upon a channel 5210 sidewall (e.g., at T-shaped junction) and be redirected. Such impingement can increase fluid flow and disrupt laminar flow along the sidewall at the point of impingement, thereby increasing the heat transfer capacity of the thermal transfer device 5200 at the point(s) of impingement. The T-shaped junction may be oriented so that the impinging stream strikes the sidewall at an angle of between 60 degrees and 90 degrees relative to the plane of the sidewall, which may maximize the disruption of the thermal boundary layer at that location.

In yet another embodiment, the internal channels 5210 may be configured to function as fluidic diodes, which are passive devices with no moving parts that exhibit a differential resistance to the airflow 5910 based on direction. For example, the channel 5210 may incorporate a series of Tesla valves. A Tesla valve consists of a main conduit with a series of bifurcating, looping pathways that rejoin the main conduit at an opposing angle. In the forward direction, the flow proceeds with low resistance down the main conduit. In the reverse direction, however, the flow is diverted into the looping pathways, where the fluid streams are forced to collide with one another, creating significant turbulence and a substantially higher resistance to flow. By integrating such a valving geometry into the channels 5210 of the thermal transfer device 5200, a preferential, unidirectional flow of air 5910 may be passively encouraged, thereby being configured to improve the overall efficacy of the active cooling system 5000. This configuration may inhibit the reverse flow of heated air from the outlets 5214 back toward the fan assemblies 5100a, 5100b, particularly during off-cycles or in the event of a fan failure, thereby preventing the recirculation of hot air and maintaining a baseline of passive cooling efficiency. Such a passive feature can also reduce the operational duty cycle of the fan assemblies 5100a, 5100b, leading to lower overall power consumption, reduced operational noise, and increased lifespan of the active components.

In addition to providing cooling functions, the thermal transfer device 5200 also serves as a physical barrier between the cooling airflow and other components within the charging mat 3100, such as the transmitter power electronics 4310a and 4310b, and the main PCBA 4314. The thermal transfer device 5200 provides physical separation between potentially sensitive internal components of the charging mat 3100, and contaminants from the ambient environment that may be ingested by the fans 5100a, 5100b. While the airflow path may be in thermal communication or connection with the electronic components of the WPT system 4000, it should be understood that said airflow path is physically isolated or sealed away from the electronic components of the WPT system 4000. As described herein, this configuration helps prevent any contaminants from physically contacting the electronic components of the WPT system 4000 and causing premature failures with said electronic components of the WPT system 4000.

In some embodiments, the thermal transfer device 5200 can partly define a substantially sealed or environmentally isolated internal space within the charging mat 3100, in accordance with industrial standards. For example, the thermal transfer device 5200 may be part of a sealing arrangement that provides an ingress protection (IP) rating such as IP68, IP65, or IP69, and/or a National Electrical Manufacturers' Association (NEMA) rating such as NEMA 4 or NEMA 6, the latest of both are incorporated herein by reference. Environmental isolation can promote the longevity and reliability of the docking station 3000, as the docking station 3000 is configured to be located near or within the workspace of the robot 1, and some workspaces can expose the docking station 3000 to environmental contaminants. For example, on an industrial work floor, the docking station 3000 may be exposed to dropped work materials (e.g., lost fasteners), sawdust, metal shavings, paint overspray, dust, and/or smoke. In another example, in a domestic or retail environment, the docking station 3000 may be exposed to contaminants such as dust, carpet fibers, liquid spills, pet dander, and/or human hair. In yet another example, in an outdoor environment (e.g., a farm), the docking station 3000 may be exposed to contaminants such as dirt, dust, insects, and/or rain. The sealing arrangement may include gaskets, O-rings, adhesive sealants, or a combination thereof disposed along the interfaces between the thermal transfer device 5200 and the adjacent structural components of the charging mat 3100.

### iv. Operation of Active Cooling System

The thermal transfer device 5200 is arranged within the flared base 3110 and positioned to receive heat from the thermal conductors 4170 and receive the focused airflow generated by the fan assemblies 5100a, 5100b and directed through the air ducts 5110a, 5110b. The ducted arrangement is configured to direct the air through the channels 5210 of the thermal transfer device 5200, which facilitates convective heat transfer for the dissipation of thermal energy generated during the charging process and carried away from the carriers 4116 and to the heat transfer device 5200 by the thermal conductors 4170. The thermal conductors 4170 may be embodied as solid metallic conductors, heat pipes, vapor chambers, or another thermally conductive medium that bridges the distance between the heat-generating transmitter coil assemblies 4100a, 4100b and the thermal transfer device 5200. The rate of heat conduction through the thermal conductors 4170 is a function of the cross-sectional area, the length, and the thermal conductivity of the material from which the thermal conductors 4170 are fabricated.

The active cooling system 5000 generates an air flow path F through portions of the charging mat 3100 and the support stand 3200 to cool components of the WPT system 4000 in the docking station 3000. The operational cycle of the active cooling system 5000 is initiated by the aspiration of ambient air into the docking station 3000. The fan assemblies 5100a, 5100b draw in or ingest air through one or more inlet apertures 5114 defined within the flared base 3110. The fans 5100a, 5100b then exhaust the air through the air ducts 5110a, 5110b toward the thermal transfer device 5200, whereupon the air is made to traverse the thermal transfer device 5200. During its passage through the structure of the thermal transfer device 5200, the airflow effectuates a thermodynamic exchange via forced convection, wherein the moving air absorbs waste thermal energy that has been conducted to the thermal transfer device 5200 from its source, namely the electronic components of the wireless power transfer (WPT) system 4000. Following this heat absorption, the now-heated, or thermally energized, air is exhausted from the docking station 3000. As shown in FIG. 7, the air is exhausted out the outlet ends 5214 from the rear of the charging mat 3100 and into the surrounding environment. This cycle of cool air intake and warm air expulsion provides a mechanism by which the active cooling system 5000 is configured to regulate the operational temperature of the internal electronic components, maintaining them within their specified design limits, which can contribute to system reliability and longevity.

### e. Cleaning System

The cleaning system 5500 is configured to perform the cleaning procedure to remove any foreign objects and/or debris from the charging mat 3100. The cleaning system 5500 may be configured to perform the cleaning procedure (i) in response to the detection of foreign objects and/or debris by the sensor assembly 3111 and/or (ii) in response to detecting the robot 1 is about to perform the docking procedure. For example, the charging controller 4104 may receive a signal from the robot 1 that the robot 1 plans to dock on the docking station 3000. The charging controller 4104 or another control unit within the docking station 3000 may proactively activate the cleaning system 5500 without performing any foreign object detection in response to this signal.

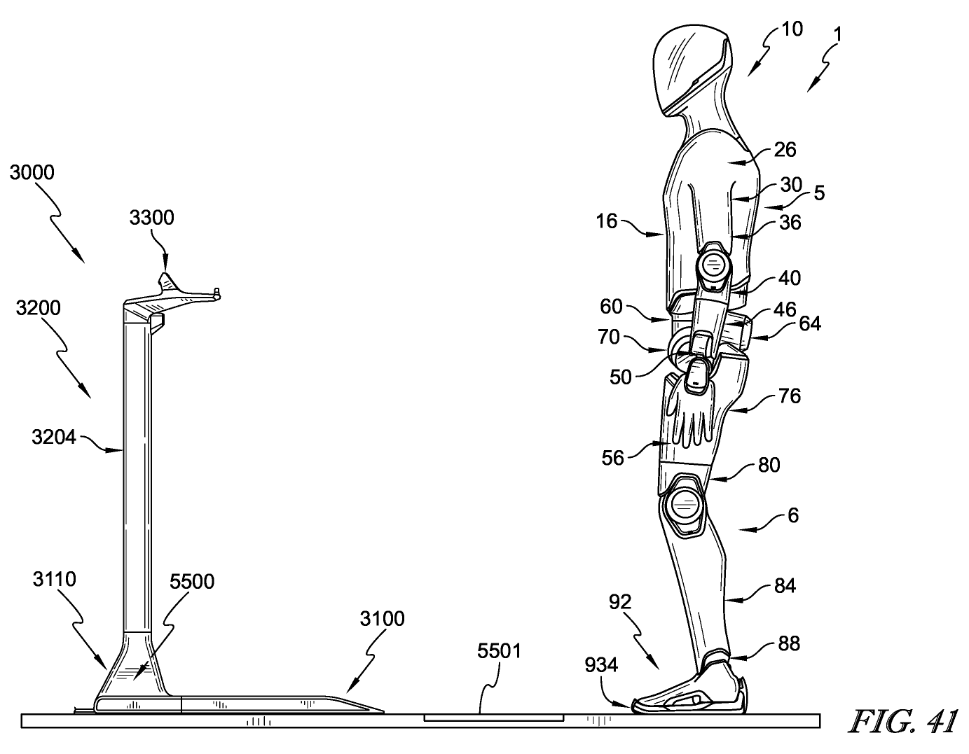

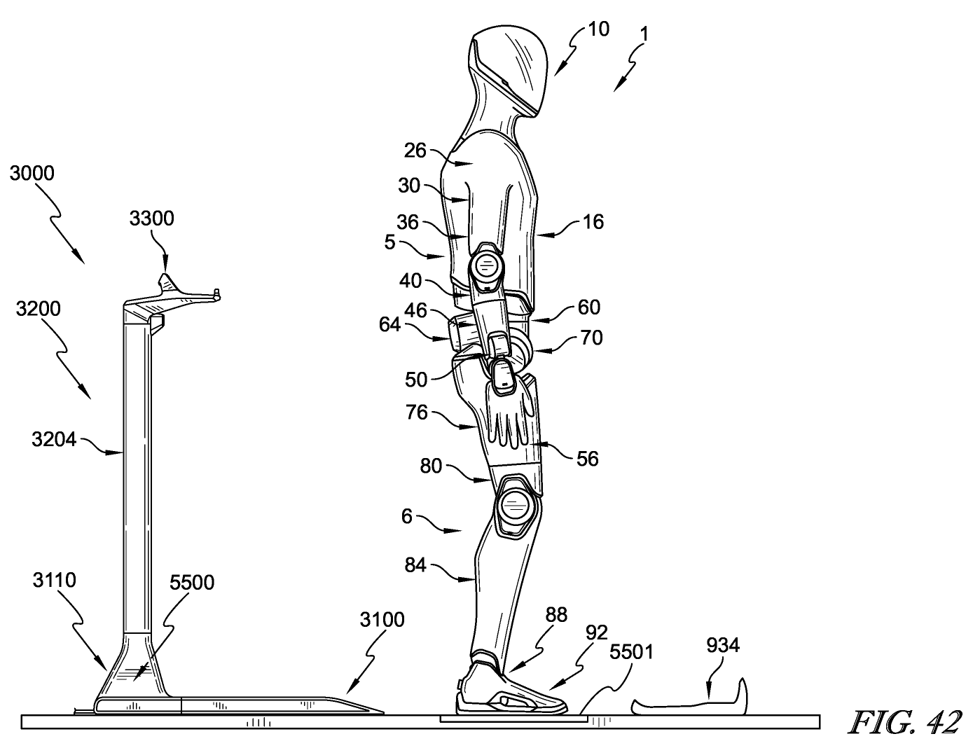

FIGS. 41-45 illustrate the process of proactively cleaning the wireless charging surface 3104 and/or the soles of the robot's feet 92 before docking the robot 1 on the docking station 3000. As shown in FIG. 41, the charging controller 4104 receives a signal from the robot 1 that the robot 1 plans to dock on the docking station 3000. In response to the signal, the charging controller 4104 or another control unit within the docking station 3000 activates the cleaning system 5500 before or without performing any foreign object detection. Simultaneously, the robot 1 may remove the foot cover 934 from each foot 92 prior to charging as suggested in FIGS. 41 and 42. While the foot cover 934 protects the underlying foot 92, the energy absorbing material of the foot cover 934 may be more likely to pick up or collect foreign objects or debris while the robot 1 is walking. Thus, to avoid tracking the foreign objects and/or debris onto the charging surface 3104 of the charging mat 3100, the robot 1 may remove the foot cover 934 before stepping on the charging mat 3100.

Once the foot covers 934 are removed, the control system 1000 of the robot 1 may still command the robot 1 to sequentially lift each foot 92 to remove any remaining foreign objects and/or debris from the soles of the feet 92 as suggested in FIG. 43. The cleaning system 5500 may be activated while the robot 1 lifts each foot 92 to remove any remaining foreign objects and/or debris from the soles of the feet 92. After cleaning, the FOD system may check for any remaining foreign objects and/or debris or the robot 1 may be directed to continue the docking maneuver. The timing and sequence of foot lifting, cleaning activation, and FOD inspection may be coordinated by the charging controller 4104 in conjunction with the control system 1000 of the robot 1, with the two systems exchanging status signals over the communication link.

Alternatively, the robot 1 may continue the docking maneuver directly after removing the foot covers 934 as suggested in FIG. 46. Instead of lifting each foot 92 before positioning itself on the docking station 3000, the robot 1 may continue to the fully docked state. Once in the fully docked state, the control system 1000 of the robot 1 commands the robot 1 to sequentially lift each foot 92 or simultaneously lift both feet 92 to remove any remaining foreign objects and/or debris from the soles of the feet 92 as suggested in FIG. 46. While the robot 1 lifts its feet 92 in the fully docked state, the support stand 3200 or another structural element of the docking station 3000 may provide physical support to the robot 1 to maintain its balance and stability.

The cleaning system 5500 may utilize fan assemblies, wiper blades, or another self-cleaning mechanism to remove the foreign objects and/or debris. For living foreign objects (e.g., cats), the cleaning system 5500 may disturb or scare the living foreign object, causing the living foreign object to remove itself from the charging mat 3100. For other non-living objects, the cleaning system 5500 applies a force to dislodge and/or remove the foreign objects. In embodiments where the cleaning system 5500 uses fan assemblies to remove debris from the charging mat 3100, these fans may also be activated to supplement the active cooling system 5000.

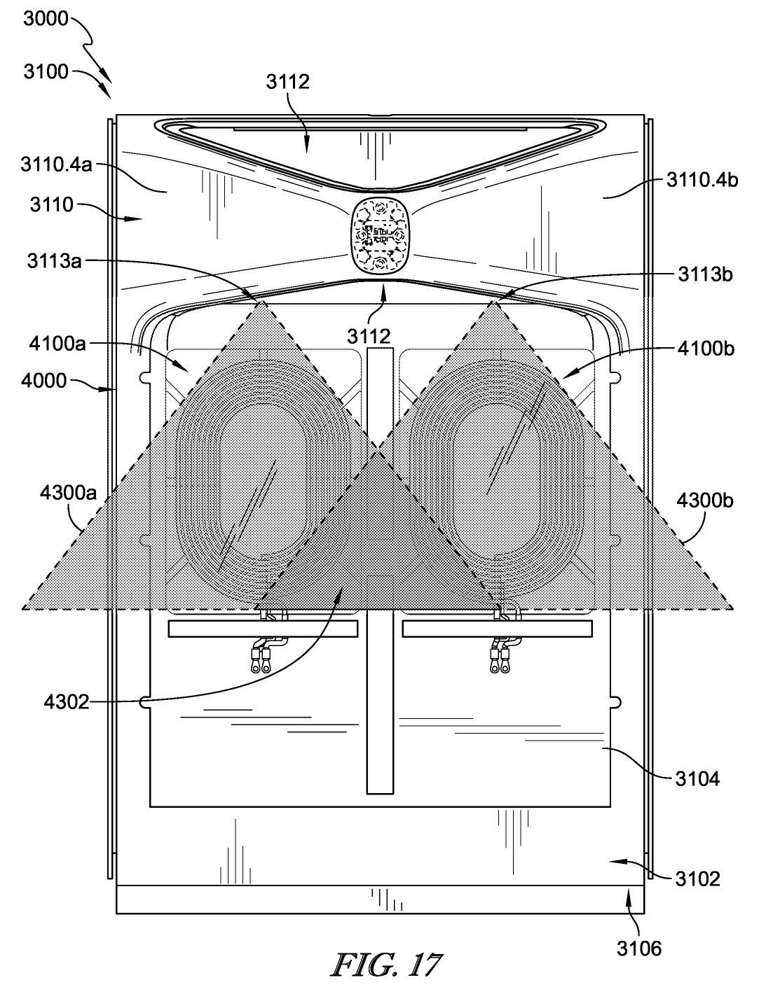

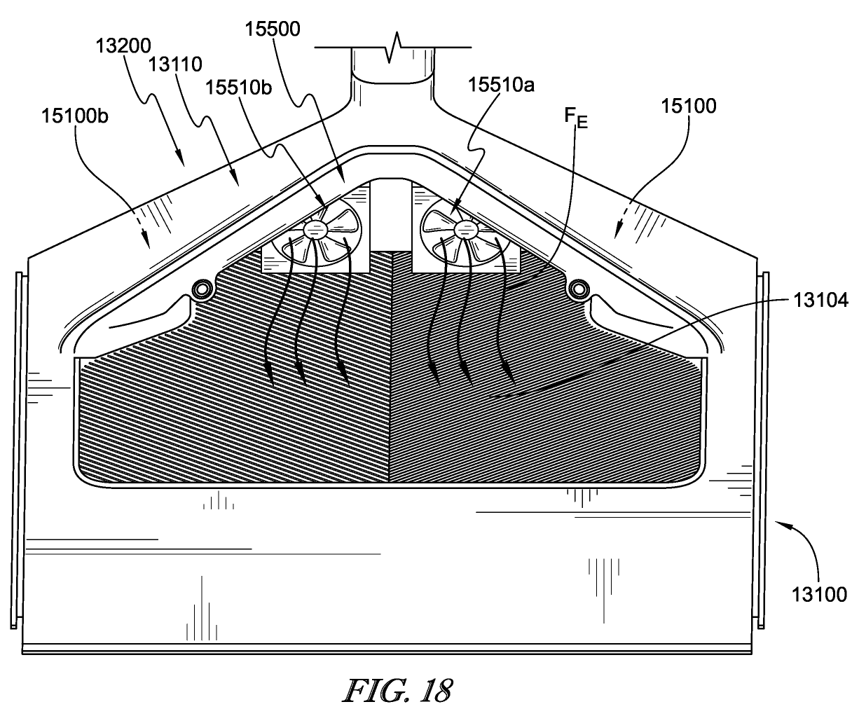

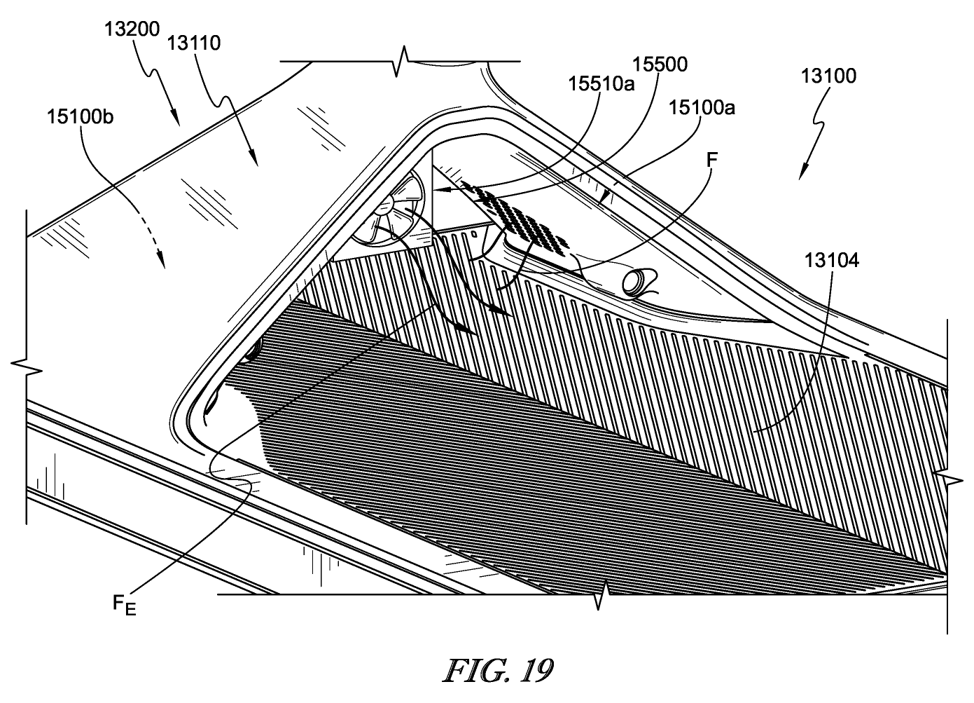

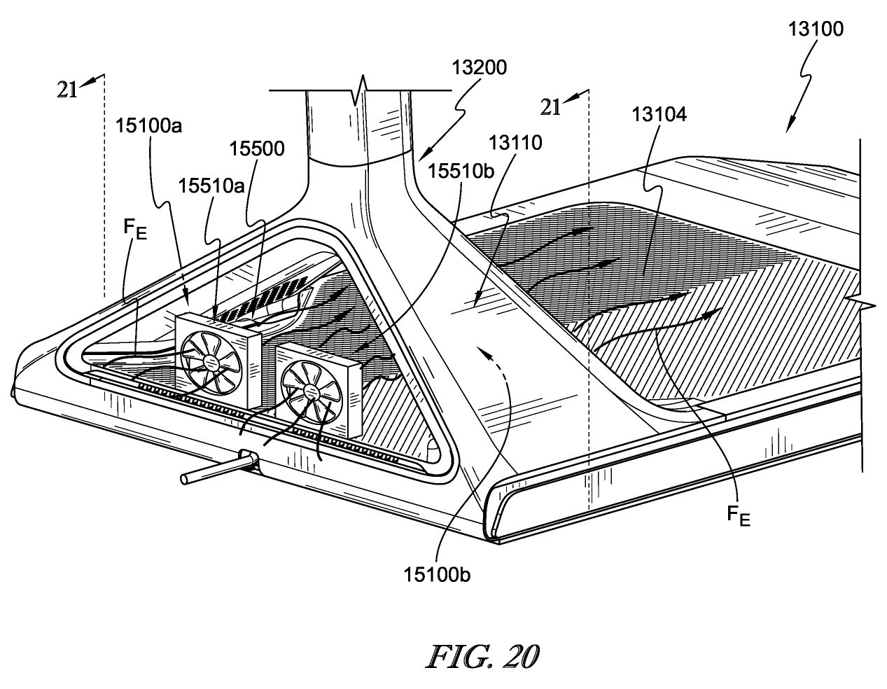

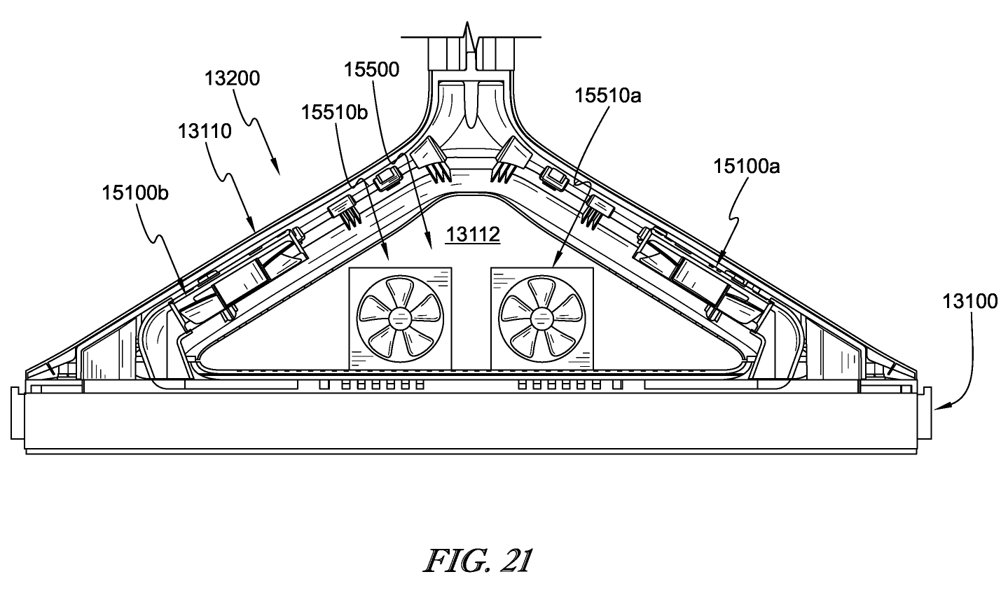

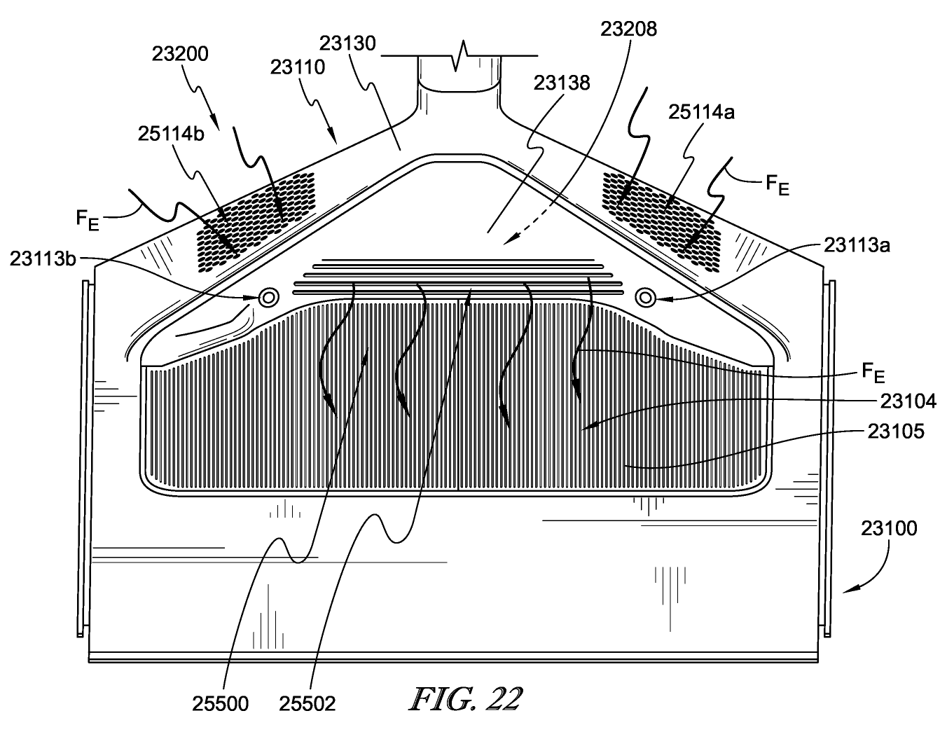

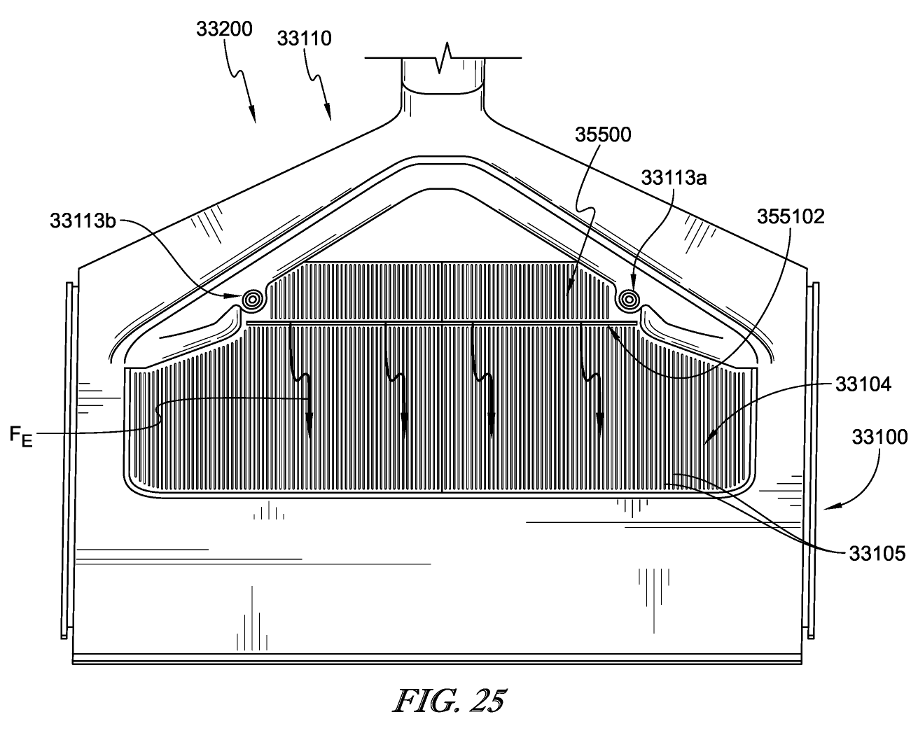

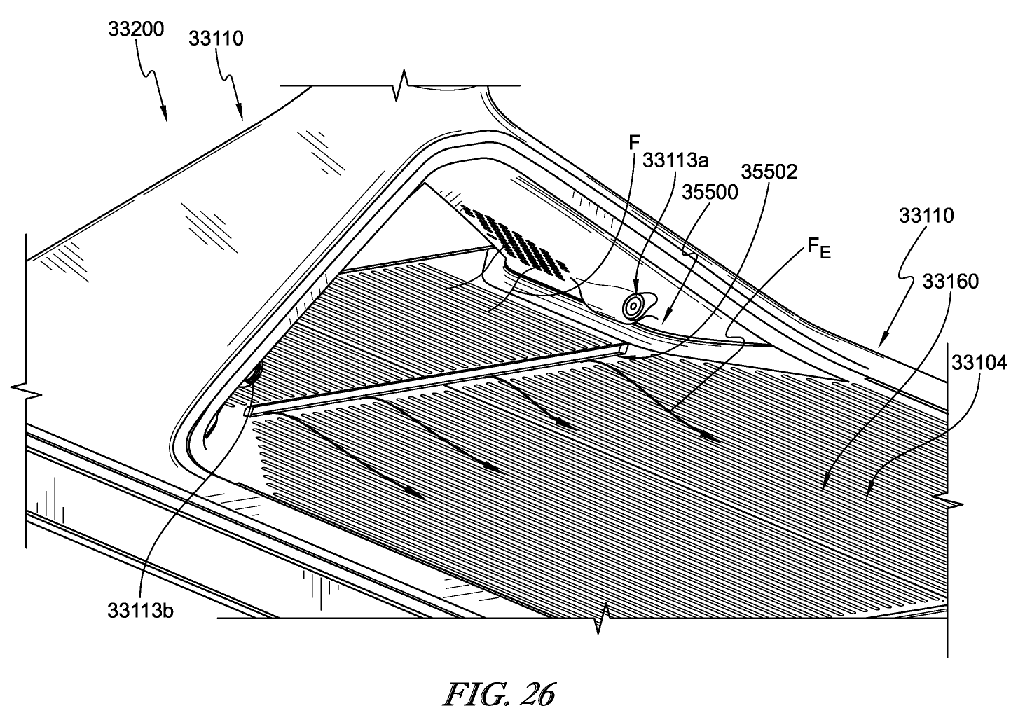

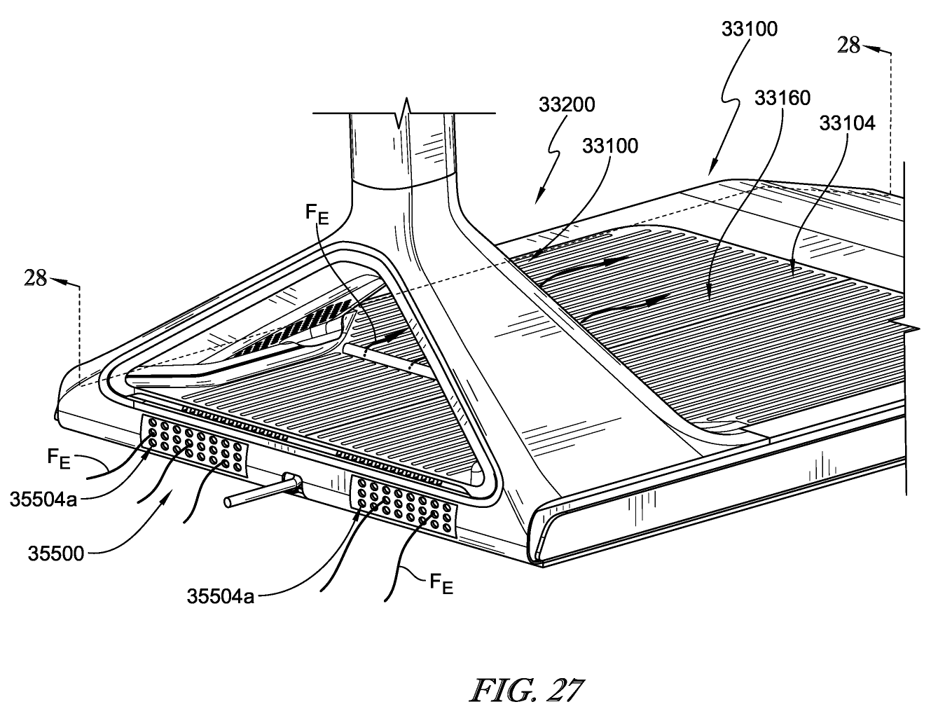

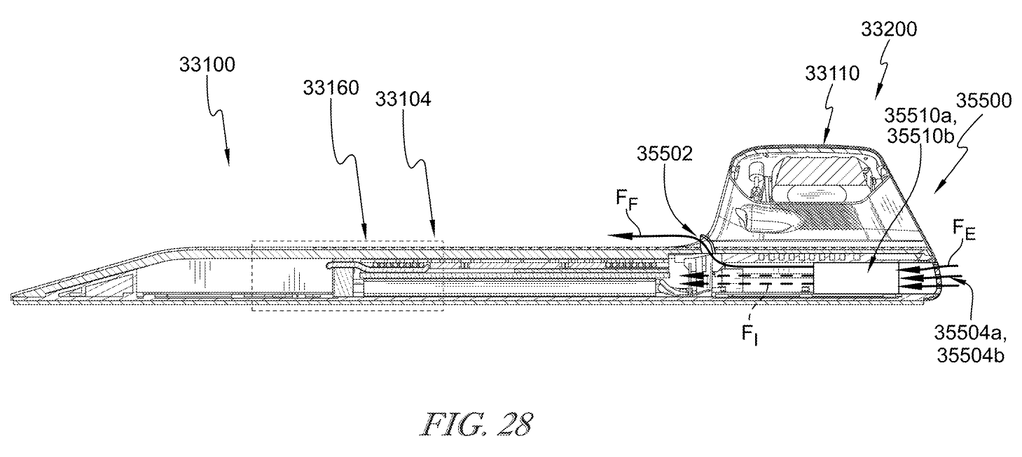

In the illustrative embodiment of FIGS. 9-17, the cleaning system 5500 may be integrated into the active cooling system 5000 and utilize the fan assemblies 5100a, 5100b of the cooling system 5000. FIGS. 18-21 show a second embodiment of the cleaning system 15500 which has separate fan assemblies 15510a, 15510b. FIGS. 22-24 show a third embodiment of the cleaning system 25500 which has separate fan assemblies 25510a, 25510b integrated into the support stand 23200 of the docking station 23000. FIGS. 25-30 show a fourth embodiment of the cleaning system 35500 which has separate fan assemblies 35510a, 35510b integrated into the charging mat 33100 of the docking station 33000. In other embodiments, the cleaning system may utilize another self- cleaning mechanism configured to remove the foreign objects and/or debris.

### i. First Embodiment

As shown in FIGS. 9-13, the air ducts 5110a, 5110b coupled to the fan assemblies 5100a, 5100b are also configured to direct the air in the air flow path toward outlets 5502a, 5502b in the flared base portion 3110. Each air duct 5110a, 5110b is coupled to the outlet end 5100.4a, 5100.4b of the respective fan assembly 5100a, 5100b and has an extent that extends toward the outlet openings 5502a, 5502b in the flared base portion 3110 so that the second outlet opening 5110.4.4a, 5110.4.4b is near or adjacent to the respective outlet opening 5502a, 5502b. Each air duct 5110a, 5110b is shaped to channel at least a portion of the airflow generated by the fan assemblies 5100a, 5100b and direct it efficiently toward the outlet openings 5502a, 5502b in the flared base portion 3110 for cleaning the wireless charging surface 3104 of the charging mat 3100. The geometry of the air ducts 5110a, 5110b may be contoured to minimize flow separation and pressure loss along the path between the fan assemblies 5100a, 5100b and the outlet openings 5502a, 5502b.

As shown in FIGS. 9-16, the second outlet opening 5110.4.4a, 5110.4.4b of each air duct 5110a, 5110b directs at least a portion of the airflow (i.e., the air flow path F_{E}) generated by the fan assemblies 5100a, 5100b through the outlet openings 5502a, 5502b in the flared base portion 3110 over the wireless charging surface 3104 of the charging mat 3100. In some embodiments, operating of the fan assemblies 5100a, 5100b will result in both airflows (e.g., the airflow F to the thermal transfer device 5200 and the airflow F_{E} to the charging surface 3104 of the charging mat 3100). In other embodiments, the air ducts 5110a, 5110b may each have an adjustable bifurcation wall that allows the airflow generated by the fan assemblies 5100a, 5100b to be directed to either (i) the air flow path F to cool components of the WPT system 4000 in the docking station 3000 or (ii) the air flow path F_{E} to clean the charging surface 3104 of the charging mat 3100. The charging controller 4104 or another control unit within the docking station 3000 may activate the adjustable bifurcation wall to change between utilizing the fan assemblies 5100a, 5100b for the active cooling system 5000 and the cleaning system 5500. The adjustable bifurcation wall may be actuated by a servo motor, a solenoid, or another electromechanical actuator under the control of the charging controller 4104, and may be positioned at any intermediate angle to apportion the airflow between the two paths in a continuously variable manner.

The airflow path F_{E} over the charging surface 3104 of the charging mat 3100 may also provide some thermal management of the WPT system 4000. For example, the air flow path F_{E} flows across the exterior of the charging mat 3100 as well as the feet 92 of the robot 1 when the robot 1 is positioned on the docking station 3000. Directing the air over the exterior of the charging mat 3100 may help address the thermal challenges inherent in high-power wireless charging, where substantial heat may also be generated at the receiver interface. The charging controller 4104 or another control unit within the docking station 3000 may activate the adjustable bifurcation wall to direct airflow over the charging surface 3104 of the charging mat 3100 in situations where more cooling is needed at the receiver interface as opposed to within the transmitter electronics.

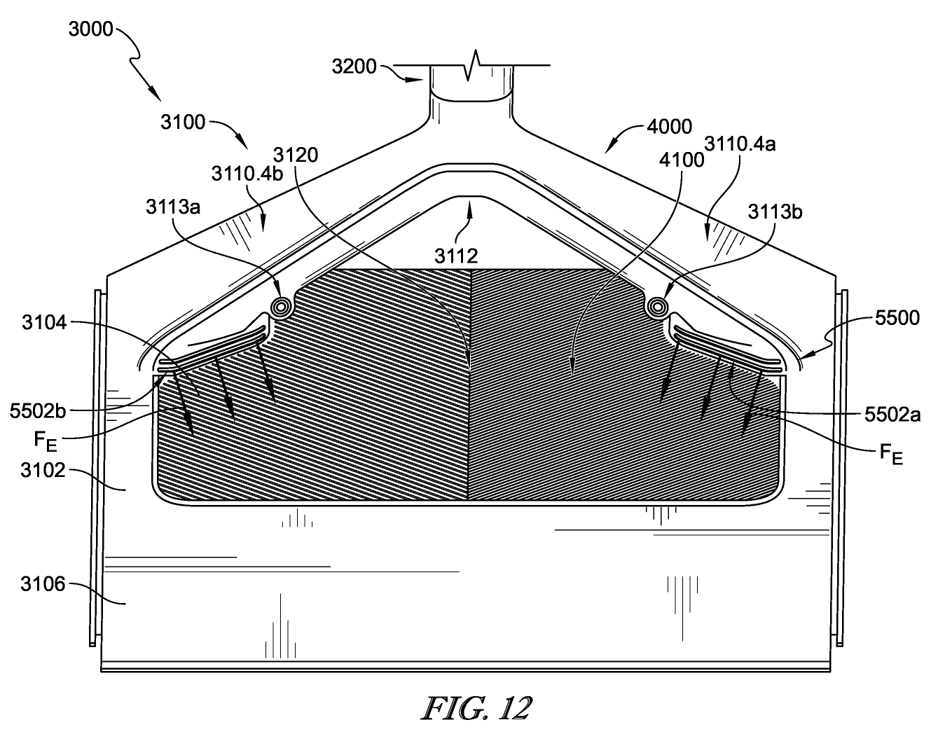

The outlet openings 5502a, 5502b may include louvers as shown in FIGS. 12-16, or another flow directing structure to control the direction of the airflow out of the outlet openings 5502a, 5502b. The louvers or diffusers may be configured to control the direction of the airflow out of the outlet openings 5502a, 5502b to ensure it is directed over the exterior (e.g., the charging surface 3104) of the charging mat 3100 to dislodge or remove foreign objects from the exterior of the charging mat 3100. In other embodiments, the outlet openings 5502a, 5502b may be an array of outlet openings 5502a, 5502b (e.g., holes, ports, vents, etc.). As shown in FIGS. 12-16, one leg 3110.4a is formed to include the outlet openings 5502a on one side of the charging mat 3100 and the other leg 3110.4b is formed to include the outlet openings 5502b on the opposite side of the charging mat 3100.

The ribbing or grooves 3105 in the planar surface 3102 of the charging mat 3100 may promote airflow from the outlet openings 5502a, 5502b under the robot's feet 92 when positioned on the charging mat 3100. As shown in FIGS. 12-16, the ribbing or grooves 3105 are substantially aligned with the direction of the air exhausted by the outlet openings 5502a, 5502b. In the illustrative embodiment, the ribbing or grooves 3105 extend at an angle toward a center 3120 of the charging mat 3100 while extending toward the forward extent of the charging mat 3100. This may help direct the airflow from the outlet openings 5502a, 5502b over the charging surface 3104 and improve the cleaning efficiency of the fan assemblies 5100a, 5100b. The depth and spacing of the ribbing or grooves 3105 may be selected to balance the promotion of directed airflow against the structural integrity of the platform surface 3102 and the ability of the robot's feet 92 to establish a stable contact with the wireless charging surface 3104.

### ii. Second Embodiment

As shown in FIGS. 18-21, the cleaning system 15500 includes dedicated fan assemblies 15510a, 15510b that generate a separate air flow path F_{E} over the exterior of the charging mat 13100 in addition to the air flow path F through the through portions of the charging mat 13100 and the support stand 13200. The fan assemblies 15510a, 15510b are arranged on an exterior of the charging mat 13100. As shown in FIGS. 18-21, the fan assemblies 15510a, 15510b may be coupled to the exterior of the charging mat 13100 at or near the flared base portion 13110. The fan assemblies 15510a, 15510b, which may be embodied as low-profile axial or cross-flow fans, are positioned and oriented in such a manner as to aspirate ambient air and generate the air flow path F_{E} across the exterior (e.g., the wireless charging surface 13104) of the charging mat 13100.

As shown in FIGS. 18-21, the air flow path F_{E} flows across the exterior of the charging mat 13100 as well as the feet 92 of the robot 1 when the robot 1 is positioned on the docking station 13000. The airflow generated by the fan assemblies 15510a, 15510b over the exterior of the charging mat 13100 helps to dislodge and/or remove the foreign objects and/or debris from the wireless charging surface 13104 of the charging mat 13100. The charging controller 4104 or another control unit within the docking station 3000 may activate the fan assemblies 15510a, 15510b to generate the airflow F_{E} during the cleaning procedure (e.g., at step 6060). The fan assemblies 15510a, 15510b may be activated in response to (i) detecting a foreign object, (ii) detecting a thermal anomaly, and/or (iii) beginning the docking procedure.

The fan assemblies 15510a, 15510b may also cooperate with the fan assemblies 15100a, 15100b to provide an enhanced and more comprehensive thermal management of the WPT system 4000. The air flow path F_{E} is directed so as to pass over and around the feet 92 of the robot 1, when positioned upon the wireless charging surface 13104 for the purpose of receiving wireless power transfer. This configuration effectuates direct convective cooling by disrupting the thermal boundary layer that forms on the exterior surface of the charging mat 13100 and around the soles of the robot's feet 92, thereby increasing the rate of heat transfer from these surfaces to the surrounding air. In some embodiments, the receiver coil assemblies 936 housed within the feet 92 may be susceptible to significant thermal loading during the charging process, and the airflow F_{E} can help the internal cooling system of the robot 1 dissipate the thermal load.

The establishment of this secondary, external cooling flow, therefore, may also supplement the internal cooling circuit of the WPT system 4000 and the internal cooling system of the robot 1, thereby offering a more comprehensive and robust thermal management strategy. This holistic approach addresses the dissipation of heat from both the transmitter system 4100 and the receiver system 936 components. This can allow for higher sustained charging power levels, potentially reducing charging duration and increasing the operational availability of the robot 1. Furthermore, by maintaining lower operating temperatures for the receiver coils 936 and associated electronics in the robot's feet 92, this approach can enhance the long-term reliability and lifespan of these components while also assisting in the maintenance of the touch-temperature of the accessible surfaces, helping to keep the temperatures within safe operational limits.

### iii. Third Embodiment

As shown in FIGS. 22-24, the cleaning system 25500 includes dedicated fan assemblies 25510a, 25510b that generate another air flow path F_{E} over the exterior of the charging mat 23100 in addition to the air flow path F through the through portions of the charging mat 23100 and the support stand 23200. In this embodiment, the fan assemblies 25510a, 25510b are arranged in the flared base portion 23110 and direct the airflow through outlet openings 25502 in the flared base portion 23110. The outlet openings 25502 are configured to direct the air from the fan assemblies 25510a, 25510b in a more streamlined airflow over the exterior (e.g., the wireless charging surface 23104) of the charging mat 23100 compared to the airflow in FIGS. 18-21. The more streamlined airflow may be attributed to the containment of the fan assemblies 25510a, 25510b within the flared base portion 23110, which constrains and directs the airflow before it is discharged onto the wireless charging surface 23104.

As shown in FIGS. 22-24, the flared base 23110 includes an upper support shell 23130, a rear support shell 23136, and a forward support shell 23138. The shells 23130, 23136, 23138 form a flare cavity 23208 configured to (i) house components of the active cooling system 25000, (ii) house the fan assemblies 25510a, 25510b of the cleaning system 25500, (iii) house components of the sensor assembly, and (iv) route wiring. Unlike the other embodiments, there is no airflow channel 3112 formed between the flared base 3110 and the charging mat 3100. The inlet apertures 25114 to the active cooling system 25000 are formed on an outer extent of the legs 23110.4a, 23110.4b of the flared base portion 23110, specifically the upper support shell 23130 of the flared base 23110 as shown in FIGS. 22-25. The forward support shell 23138 of the flared base portion 23110 is formed to include the outlet openings 25502 and the rear support shell 23136 is formed to include inlet openings 25504a, 25504b.

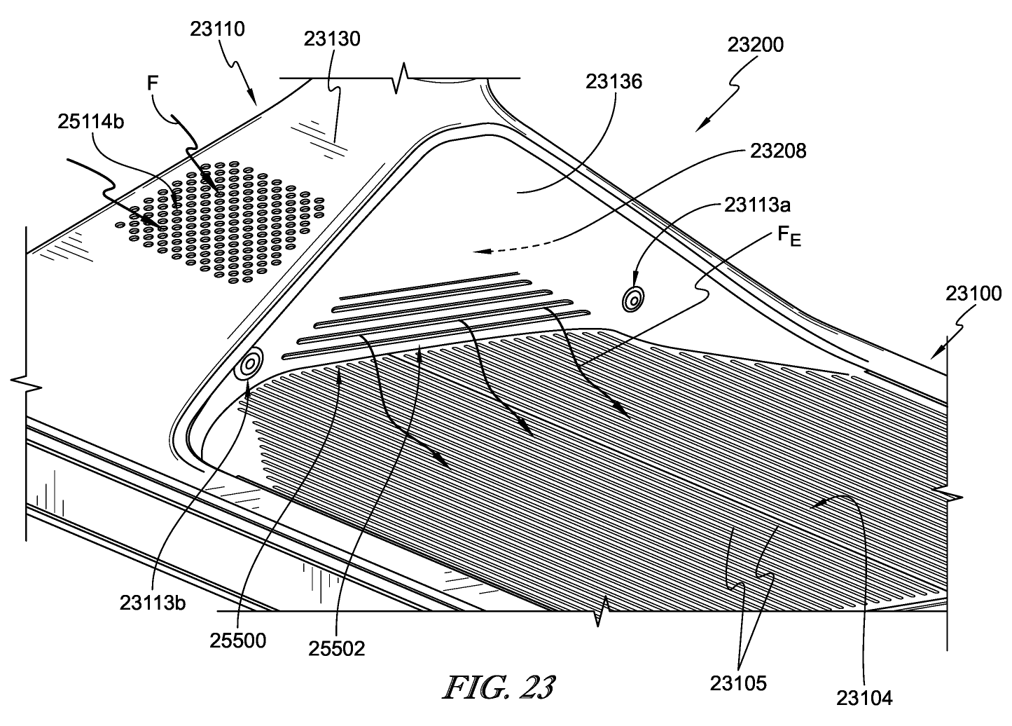

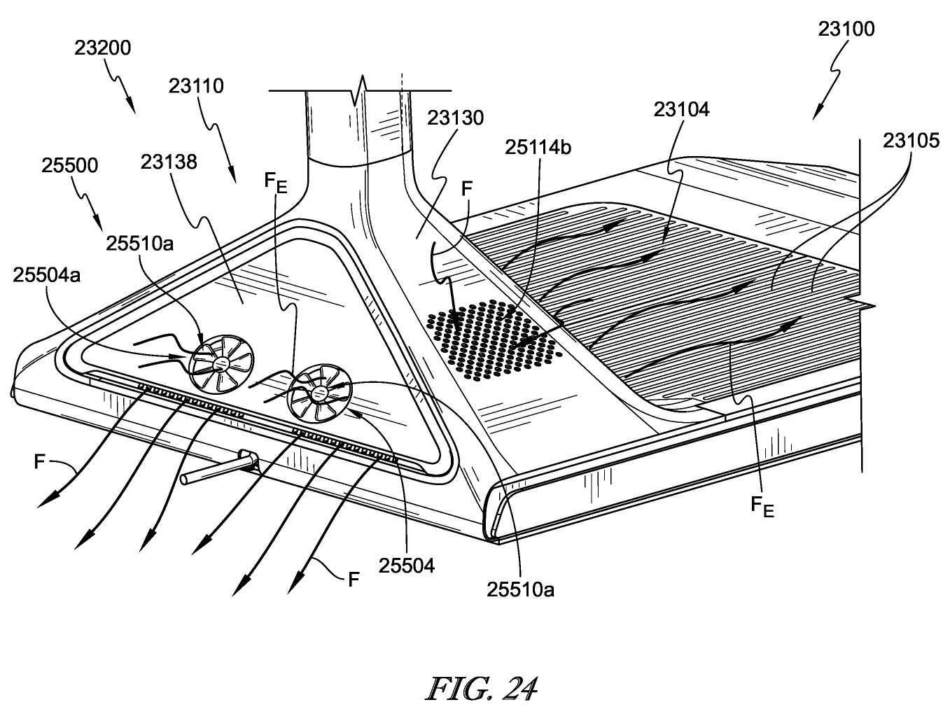

The fan assemblies 25510a, 25510b draw air in through the inlet openings 25504a, 25504b in the rear support shell 23136 of the flared base portion 23110 as shown in FIG. 24. This air is then exhausted through the outlet openings 25502 in the forward support shell 23138 of the flared base portion 23110 as shown in FIGS. 22 and 23. The outlet openings 25502 may include louvers or another flow directing structure to control the direction of the airflow out of the outlet openings 25502 to ensure it is directed over the charging surface 23104 of the charging mat 23100. In other embodiments, the outlet openings 25502 may be an array of outlet openings 25502 (e.g., holes, ports, vents, etc.). In some embodiments, the cleaning system 25500 may include duct(s) for the fan assemblies 25510a, 25510b that extend between the fan assemblies 25510a, 25510b and the outlet openings 25502 to help direct the airflow generated by the fan assemblies 25510a, 25510b to the outlet openings 25502.

As shown in FIGS. 22-24, the ribbing or grooves 23105 in the planar surface 23102 of the charging mat 23100 extend linearly from the forward support shell 23138 toward the forward extent of the charging mat 23100. As a result, the ribbing or grooves 23105 are substantially aligned with the direction of the air exhausted by the outlet openings 25502. This may help direct the airflow from the outlet openings 25502 over the charging surface 23104 and improve the cleaning efficiency of the fan assemblies 25510a, 25510b. The linear orientation of the ribbing or grooves 23105 in this embodiment, as contrasted with the angled orientation in the first embodiment, may provide more uniform airflow distribution across the width of the charging mat 23100.

### iv. Fourth Embodiment

As shown in FIGS. 25-30, the cleaning system 35500 includes dedicated fan assemblies 35510a, 35510b that generate another air flow path F_{E} over the exterior of the charging mat 33100 in addition to the air flow path F through the through portions of the charging mat 33100 and the support stand 33200. In this embodiment, the fan assemblies 35510a, 35510b are arranged in the charging mat 33100 and direct the airflow through outlet opening 35502 in the platform cover 33160 of the charging mat 33100. The outlet opening 35502 is configured to direct the air from the fan assemblies 35510a, 35510b over the exterior (e.g., the wireless charging surface 33104) of the charging mat 33100. By positioning the fan assemblies 35510a, 35510b within the charging mat 33100 itself, the airflow originates from a location that is proximate to the wireless charging surface 33104, which may increase the velocity and coverage of the air stream at the surface.

The fan assemblies 35510a, 35510b draw air into the charging mat 33100 through inlet openings 35504a, 35504b on a rear extent of the charging mat 33100, through an internal plenum, defined at least partly by the underside of the thermal transfer device 35200 and the surrounding structural components of the charging mat 33100, and out through outlet opening 35502 in the platform cover 33160. The flow of air through the internal plenum may aid in convective heat transfer to help cool the WPT system 34000. Within this plenum, the airflow may be directed across the thermal transfer device 35200, but may also be directed across thermally conductive surfaces of the carriers of the WPT system 34000, which support the transmitter coils before it is exhausted out the outlet opening 35502. In some embodiments, the cleaning system 35500 may include duct(s) for the fan assemblies 35510a, 35510b that extend between the fan assemblies 35510a, 35510b and the outlet opening 35502 to help direct the airflow generated by the fan assemblies 35510a, 35510b to the outlet opening 35502. The internal plenum may include baffles or flow guides to distribute the airflow evenly across the internal surfaces of the charging mat 33100 before the airflow is discharged through the outlet opening 35502.

The outlet opening 35502 may include louvers or another flow directing structure to control the direction of the airflow out of the outlet opening 35502 to ensure it is directed over the charging surface 33104 of the charging mat 33100. As shown in FIGS. 25-30, the louvers turn the air and direct it towards the forward extent of the charging mat 33100. The angle of the louvers may be fixed or adjustable, and may be selected to maximize the surface coverage of the airflow across the wireless charging surface 33104. In embodiments with adjustable louvers, the charging controller 4104 or another control unit may vary the louver angle to sweep the airflow across the wireless charging surface 33104 in a pattern that enhances debris removal.

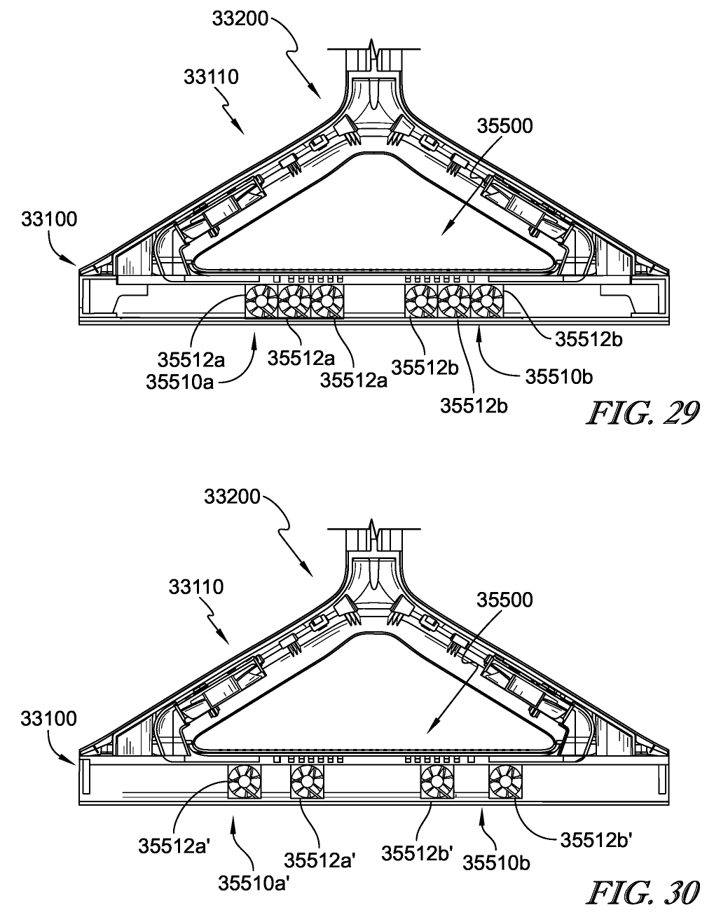

As shown in FIGS. 29 and 30, the fan assemblies 35510a, 35510b include more than a single fan. Rather, the fan assemblies 35510a, 35510b are fan arrays 35510a, 35510b with a plurality of fans 35512a, 35512b arranged in the charging mat 33100. As shown in FIG. 29, the fan arrays 35510a, 35510b include a plurality of fans 35512a, 35512b arranged near or adjacent to each other in the charging mat 33100. FIG. 30 shows another embodiment of the fan arrays 35510a', 35510b'. Each fan array 35510a', 35510b' includes a plurality of fans 35512a', 35512b' arranged spaced apart along a width of the charging mat 33100. The number of fans 35512a, 35512b, 35512a', 35512b' in each fan array 35510a, 35510b, 35510a', 35510b' may vary based on the power of the fans and/or the thermal loads of the WPT system 34000. The use of multiple smaller fans 35512a, 35512b, 35512a', 35512b' in a distributed array may be configured to generate a substantially uniform curtain of air across the entire width of the charging mat 33100 and can also offer redundancy in the event of a single fan failure.

### F. OPERATION OF THE WIRELESS POWER TRANSFER SYSTEM

FIGS. 5A and 5B illustrate a high-level functional block diagram of an exemplary wireless power transfer (WPT) system 4000, which illustrates the principal subsystems thereof and the flow of power and information therethrough. The system 4000 broadly includes a transmitter coil assembly 4100, which may be situated within the base 3100 of the docking station 3000, and a corresponding receiver coil assembly 936, which is configured for integration within the humanoid robot 1, for instance, in one or both of the feet 92. The block diagram serves to illustrate the principal power conversion stages and the bidirectional communication architecture that enable coordinated, closed-loop wireless charging. Each subsystem block depicted in FIGS. 5A and 5B may be embodied as a discrete circuit board, an integrated module, or a combination of hardware and firmware, depending on the design constraints and packaging considerations for the particular implementation.

The transmitter coil assembly 4100 is configured to receive utility power and convert it into a controlled, high-frequency magnetic field. The process is initiated by a power supply block 4102, which is configured to receive electrical power from a conventional alternating current (AC) source, such as a standard wall outlet providing, for example, 90-264 volts AC at a frequency of 20-90 Hz. The input power may first be subjected to an electromagnetic compatibility (EMC) filter stage, which can be constituted by components including, but not limited to, X/Y capacitors, common-mode chokes, and a Metal Oxide Varistor (MOV), for the purpose of suppressing conducted and radiated electromagnetic noise and protecting the system against transient voltage surges. Subsequent to filtration, the alternating current may be converted to direct current (DC) by means of a bridge rectifier. In certain instantiations of the design, a Power Factor Correction (PFC) circuit may be disposed downstream of the rectifier to ensure an efficient power draw from the mains supply, thereby establishing a stable, high-voltage DC bus, which may be on the order of 400 volts DC. Furthermore, it is contemplated that in some embodiments, the power supply block 4102 may incorporate an auxiliary power supply, such as a flyback converter, for the generation of various low-voltage DC rails (e.g., 12V, 5V, 3.3V) for the energization of the control electronics, microcontrollers (MCUs), and any associated cooling fans of the docking station 3000.

A charging controller block 4104, which includes the primary power electronics of the transmitter side, is configured to effect the conversion of the high-voltage DC, provided by the power supply block 4102, into a precisely controlled, high-frequency AC waveform. The aforementioned high-voltage DC energizes one or more full-bridge inverters, said inverters being sophisticated switching circuits constructed from high-performance components such as silicon carbide (SiC) metal-oxide-semiconductor field-effect transistors (MOSFETs) or insulated-gate bipolar transistors (IGBTs). Under the governance of a transmitter microcontroller unit (MCU), these inverters transform the DC power into a high-frequency AC waveform, operating, for example, at a nominal frequency between 20 to 200 kHz, and preferably at 85 kHz. The regulation of the power output may be achieved through the application of advanced modulation techniques, which may include a combination of phase-shifting and duty-cycle control. The resultant high-frequency AC output from the inverter may be subsequently conditioned by an LC filter to produce a substantially sinusoidal waveform, whereupon it is supplied to an impedance matching network (IMN). The IMN, which may be embodied as a dynamically adjustable matrix or array of capacitors, tunes the circuit to a specific resonant topology, such as LCC-S or LCC-P, for the purpose of maximizing the efficiency of power transfer across the air gap between the transmitter and receiver. Ultimately, the conditioned, high-frequency current energizes the transmitter coil assembly (TX PAD) 4100, thereby generating the powerful, oscillating magnetic field suitable for wireless power transmission.

The receiver coil assembly 936, represented by the designation Rx PAD and configured for integration within the robot 1 (e.g., within the foot appendages 92), is operative to capture the transmitted magnetic energy and convert said energy into a usable form of electrical power for the robot 1. For the transfer of power to be effected, the receiver coil assembly (Rx PAD) 936 is positioned within the magnetic field generated by the transmitter coil assembly 4100. The oscillating magnetic field induces a high-frequency alternating current in the receiver coil. This induced AC signal may be subsequently passed through an impedance matching network (IMN) of the receiver coil assembly 936, which may likewise employ a capacitor array to ensure that the receiver circuit is precisely tuned to the resonant frequency of the transmitter coil assembly 4100. The IMN of the receiver coil assembly 936 may be tuned to the same resonant frequency as the IMN of the transmitter coil assembly 4100, or it may be tuned to a slightly offset frequency to accommodate manufacturing tolerances and variations in the air gap distance.

The tuned, high-frequency alternating current may be thereafter converted to direct current by a rectification stage. In certain embodiments, said rectification stage may be realized as a standard diode full-bridge rectifier or, for higher efficiency, an active synchronous rectifier. This stage is capable of producing a rectified DC voltage (Vrec) at a predetermined value that is between 10V and 400V, and preferably between 48 and 60 volts. This rectified DC voltage may then be supplied to a final DC/DC converter, which is tasked with the precise regulation of the voltage and current to satisfy the specific charging needs of the onboard battery 202 of the robot 1 and its main power bus. The DC/DC converter may be embodied as a buck converter, a boost converter, or a buck-boost converter, depending on the voltage relationship between the rectified output and the battery 202 charging voltage profile.

The flow of energy and data within the system is represented by the charging controllers 888a, 888b in each leg 6, which is disposed within the robot 1, for example, in one or both of the leg assemblies 6. The primary power pathway, designated "P" in the diagram, originates at the power supply block 4102, proceeds through the charging controller 4104 and the transmitter coil assembly 4100, traverses the magnetic link across the air gap to the receiver coil assembly 936, and ultimately culminates at the robot's battery 202. The control and communication pathway, designated "C", is configured to be bidirectional. The receiver's MCU is arranged to continuously monitor its operational status, including but not limited to received voltage, battery charge state, and temperature, and to transmit this vital information back to the transmitter's MCU as part of a robust, closed-loop control architecture. This feedback mechanism permits the charging controller 4104 to effect real-time adjustments to the transmitted power level, and further enables the cooperative monitoring by both systems for fault conditions or Foreign Object Detection (FOD) events, thereby facilitating the immediate termination of power transfer should a hazardous condition be detected. It is to be understood that in various embodiments, said communication may be achieved through a plurality of standard industrial protocols, including, for example, a Controller Area Network (CAN), the RS422 standard, RS485, RS232, I2C, Ethernet, or a dedicated wireless communication link.

### G. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut -shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US26/13952, PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. Patent Application Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, and 19/252,708; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A docking station for a humanoid robot, the docking station comprising:
a wireless charging mat assembly comprising:
a base housing;
a platform cover coupled to an upper surface of the base housing, the platform cover comprising a wireless charging surface and a ramped portion extending forward and downward from the wireless charging surface;
a wireless power transmitter positioned within the base housing, the wireless power transmitter comprising at least one transmitter coil assembly positioned beneath the wireless charging surface and configured to generate an electromagnetic field to provide wireless power transfer to the humanoid robot; and
at least one thermistor positioned within the base housing; and
a charging controller communicatively coupled to the at least one transmitter coil assembly and the at least one thermistor, the charging controller configured to:
while causing the at least one transmitter coil assembly to generate an electromagnetic field, receive, from the at least one thermistor, temperature data;
based on the received temperature data, determine that a predetermined temperature threshold has been exceeded; and
based on determining that the predetermined temperature threshold has been exceeded, adjust the electromagnetic field generated by the at least one transmitter coil assembly.

2. The docking station of claim 1, wherein the at least one transmitter coil assembly comprises a first transmitter coil assembly and a second transmitter coil assembly arranged in a side-by-side configuration corresponding to a stance of left and right feet of the humanoid robot.

3. The docking station of claim 1, wherein the ramped portion is a first ramped portion, the platform cover further comprising second and third ramped portions extending laterally and downward from the wireless charging surface on respective sides of the base housing.

4. The docking station of claim 1, further comprising:
a support stand coupled to the wireless charging mat assembly, the support stand comprising:
a vertical support; and
a support cradle coupled to the vertical support above the charging mat assembly, the support cradle configured to mechanically couple with the humanoid robot to support the humanoid robot in an upright position during wireless power transfer.

5. The docking station of claim 4, further comprising at least one fan assembly that is configured to generate an airflow across an extent of the wireless charging surface.

6. The docking station of claim 5, further comprising at least one sensor positioned on the support stand, and wherein the at least one sensor is configured to detect foreign objects on the wireless charging surface; and
wherein the charging controller is further configured to, based on the at least one sensor detecting a foreign object on the wireless charging surface, activate the at least one fan assembly.

7. The docking station of claim 6, wherein the at least one sensor comprises a thermal imaging sensor, and wherein detecting foreign objects on the wireless charging surface comprises detecting thermal signatures of metallic foreign objects being heated by induced eddy currents from the electromagnetic field.

8. The docking station of claim 1, wherein the wireless charging mat assembly further comprises:
a thermal transfer device positioned within the base housing and in thermal communication with the at least one transmitter coil assembly, the thermal transfer device comprising a plurality of channels configured to receive airflow from a fan assembly.

9. The docking station of claim 8, wherein the thermal transfer device is positioned rearward of the at least one transmitter coil assembly, and wherein the plurality of channels extend from inlet ends positioned near lateral sides of the thermal transfer device to outlet ends positioned at a rear extent of the base housing.

10. The docking station of claim 1, wherein the wireless charging surface comprises a textured surface defining a plurality of grooves configured to promote airflow beneath feet of a humanoid robot when positioned on the wireless charging surface.

11. The docking station of claim 1, wherein the at least one thermistor comprises a negative temperature coefficient (NTC) thermistor positioned in thermal contact with one or both of a wire or a carrier of the at least one transmitter coil assembly.

12. The docking station of claim 1, wherein the at least one thermistor comprises an unshielded wire thermistor configured to avoid inductive heating by the electromagnetic field generated by the at least one transmitter coil assembly.

13. A docking station for a humanoid robot, the docking station comprising:
a wireless charging mat assembly comprising:
a base;
a wireless power transmitter positioned within the base, the wireless power transmitter comprising at least one transmitter coil assembly configured to generate an electromagnetic field to provide wireless power transfer to the humanoid robot; and
at least one thermistor positioned within the base; and
a charging controller communicatively coupled to the at least one transmitter coil assembly and the at least one thermistor, the charging controller configured to:
while causing the at least one transmitter coil assembly to generate the electromagnetic field, receive, from the at least one thermistor, temperature data;
based on the received temperature data, determine that a predetermined temperature threshold has been exceeded; and
based on determining that the predetermined temperature threshold has been exceeded, adjust the electromagnetic field generated by the at least one transmitter coil assembly.

14. The docking station of claim 13, further comprising:
a support stand coupled to the wireless charging mat assembly, the support stand comprising:
a vertical support; and
a support cradle coupled to the vertical support above the charging mat assembly, the support cradle configured to mechanically couple with the humanoid robot to support the humanoid robot in an upright position during wireless power transfer.

15. The docking station of claim 14, further comprising at least one fan assembly that is configured to generate an airflow across an extent of the base.

16. The docking station of claim 15, further comprising at least one sensor positioned on the support stand, and wherein the at least one sensor is configured to detect foreign objects on the base; and
wherein the charging controller is further configured to, based on the at least one sensor detecting a foreign object on the base, activate the at least one fan assembly.

17. The docking station of claim 16, wherein the at least one sensor comprises a thermal imaging sensor, and wherein detecting foreign objects on the base comprises detecting thermal signatures of metallic foreign objects being heated by induced eddy currents from the electromagnetic field.

18. A docking station for a humanoid robot, the docking station comprising:
a wireless charging mat assembly comprising a wireless charging surface configured to receive feet of a humanoid robot for wireless power transfer;
at least one camera positioned on the docking station and oriented to capture image data of a sole of a first foot of the humanoid robot while the first foot is lifted above the wireless charging surface;
a cleaning system comprising at least one fan assembly configured to direct airflow across the wireless charging surface; and
a controller communicatively coupled to the at least one camera and the cleaning system, the controller configured to:
receive an indication that the humanoid robot is approaching the docking station;
capture, via the at least one camera, first image data of the sole of the first foot of the humanoid robot while the first foot is lifted above the wireless charging surface;
analyze the first image data and thereby detect a foreign object on the sole of the first foot;
based on detecting the foreign object on the sole of the first foot, activate the cleaning system to direct airflow toward the sole of the first foot to remove the foreign object;
after activating the cleaning system to direct airflow toward the sole of the first foot to remove the foreign object, capture, via the at least one camera, second image data of the sole of the first foot of the humanoid robot while the first foot is lifted above the wireless charging surface;
analyze the second image data and thereby determine that the sole of the first foot is free of foreign objects; and
based on determining that the sole of the first foot is free of foreign objects, transmit a signal to the humanoid robot indicating that the sole of the first foot is free of foreign objects.

19. The docking station of claim 18, wherein the controller is configured to capture the first image data before the humanoid robot positions the first foot on the wireless charging surface.

20. The docking station of claim 18, wherein the at least one camera comprises a first camera and a second camera positioned on opposing sides of the wireless charging mat assembly, wherein fields of view of the first camera and the second camera at least partially overlap over the wireless charging surface.
